(19) United States
(12) Patent Application Publication
(10) Pub. No.: US 2023/0036482 A1
(43) Pub. Date: Feb. 2, 2023

(54) REMOTELY-CONTROLLABLE LOAD CONTROL DEVICE HAVING AN ANALOG ADJUSTMENT ACTUATOR

(71) Applicant: Lutron Technology Company LLC, Coopersburg, PA (US)

(72) Inventors: Gregory S. Altonen, Easton, PA (US); Edward J. Blair, Teleford, PA (US); Chris Dimberg, Easton, PA (US); Matthew V. Harte, Stewartsville, NJ (US); Jaime L. Ingram, Coopersburg, PA (US); Jason C. Killo, Emmaus, PA (US); Matthew K. Olsen, Allentown, PA (US); Adam Rosenberg, Wellington, FL (US); William Taylor Shivell, Breinigsville, PA (US); Matthew J. Swatsky, Allentown, PA (US); Daniel L. Twaddell, Bethlehem, PA (US); Aaron J. Wilz, Emmaus, PA (US); Noah Zinn, Boynton Beach, FL (US)

(73) Assignee: Lutron Technology Company LLC, Coopersburg, PA (US)

(21) Appl. No.: 17/877,895

(22) Filed: Jul. 30, 2022

Related U.S. Application Data
(60) Provisional application No. 63/326,644, filed on Apr. 1, 2022.
(60) Provisional application No. 63/227,394, filed on Jul. 30, 2021.

(51) Int. Cl. H05B 45/10; H01H 15/10; H05B 45/20; H05B 47/19

(52) U.S. Cl. CPC H05B 45/10; H01H 15/10; H05B 45/20; H05B 47/19

(57) ABSTRACT

A control device for controlling an electrical load may include a slider knob, a plurality of light sources, a diffuser, and a control circuit. The slider knob may be configured to move in a vertical direction along an elongated slot located in a bezel of the control device. The diffuser may be located along the elongated slot and be configured to be illuminated by the plurality of light sources to indicate the amount of power delivered to the electrical load. The control circuit may be configured to control the amount of power delivered to the electrical load in response movement of the slider knob along the elongated slot, and to illuminate at least a portion of the diffuser to indicate the amount of power delivered to the electrical load. In response to receiving a message to control the electrical load by a remote device, the control circuit may be configured to illuminate the diffuser to indicate the amount of power delivered to the electrical load such that the illuminated portion of the diffuser does not align with the location of the slider knob.

### CROSS-REFERENCE TO RELATED APPLICATIONS

This application claims priority from Provisional U.S. Patent Application No. 63/227,394, filed Jul. 30, 2021, and Provisional U.S. Patent Application No. 63/326,644, filed Apr. 1, 2022, the entire disclosures of which are hereby incorporated by reference herein in their entirety.

### BACKGROUND

A load control system may include one or more electrical loads that a user may wish to control via a single load control device. These electrical loads may include, for example, lighting loads, HVAC units, motorized window treatment or projection screens, humidity control units, audio systems or amplifiers, Internet of Things (IoT) devices, and/or the like. The electrical loads may have advanced features. For example, a lighting load may be controlled to emit light of varying intensities and/or colors in response to a user command. The amount of power delivered to the electrical loads may be adjusted to an absolute level or by a relative amount.

Traditional wall-based control devices (e.g., wallbox dimmers) may allow a user to adjust an intensity level of one or more lighting loads through the movement of an analog intensity actuator (e.g., slider control or rotary knob) or the actuation of a digital intensity actuator (e.g., an intensity-increase and intensity-decrease actuators). These traditional wall-based control devices may also provide feedback to the user on the intensity level of the load. For the control devices with digital intensity actuators, the control devices may include feedback that indicates the intensity level of the lighting load. For control devices with analog intensity actuators, the feedback traditionally indicates both the intensity level of the lighting load and the position of the analog intensity actuator.

### SUMMARY

A control device for controlling an electrical load may include a slider knob that is configured to move in a linear (e.g., vertical or horizontal) direction along an elongated slot. The control device may also include a plurality of light sources, and a diffuser located behind the elongated slot. The diffuser may be configured to be illuminated by the plurality of light sources to indicate the amount of power delivered to the electrical load. The diffuser may be coupled to the slider knob and configured to move in the vertical direction with the slider knob. The control device may also include a control circuit. The control circuit may be configured to control the amount of power delivered to the electrical load in response movement of the slider knob along the elongated slot. The control circuit may also be configured to illuminate at least a portion of the diffuser to indicate the amount of power delivered to the electrical load. The control circuit may be configured to determine a length of the illuminated portion of the diffuser in proportion to the amount of power delivered to the electrical load (e.g., in response to both local and remote control commands).

A control device for controlling an electrical load may include an intensity adjustment actuator. In some examples, the intensity adjustment actuator may be an analog intensity adjustment actuator, which for example, may comprise a moveable component that moves relative to the base portion (e.g., bezel) of the control device, and wherein, movement of the moveable component is configured to cause the control device to change an amount of power delivered to the electrical load. The control device may include a communication circuit that is configured to receive a message from a remote device (e.g., a digital message). The control device may include a plurality of light sources and a visible display that is configured to be illuminated by the plurality of light sources to indicate an amount of power delivered to the electrical load. The control device may include a control circuit that is configured to control the amount of power delivered to the electrical load in response to movement of the analog intensity adjustment actuator, and that is configured to illuminate at least a portion of the visible display to indicate the amount of power delivered to the electrical load in response to the message from the remote device. The control circuit may be configured to illuminate at least a portion of the visible display to indicate the amount of power delivered to the electrical load in response to the movement of the analog intensity adjustment actuator.

In some examples, the analog intensity adjustment actuator is configured to control a potentiometer. For example, the analog intensity adjustment actuator is mechanically coupled to the potentiometer. The analog intensity adjustment actuator may include a slider knob configured to move in a linear direction along a slider slot. The visible display may be located behind the slider slot. For example, the visible display may be located within the slider slot behind the slider knob.

In some examples, the analog intensity adjustment actuator may include a rotary knob configured to be rotatable with respect to a base portion of the control device. The rotary knob may be characterized by non-continuous rotation having a high-end stopping point and a low-end stopping point.

In some examples, the analog intensity adjustment actuator may include a slider knob configured to move within a slider slot, and the visible display may be located within the slider slot behind the slider knob. For example, the visible display may define a plurality of discrete segments, and the control circuit may be configured to controllably illuminate at least a subset of the plurality of discrete segments based on the amount of power delivered to the electrical load. For example, the control circuit may be configured to illuminate a first segment of the plurality of discrete segments when the amount of power delivered to the electrical load is between a low-end threshold and a first threshold, illuminate the first segment and a second segment of the plurality of discrete segments when the amount of power delivered to the electrical load is between the first threshold and a second threshold, illuminate the first segment, the second segment, and a third segment of the plurality of discrete segments when the amount of power delivered to the electrical load is between the second threshold and a third threshold, and illuminate the first segment, the second segment, the third segment, and a fourth segment of the plurality of discrete segments when the amount of power delivered to the electrical load is between the third threshold and a fourth threshold. The control circuit may be configured to control the amount of power delivered to the electrical load across a power range, and each of the plurality of discrete segments may be associated with a lower power threshold and an upper power threshold that are associated with a portion of the power range. For example, the lower power threshold and the upper power threshold for at least some of the plurality of discrete segments may be different based on whether the amount of power delivered to the electrical load is controlled in response to movement of the analog intensity adjustment actuator or is controlled in response to the message received from the remote device.

The control device may include a diffuser and a tunnel structure. The tunnel structure may be located between the plurality of light sources and the diffuser. The tunnel structure may include a plurality of apertures that are configured to cause an illumination surface of the diffuser to illuminate the plurality of discrete segments.

The analog intensity adjustment actuator may include a slider knob that defines a length, and the length of the slider knob may be equal to or greater than the length of each of the plurality of segments. For example, the length of the slider knob may be at least two times greater than a length of each of the plurality of segments. The control circuit may be configured to controllably illuminate and turn off each of the plurality of discrete segments on when the segment is located behind the slider knob.

In some examples, the control circuit may be configured to illuminate the visible display as a continuous light bar. For instance, the control circuit may be configured to illuminate the visible display as a continuous light bar such that an end point of the continuous light bar is based on the amount of power delivered to the electrical load.

In some examples, the visible display may be located adjacent the slider slot. For instance, the visible display may include a linear array of discrete visible indicators. Additionally or alternatively, the visible display may define a plurality of discrete segments that can be controllably illuminated by the control circuit. The control circuit may be configured to illuminate the visible display as a continuous light bar. In some examples, the visible display may be provided on a rear surface of the slider slot. In some examples, the slider knob may be configured to move in a linear direction with the slider slot. In some examples, the control circuit may be further configured transmit a message to control the amount of power delivered to the electrical load in response to the message from the remote device.

The message may include an indication of the amount of power being delivered to the electrical load. The control device may further comprise a controllably conductive device adapted to be coupled in series electrical connection between an alternating current (AC) power source and the electrical load. The message may include a command for controlling the electrical load. The control circuit may be configured to control the controllably conductive device to control the amount of power delivered to the electrical load in response to the movement of the analog intensity adjustment actuator, and may be configured to illuminate at least a portion of the visible display to indicate the amount of power delivered to the electrical load in response to the movement of the analog intensity adjustment actuator.

The message may include a command for controlling the electrical load. The control circuit may be configured to cause the communication circuit to transmit a control message that causes the amount of power being delivered to the electrical load to be adjusted.

In some examples, the control device may include an actuation member configured to pivot in response to an actuation of an upper portion of the actuation member or a lower position of the actuation member. In such examples, the control circuit may be configured to turn the electrical load on in response to an actuation of the upper portion of the actuation member, and turn the electrical load off in response to an actuation of the lower portion of the actuation member. The actuation member may be located between the visible display and the analog intensity adjustment actuator. The analog intensity adjustment actuator may be located between the actuation member and the visible display. The visible display may be located between the actuation member and the analog intensity adjustment actuator.

In some examples, a control device for controlling an electrical load may include a slider knob configured to move in a vertical direction along an elongated slot, a plurality of light sources, and a surface located behind the elongated slot, where the surface may be configured to be illuminated by the plurality of light sources. The control device may also include a control circuit. The control circuit may be configured to control the amount of power delivered to the electrical load in response movement of the slider knob along the elongated slot, and to illuminate at least a portion of the surface to indicate an amount of power delivered to the electrical load. In some examples, the slider knob may be configured to move along the elongated slot in response to a user input to adjust the amount of power delivered to the electrical load. The control device may also include a diffuser defining the surface. The diffuser may be coupled to the slider knob and configured to move in the vertical direction with the slider knob.

In some examples, in response to movements of the slider knob, the control circuit may be configured to align an illuminated portion of the surface with a location of the slider knob. And, in response to control of the electrical load by a remote device, the control circuit may be configured to illuminate the surface to indicate the amount of power delivered to the electrical load such that the illuminated portion of the surface does not align with the location of the slider knob.

The control device may include a communication circuit that is configured to receive a message from a remote device. In such examples, the control circuit may be configured to control the amount of power delivered to the electrical load in response to the received message, and illuminate at least a portion of the surface to indicate the amount of power delivered to the electrical load in accordance with the received message. For example, the control circuit may be configured to cause the communication circuit to transmit a control message that causes the amount of power delivered to the electrical load to be adjusted.

In some examples, the control device may include a communication circuit that is configured to receive a message from a remote device. In such examples, the control circuit may be configured to illuminate at least a portion of the surface to indicate the amount of power delivered to the electrical load in accordance with the received message such that an illuminated portion of the surface is not aligned with the position of the slider knob along the elongated slot.

In some examples, when an illuminated portion of the surface is not aligned with the position of the slider knob along the elongated slot, the control circuit may be configured to realign the illuminated portion of the surface with the position of the slider knob in response to a movement of the slider knob. In some examples, in response to movement of the slider knob, the control circuit may be configured to illuminate a portion of the surface that is located below the slider knob. In some examples, in response to movement of the slider knob, the control circuit may be configured to illuminate the surface behind the location of the slider knob without illuminating any portion of the surface located above the slider knob.

In some examples, the surface may define a plurality of discrete segments. In such examples, the control circuit may be configured to controllably illuminate at least a subset of the plurality of discrete segments based on the amount of power delivered to the electrical load. The plurality of segments may include nine segments, although any number of segments may be provided. The slider knob may define a length, and the length of the slider knob may be equal to or greater than the length of each of the plurality of segments. For example, the length of the slider knob may be at least two times greater than a length of each of the plurality of segments.

The control device may include a diffuser that defines the surface, and a tunnel structure located between the plurality of light sources and the diffuser. The tunnel structure may include a plurality of apertures that are configured to cause an illumination surface of the diffuser to illuminate a plurality of discrete segments along the elongated slot.

In some examples, the control circuit may be configured to enter an idle mode when the electrical load is off. When in the idle mode, the control circuit may be configured to illuminate the surface at an intensity level that is lower than an intensity level used to indicate the amount of power delivered to the electrical load when in an active mode.

In some examples, the control device may include an actuation member, and the elongated slot may be located adjacent to the actuation member. For example, the actuation member may be configured to pivot in response to an actuation of an upper portion of the actuation member or a lower position of the actuation member. The control circuit may be configured to control a controllable conductive device to connect an alternating current (AC) power source to the electrical load in response to an actuation of an upper portion of the actuation member, and may be configured to control the controllable conducive device to disconnect the AC power source from the electrical load in response to an actuation of a lower portion of the actuation member.

In some examples, the control device may include a bezel, and the elongated slot may be located in the bezel. The control device may also include an actuation member located within an opening in the bezel adjacent to the elongated slot. In some examples, the slider knob may be mechanically coupled to a potentiometer of the load control device, such that the potentiometer generates a direct-current (DC) voltage representative of the desired amount of power to be delivered to the electrical load.

In some examples, the control circuit may be configured to determine a length of an illuminated portion of the surface in proportion to the amount of power delivered to the electrical load.

In some examples, the electrical load may include a lighting load, and the control circuit may be configured to adjust a lighting intensity of a lighting load between a low-end intensity and a high-end intensity in response to adjustment of the slider knob along the elongated slot.

In some examples, the control device may also include a diffuser comprising an elongated portion that extends behind the elongated slot, and the diffuser may be configured to scatter light received from the plurality of light sources. The plurality of light sources may include one or more light-emitting diodes.

In some examples, the control device may include a controllably conductive device adapted to be coupled in series electrical connection between an AC power source and the electrical load. In such examples, the control circuit may be configured to control the controllably conductive device to control the amount of power delivered to the electrical load in response to actuations of the actuation member and in response to movement of the slider knob along the elongated slot.

In some examples, the control circuit may be configured to control the amount of power delivered to the electrical load based on a position of the slider knob along the elongated slot.

In some examples, the control device may include a linear diffuser that defines the surface.

In some examples, the elongated slot may be configured to provide feedback indicating whether the amount of power provided to the electrical load is determined based on the position of the slider knob or an external device.

In some examples, the electrical load may include a lighting load. In such examples, the elongated slot may be configured to provide multiple types of feedback including two or more of an intensity of the lighting load, a color of the lighting load, or a position of the slider knob.

In some examples, a control device for controlling an electrical load may include an analog intensity adjustment actuator, a communication circuit configured to receive a message from a remote device, a visible display configured to be illuminated by a one or more light sources, and a control circuit. In such examples, the control circuit may be configured to control the amount of power delivered to the electrical load in response to movement of a position of the analog intensity adjustment actuator, determine the amount of power delivered to the electrical load in response to the message from the remote device, and in response to receiving the message from the remote device, illuminate the visible display to indicate that the amount of power delivered to the electrical load is not aligned with the position of the intensity adjustment actuator.

In some examples, analog intensity adjustment actuator may include a slider knob configured to move linearly along an elongated slot. In such examples, the control circuit may be configured to illuminate the visible display to indicate that the amount of power delivered to the electrical load is not aligned with the position of the slider knob along the elongated slot. For instance,

The visible display may be located behind the elongated slot. The visible display may be located within the elongated slot behind the slider knob. For example, the control circuit may be configured to illuminate the visible display above the slider knob to indicate that the amount of power delivered to the electrical load is greater than the position of the slider knob along the elongated slot, and illuminate the visible display below the slider knob to indicate that the amount of power delivered to the electrical load is less than the position of the slider knob along the elongated slot. The slider knob may include an opening, and the control circuit may be configured to illuminate the opening in the slider knob to indicate that the amount of power delivered to the electrical load is not aligned with the position of the slider knob along the elongated slot. For example, the control circuit may be configured to not illuminate the opening in the slider knob in response to an actuation of the analog intensity adjustment actuator, and may be configured to illuminate the opening in the slider control in response to reception of the message from the remote device.

In some examples, the control circuit may be configured to illuminate the visible display to indicate the amount of power delivered to the electrical load.

In some examples, the visible display may include a first visible indicator located above the elongated slot and a second visible indicator located below the elongated slot. In such examples, the control device may be configured to illuminate the first visible indicator in response to reception of the message from the remote device when the amount of power delivered to the electrical load is greater than a corresponding amount of power associated with a position of the actuator, illuminate the second visible indicator in response to reception of the message from the remote device when the amount of power delivered to the electrical load is less than a corresponding amount of power associated with a position of the actuator, and control plurality of light sources such that neither the first nor second visible indicator is illuminated in response to an actuation of the actuator.

In some examples, the control circuit may be configured to illuminate the visible display to indicate the amount of power delivered to the electrical load when the amount of power delivered to the electrical load is aligned with the position of the intensity adjustment actuator.

In some examples, the control device may include a diffuser and a tunnel structure. In such examples, the tunnel structure may be located between the plurality of light sources and the diffuser. The tunnel structure may include a plurality of apertures that are configured to cause an illumination surface of the diffuser to illuminate a plurality of discrete segments along the elongated slot, and the visible display may include the illumination surface of the diffuser.

In some examples, the visible display may define a plurality of discrete segments, and wherein the control circuit is configured to controllably illuminate at least a subset of the plurality of discrete segments based on the amount of power delivered to the electrical load.

In some examples, a control device for controlling an electrical load may include an analog intensity adjustment actuator, a communication circuit configured to receive a message from a remote device, a visible display configured to be illuminated by a one or more light sources, and a control circuit. In such examples, the control circuit may be configured to control the amount of power delivered to the electrical load to a first amount in response to movement of a position of the analog intensity adjustment actuator, determine the amount of power delivered to the electrical load to a second amount in response to the message from the remote device, and illuminate the visible display to indicate that the second amount of power delivered to the electrical load in response to the message is not equal to the first amount of power as indicated by the position of the intensity adjustment actuator.

The analog intensity adjustment actuator may include a slider knob configured to move linearly along an elongated slot. In such examples, the control circuit may be configured to illuminate the visible display to indicate that the amount of power delivered to the electrical load is not aligned with the position of the slider knob along the elongated slot. For example, the visible display may be located behind the elongated slot. The control circuit may be configured to illuminate the visible display above the slider knob to indicate that the amount of power delivered to the electrical load is greater than the position of the slider knob along the elongated slot, and illuminate the visible display below the slider knob to indicate that the amount of power delivered to the electrical load is less than the position of the slider knob along the elongated slot. In some examples, the visible display may be located within the elongated slot behind the slider knob. In some examples, the slider knob may include an opening, and the control circuit may be configured to illuminate the opening in the slider knob to indicate that the amount of power delivered to the electrical load is not aligned with the position of the slider knob along the elongated slot. For example, the control circuit may be configured to illuminate the opening in the slider knob in response to an actuation of the analog intensity adjustment actuator, and configured to not illuminate the opening in the slider control in response to reception of the message from the remote device. In some examples, the control circuit may be configured to illuminate at least a portion of the elongated slot between a top edge of the slider knob and a top of the elongated slot when the amount of power delivered to the electrical load is greater than a corresponding amount of power associated with a position of the actuator, and may be configured to illuminate at least a portion of the elongated slot between a bottom edge of the slider knob and a bottom of the elongated slot when the amount of power delivered to the electrical load is less than a corresponding amount of power associated with a position of the actuator. For example, the control circuit may be configured to illuminate an entirety of the elongated slot between the top edge of the slider knob and the top of the elongated slot when the amount of power delivered to the electrical load is greater than the corresponding amount of power associated with a position of the actuator, and illuminate an entirety of the elongated slot between the bottom edge of the slider knob and the bottom of the elongated slot when the amount of power delivered to the electrical load is less than the corresponding amount of power associated with a position of the actuator.

In some examples, the control circuit may be configured to illuminate the visible display to indicate the amount of power delivered to the electrical load.

In some examples, the visible display may include a visible indicator located on or in the slider knob. In such examples, the control circuit may be configured to illuminate the visible indicator to indicate that the second amount of power delivered to the electrical load in response to the message is equal to the first amount of power as indicated by the position of the intensity adjustment actuator, and turn off the visible indicator to indicate that the second amount of power delivered to the electrical load in response to the message is not equal to the first amount of power as indicated by the position of the intensity adjustment actuator.

In some examples, the visible display may include a first visible indicator located above the elongated slot and a second visible indicator located below the elongated slot. In such examples,

The control device may be configured to illuminate the first visible indicator in response to reception of the message from the remote device when the amount of power delivered to the electrical load is greater than a corresponding amount of power associated with a position of the actuator, illuminate the second visible indicator in response to reception of the message from the remote device when the amount of power delivered to the electrical load is less than a corresponding amount of power associated with a position of the actuator, and control plurality of light sources such that neither the first nor second visible indicator is illuminated in response to an actuation of the actuator.

In some examples, the control circuit may be configured to illuminate the visible display to indicate the amount of power delivered to the electrical load when the amount of power delivered to the electrical load is aligned with the position of the intensity adjustment actuator.

In some examples, the control device may include a diffuser and a tunnel structure. The tunnel structure may be located between the plurality of light sources and the diffuser. For example, the tunnel structure may include a plurality of apertures that are configured to cause an illumination surface of the diffuser to illuminate a plurality of discrete segments along the elongated slot, and the visible display may include the illumination surface of the diffuser.

In some examples, the visible display may define a plurality of discrete segments, and the control circuit may be configured to controllably illuminate at least a subset of the plurality of discrete segments based on the amount of power delivered to the electrical load.

In some examples, the visible display may include a linear array of visible indicators that may be configured to indicate the amount of power delivered to the electrical load. For example, the control device may also include a bezel. In such examples, each visible indicator of the linear array of visible indicators may be an opening in the bezel, and the analog intensity adjustment actuator may be configured to be located within an opening in the bezel. For example, the control device may include one or more light pipes. Each light pipe may be configured to guide light from one or more of the plurality of light sources to the linear array of visible indicators to indicate the amount of power delivered to the electrical load.

A control device for controlling an electrical load may include an intensity adjustment actuator comprising a movable component that is moveable, a communication circuit configured to receive a message from a remote device, a visible display configured to be illuminated by a one or more light sources, and a control circuit. The control circuit may be configured to control the amount of power delivered to the electrical load in response to a position of the movable component of the analog intensity adjustment actuator, determine that the amount of power delivered to the electrical load in response to the message from the remote device is different than the amount of power associated with the position of the movable component of the analog intensity adjustment actuator, and in response to receiving the message from the remote device, illuminate the visible display to indicate that the amount of power delivered to the electrical load is not aligned with the position of the movable component of the analog intensity adjustment actuator.

In some examples, the movable component may include a slider knob that is configured to move linearly along an elongated slot. In such examples, the control circuit may be configured to illuminate the visible display to indicate that the amount of power delivered to the electrical load is not aligned with the position of the slider knob along the elongated slot. For instance, the visible display may be located within the elongated slot behind the slider knob. Alternatively or additionally, the control device may include a diffuser and a tunnel structure that is located between the one or more light sources and the diffuser. The tunnel structure may include a plurality of apertures that are configured to cause an illumination surface of the diffuser to illuminate a plurality of discrete segments along the elongated slot, and the visible display may include the illumination surface of the diffuser.

A control device for controlling an electrical load may include an actuation member, a slider knob configured to move along an elongated slot adjacent to the actuation member, a plurality of light sources, and a surface located behind the elongated slot and configured to be illuminated by the plurality of light sources. The control device may also include a controllably conductive device adapted to be coupled in series electrical connection between an AC power source and the electrical load. The control device may also include a control circuit that may be configured to control the controllably conductive device to control the amount of power delivered to the electrical load in response movement of the slider knob along the elongated slot, and illuminate a portion of the surface located below the slider knob as the slider knob is moved along the slider slot. In some examples, in response to movement of the slider knob, the control circuit may be configured to illuminate the portion of the surface below the location of the slider knob without illuminating any portion of the surface located above the slider knob. In some examples, in response to movements of the slider knob, the control circuit may be configured to illuminate the portion of the surface located below the slider knob to indicate the amount of power delivered to the electrical load. In some examples, the control circuit may be configured to illuminate the portion of the surface to indicate the amount of power delivered to the electrical load. The control device may include a diffuser defining the surface, where the diffuser may be coupled to the slider knob and configured to move in the vertical direction with the slider knob. In some examples, in response to movements of the slider knob, the control circuit may be configured to align an illuminated portion of the surface with a location of the slider knob and, in response to control of the electrical load by a remote device, the control circuit may be configured to illuminate the diffuser to indicate the amount of power delivered to the electrical load such that the illuminated portion of the surface does not align with the location of the slider knob.

In some examples, the control device may include a communication circuit that is configured to receive a message from a remote device. In such examples, the control circuit may be configured to control the amount of power delivered to the electrical load in response to the received message, and illuminate at least a portion of the surface to indicate the amount of power delivered to the electrical load in accordance with the received message. Alternatively or additionally, the control circuit may be configured to illuminate at least a portion of the surface to indicate the amount of power delivered to the electrical load in accordance with the received message such that an illuminated portion of the surface is not aligned with the position of the slider knob along the elongated slot.

In some examples, when an illuminated portion of the surface is not aligned with the position of the slider knob along the elongated slot, the control circuit may be configured to realign the illuminated portion of the surface with the position of the slider knob in response to a movement of the slider knob.

In some examples, an illumination surface of the surface may define a plurality of discrete segments, and the control circuit may be configured to controllably illuminate at least a subset of the plurality of discrete segments based on the amount of power delivered to the electrical load. For example, the plurality of segments may include nine segments. The slider knob may define a length, and the length of the slider knob may be equal to or greater than the length of each of the plurality of segments. For examples, the length of the slider knob may be at least two times greater than a length of each of the plurality of segments.

In some examples, the control device may include a tunnel structure located between the plurality of light sources and the surface. The tunnel structure may include a plurality of apertures that are configured to cause an illumination surface of the surface to illuminate a plurality of discrete segments along the elongated slot.

In some examples, the control circuit may be configured to enter an idle mode when the electrical load is off and, when in the idle mode, the control circuit may be configured to illuminate the surface at an intensity level that is lower than an intensity level used to indicate the amount of power delivered to the electrical load when in an active mode.

In some examples, the actuation member may be configured to pivot in response to an actuation of an upper portion of the actuation member or a lower position of the actuation member. In such examples, the control circuit may be configured to control a controllable conductive device to connect an AC power source to the electrical load in response to an actuation of an upper portion of the actuation member, and configured to control the controllable conducive device to disconnect the AC power source from the electrical load in response to an actuation of a lower portion of the actuation member.

The elongated slot may be located adjacent to the actuation member. In some examples, the control device may include a bezel, and the actuation member may be located within an opening in the bezel adjacent to the elongated slot. For example, the elongated slot may be located within a bezel of the control device. The elongated slot may be located within the actuation member.

A control device for controlling an electrical load may include a visible display that is configured to be illuminated by a plurality of light sources to indicate an amount of power delivered to the electrical load. The control device may include an actuator that is configured to receive a local control command of the electrical load, and a communication circuit that is configured to receive a message from a remote device. The message may be configured to provide a remote control command for the electrical load. The control device may also include a control circuit that is configured to control the amount of power delivered to the electrical load in response to the local control command, and illuminate the visible display to indicate the amount of power delivered to the electrical load in a first manner in response to an actuation of the actuator. The control circuit may also be configured to control the amount of power delivered to the electrical load in response to the remote control command, and illuminate the visible display to indicate the amount of power delivered to the electrical load in a second manner in response to reception of the message from the remote device.

In some examples, the visible display may include a surface of the control device, and the control circuit may be configured to control the plurality of light sources to illuminate the surface to indicate the amount of power delivered to the electrical load. For example, the visible display may include a diffuser defining an illumination surface, and the surface of the visible display may include the illumination surface of the diffuser. For example, the illumination surface of the diffuser may define a plurality of discrete segments, and the control circuit may be configured to controllably illuminate at least a subset of the plurality of discrete segments based on the amount of power delivered to the electrical load. For instance, to illuminate the illumination surface of the diffuser in the first manner, the control circuit may be configured to determine a number of segments to illuminate based on a set of local control buckets. To illuminate the illumination surface of the diffuser in the second manner, the control circuit may be configured to determine a number of segments to illuminate based on a set of remote control buckets. For example, the set of local control buckets may be used to determine which of the plurality of light sources to illuminate to indicate the amount of power delivered to the electrical load in response to the local control command, and the remote control buckets may be used to determine which of the plurality of light sources to illuminate to indicate the amount of power delivered to the electrical load in response to the remote control command. For example, each bucket may define one or more of an upper threshold and a lower threshold that define which of the plurality of light sources are to be illuminated such that the number of segments are illuminated based on the amount of power delivered to the electrical load.

In some examples, the control device may include a tunnel structure located between the plurality of light sources and the diffuser. The tunnel structure may include a plurality of apertures that are configured to cause the illumination surface of the diffuser to illuminate in the plurality of segments to indicate the amount of power delivered to the electrical load. For example, each of the plurality of light sources may be aligned with one of the plurality of apertures. For example, the plurality of light sources may be directly adjacent a back side of the tunnel structure.

In some examples, the control circuit may be configured to illuminate the illumination surface of the diffuser in the first manner in response to the local control command substantially instantaneously, and illuminate the illumination surface of the diffuser in the second manner in response to the remote control command over an adjustment period.

In some examples, the control circuit may be configured to determine whether the local control command or the remote control command indicates a change to the amount of power being delivered to the electrical load that is above a threshold. The control circuit may be configured to illuminate the illumination surface of the diffuser over an adjustment period in response to a determination that the change to the amount of power being delivered to the electrical load is above the threshold. The control circuit may be configured to illuminate the illumination surface of the diffuser substantially instantaneously in response to a determination that the change to the amount of power being delivered to the electrical load is below the threshold.

In some examples, the actuator may include a slider control configured to move in a linear direction along an elongated slot to provide the local control command of the electrical load. In such examples, the illumination surface may be provided on a rear surface of the slider slot. The control circuit may be configured to illuminate the illumination surface as a plurality of segments. The control circuit may be configured to illuminate the illumination surface as a continuous light bar. The control circuit may be configured to determine an end of the continuous light bar based on a local control threshold to illuminate the illumination surface of the diffuser in the first manner. The control circuit may be configured to determine the end of the continuous light bar based on a remote control threshold to illuminate the illumination surface of the diffuser in the second manner.

In some examples, the control device may be configured to control which light sources of the plurality of light sources to illuminate based on the amount of power delivered to the electrical load such that a corresponding number of segments on the illumination surface of the diffuser are illuminated.

In some examples, the visible display may include a linear array of visible indicators configured to indicate the amount of power delivered to the electrical load. For example, the control device may further include a bezel, and each visible indicator of the linear array of visible indicators may be an opening in the bezel, and the actuator may be configured to be located within an opening in the bezel. In such examples, the control device may include one or more light pipes, and each light pipe may be configured to guide light from one or more of the plurality of light sources to the linear array of visible indicators to indicate the amount of power delivered to the electrical load.

In some examples, the actuator may include an analog intensity actuator. In such examples, the control circuit may be configured to receive the local control command of the electrical load in response to movements of the analog intensity actuator. The analog intensity actuator may be mechanically coupled to a potentiometer.

In some examples, the actuator may include a slider control configured to move in a vertical direction along an elongated slot to provide the local control command of the electrical load. For example, the slider control may include a slider slot and a slider knob. The visible display may be provided on a rear surface of the slider slot. The control circuit may be configured to illuminate the visible display as a plurality of segments. Each of the plurality of segments may be any shape, such as rectangular in shape or circular in shape. In some examples, the control circuit may be configured to illuminate the visible display as a continuous light bar.

In some examples, the actuator may include a non-continuously rotatable rotary knob configured to be rotatable with respect to a base portion of the control device to provide the local control command of the electrical load.

In some examples, the control circuit may be configured to determine whether a most recent control event was in response to an action of the actuator or in response to reception of the message.

A control device for controlling an electrical load may include an analog intensity adjustment actuator, a plurality of light sources, and a visible display. In some examples, the visible display may define a plurality of segments that can be controllably illuminated onto a back of a front surface of the control device by the plurality of light sources to indicate an amount of power delivered to the electrical load. The control device may include a control circuit that is configured to control the amount of power delivered to the electrical load in response to movement of the analog intensity adjustment actuator, determine a number of segments of the plurality of segments to illuminate based on the amount of power delivered to the electrical load, and illuminate the number of segments of the visible display to indicate the amount of power delivered to the electrical load. The control device may include a controllably conductive device that is adapted to be coupled in series electrical connection between an AC power source and the electrical load. In such examples, the control circuit may be configured to control the controllably conductive device to control the amount of power delivered to the electrical load. The control device may include a communication circuit that is configured to receive a message from a remote device. In such examples, the control circuit may be configured to control the amount of power delivered to the electrical load based on the message received from the remote device. The front surface of the control device may include an illumination surface. For example, the analog intensity adjustment actuator may include a slider knob that is configured to move in a linear direction along an elongated slot, and the illumination surface may be located behind the elongated slot. For example, the illumination surface may be located behind the slider knob. The control device may include a diffuser that defines the illumination surface. In some examples, the diffuser may include an elongated portion that resides behind the elongated slot, and the diffuser may be configured to move with the slider knob along the elongated slot. In some examples, the diffuser may be configured to be mechanically coupled to the slider body such that the diffuser is configured to move with the slider knob along the elongated slot. The control device may include a bezel defining the illumination surface is provided on the bezel.

In some examples, the control device may include a tunnel structure that is located between the plurality of light sources and the visible display. The tunnel structure may be configured to cause the visible display to illuminate the plurality of segments. For example, the tunnel structure may include a plurality of apertures that are configured to cause the illumination surface to illuminate in the plurality of segments. Each of the plurality of light sources may be aligned with one of the plurality of apertures. The plurality of light sources may be directly adjacent to a back side of the tunnel structure. In some examples, the plurality of segments includes nine segments.

In some examples, the analog intensity adjustment actuator may include a slider knob that defines a length. The length of the slider knob may be equal to or greater than the length of each of the plurality of segments. For example, the length of the slider knob may be at least two times greater than a length of each of the plurality of segments.

In some examples, the control circuit may be configured to illuminate the number of segments of the visible display to indicate an intensity of a lighting load. Each of the plurality of segments may be any shape, such as rectangular in shape or circular in shape.

A control device for controlling an electrical load in a load control system may include a slider knob configured to move along an elongated slot adjacent to the actuation member, at least one light source, and a diffuser. The diffuser may include an elongated portion that resides behind the elongated slot (e.g., to form a visible display and/or illumination surface). The diffuser may be configured to be illuminated by the at least one light source. The diffuser may be configured to move with the slider knob along the elongated slot. The control device may also include a control circuit that is configured to control the amount of power delivered to the electrical load in response movement of the slider knob along the elongated slot, and to illuminate at least a portion of the diffuser.

The control device may include a slider body that defines the slider knob. The diffuser may be configured to be mechanically coupled to the slider body such that the diffuser is configured to move with the slider knob along the elongated slot. In some examples, the control device may include a bezel that defines the elongated slot on a front side of the bezel and a channel on a back side of the bezel. In such examples, the slider body may define one or more nubs that are configured to reside within the channel of the bezel to allow the slider knob to move along the elongated slot. For example, the bezel may define a first channel and a second channel on the back side of the bezel, and the second channel may include the elongated slot. The one or more nubs may be configured to reside within the first channel. One or more of the slider knob or diffuser may be configured to reside within the second channel to allow the slider knob to move along the elongated slot. For example, the one or more nubs residing within the channel may be configured to reduce transverse force on the diffuser in response to movement of the slider knob along the elongated slot.

In some examples, the mechanical coupling may include a snap-fit coupling between the diffuser and the slider body.

In some examples, the slider body may be mechanically coupled to a potentiometer of the load control device, such that the potentiometer generates a direct-current (DC) voltage representative of the desired amount of power to be delivered to the electrical load. For example, the slider body may include a potentiometer shaft that comprises a notch that is configured to engage the potentiometer such that movement of the slider knob along the elongated slot causes adjustment of the potentiometer. In some examples, the slider knob may be offset from the notch. The slider body may include a slider shaft. The slider knob may be located at a distal end of the slider shaft. The slider shaft may extend outward from the potentiometer shaft at a substantially perpendicular angle. The slider body may include a notch that mechanically couples the slider body to the potentiometer, and the notch is offset from the slider knob.

In some examples, the diffuser may be able to rotate with respect to the slider knob. In some examples, the control device may include a tunnel structure located between the plurality of light sources and the diffuser, and the tunnel structure may be configured to cause the diffuser to illuminate a plurality of discrete segments along the elongated slot. In some examples, the control device may include an actuation member and a center spring. The center spring may be configured to be located adjacent a center, back surface of the actuation member to allow the actuation member to pivot in response to an actuation of an upper portion of the actuation member or a lower position of the actuation member. For example, the center spring may include a rubber membrane. In some examples, the control device may include a controllably conductive device adapted to be coupled in series electrical connection between an AC power source and the electrical load. In such examples, the control circuit may be configured to control the controllably conductive device to control the amount of power delivered to the electrical load in response to the movement of the slider knob along the elongated slot.

In some examples, the control device may include an actuation member configured to pivot in response to an actuation of an upper portion of the actuation member or a lower position of the actuation member. In such examples, the control circuit may be configured to control a controllable conductive device to connect an AC power source to the electrical load in response to an actuation of the upper portion of the actuation member, and configured to control the controllable conducive device to disconnect the AC power source from the electrical load in response to an actuation of the lower portion of the actuation member. The actuator may include a slider control configured to move in a linear direction along an elongated slot to provide the local control of the electrical load.

In some examples, the control device may include a communication circuit. In such examples, the control circuit may be configured to transmit a digital message, via the communication circuit, to control the amount of power delivered to the electrical load in response to movement of the slider knob along the elongated slot.

In some examples, the control circuit may be configured to illuminate the diffuser as a continuous light bar in response movement of the slider knob along the elongated slot.

### BRIEF DESCRIPTION OF THE DRAWINGS

FIG. 1 depicts an example load control system that includes one or more example control devices.

FIG. 2 is a perspective view of an example control device that may be deployed as a dimmer switch of the load control system illustrated in FIG. 1.

FIG. 3 is a front view of the control device of FIG. 2.

FIGS. 4A-4D are front views of the control device of FIG. 2 illustrating an illuminated surface of a diffuser that is illuminated in segments at various levels based on the position of the slider knob along the slider slot.

FIGS. 5A-5D are front views of the control device of FIG. 2 illustrating an illuminated surface of a diffuser that is illuminated in segments at various levels based on received messages irrespective of the position of the slider knob along the slider slot.

FIGS. 6A-6D are front views of the control device of FIG. 2 illustrating an illuminated surface of a diffuser that is illuminated in a continuous bar at various levels based on the position of the slider knob along the slider slot.

FIGS. 7A-7D are front views of the control device illustrating an illuminated surface of a diffuser that is illuminated in a continuous bar at various levels based on received messages irrespective of the position of the slider knob along the slider slot.

FIG. 8 is a front view of an example control device without a faceplate that may be deployed as a dimmer switch of the load control system illustrated in FIG. 1.

FIG. 9 is a cross-sectional view of the control device of FIG. 8 taken through the line shown in FIG. 8.

FIG. 10 is a cross-sectional view of the control device of FIG. 8 taken through the line shown in FIG. 8.

FIG. 11 is a top cross-sectional view of the control device of FIG. 8 taken through the line shown in FIG. 8.

FIG. 12 is a magnified view of the cross-sectional view of the control device of FIG. 11.

FIG. 13 is a partially exploded view of the control device of FIG. 8.

FIG. 14 and FIG. 15 illustrate rear perspective views of the base portion of the control device of FIG. 8 with the actuation portion, the slider, and the diffuser installed.

FIG. 16 illustrates a side, perspective view of the diffuser and the slider of the control device of FIG. 8 coupled together.

FIG. 17 illustrates a front, perspective view of the diffuser and the slider of the control device of FIG. 8 coupled together.

FIG. 18 illustrates the front, perspective view of the diffuser and the slider of the control device of FIG. 8 separated from one another.

FIGS. 19-24 illustrate various perspective views of an example control device that may be deployed as a dimmer switch of the load control system illustrated in FIG. 1.

FIG. 25 shows a simplified block diagram of an example control device (e.g., dimmer switch) that may be implemented as the control device illustrated in FIG. 2, the control device illustrated in FIG. 8, and/or the control device illustrated in FIG. 19.

FIG. 26 is a flowchart of an example procedure for determining the number of segments of an illumination surface of a control device to illuminate based on whether a command to adjust the intensity level of a lighting load is received from a user interface of the control device or from a remote device.

FIG. 27 is a flowchart of an example procedure for determining the number of segments of an illumination surface of a control device to illuminate based on the commanded intensity of a lighting load.

FIG. 28 is a flowchart of an example procedure for adjusting on and/or off, with respect to time, one or more light sources (e.g., one or more LEDs) of a control device based on whether a command to adjust the intensity level of a lighting load is received from a user interface of the control device or from a remote device.

FIG. 29 is a flowchart of an example procedure for adjusting on and/or off, with respect to time one or more light sources (e.g., one or more LEDs) of a control device based on whether a command to adjust the intensity level of a lighting load is received from a user interface of the control device or from a remote device, and further based on the size of the change to the intensity.

FIGS. 30A-30C are front views of an example control device illustrating a visible display that is comprised of a plurality of visible indicators.

FIGS. 31A-31C are front views of an example control device illustrating an illumination surface of a user interface that is configured to be illuminated in a continuous bar.

FIGS. 32A-32C are front views of an example control device illustrating a visible display that is comprised of a plurality of visible indicators.

FIG. 33 is a flowchart of an example procedure for controlling a visible display to indicate whether the present intensity of the lighting load is in synchronization with the position of a slider knob along a slider slot.

FIGS. 34A-34B are front views of an example control device illustrating a visible display that is comprised of a visible indicator on a slider knob of a slider actuator.

FIG. 35 is a flowchart of an example procedure for controlling a visible display to indicate whether the present intensity of the lighting load is in synchronization with the position of a slider knob along a slider slot.

### DETAILED DESCRIPTION

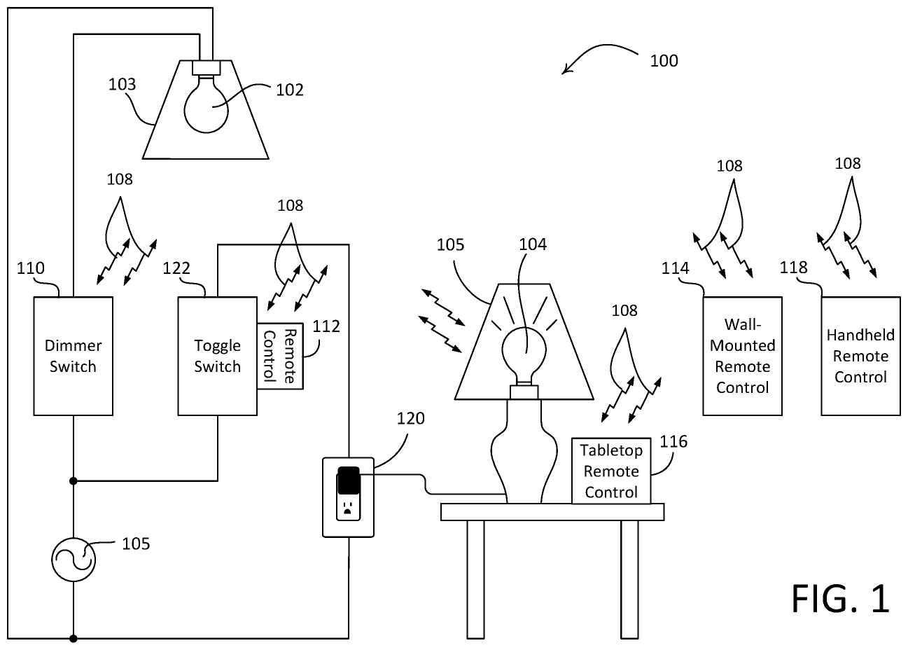

FIG. 1 is a simplified block diagram of an example load control system. As shown, the load control system is configured as a lighting control system 100 for control of one or more lighting loads, such as a lighting load 102 that is installed in a ceiling-mounted downlight fixture 103 and a controllable lighting load 104 that is installed in a table lamp 105. The lighting loads 102, 104 shown in FIG. 1 may include light sources of different types (e.g., incandescent lamps, fluorescent lamps, and/or LED light sources). The lighting loads may have advanced features. For example, the lighting loads may be controlled to emit light of varying intensities and/or colors in response to a user command. The amount of power delivered to the lighting loads may be adjusted to an absolute level or by a relative amount. The lighting control system 100 may be configured to control one or more of the lighting loads (e.g., and/or other electrical loads) according to one or more configurable presets or scenes. These presets or scenes may correspond to, for example, predefined light intensities and/or colors, predefined entertainment settings such as music selection and/or volume settings, predefined window treatment settings such as positions of shades, predefined environmental settings such as HVAC settings, or any combination thereof. The presets or scenes may correspond to one or more specific electrical loads (e.g., bedside lamps, ceiling lights, etc.) and/or one or more specific locations (e.g., a room, an entire house, etc.).

The lighting load 102 may be an example of a lighting load that is wired into a power control and/or delivery path of the lighting control system 100. As such, the lighting load 102 may be controllable by a wall-mounted control device such as a dimmer switch. The lighting load 104 may be an example of a lighting load that is equipped with integral load control circuitry and/or wireless communication capabilities such that the lighting load may be controlled via a wireless control mechanism (e.g., by a remote control device).

The lighting control system 100 may include one or more control devices for controlling the lighting loads 102, 104 (e.g., controlling an amount of power delivered to the lighting loads). The lighting loads 102, 104 may be controlled substantially in unison, or be controlled individually. For example, the lighting loads may be zoned so that the lighting load 102 may be controlled by a first control device, while the lighting load 104 may be controlled by a second control device. The control devices may be configured to turn the lighting loads 102, 104 on and off. The control devices may be configured to control the magnitude of a load current conducted through the lighting loads (e.g., so as to control an intensity level of the lighting loads 102, 104 between a low-end intensity level L_{LE} and a high-end intensity level L_{HE}). The control devices may be configured to control an amount of power delivered to the lighting loads to an absolute level (e.g., to a maximum allowable amount), or by a relative amount (e.g., an increase of 10% from a current level). The control devices may be configured to control a color of the lighting load 102, 104 (e.g., by controlling a color temperature of the lighting loads or by applying full color control over the lighting loads).

The control devices may be configured to activate a preset associated with the lighting load 102, 104. A preset may be associated with one or more predetermined settings of the lighting loads, such as an intensity level of the lighting loads and/or a color of the lighting loads. The presets may be configured via the control device and/or via an external device (e.g., a mobile device) by way of a wireless communication circuit of the control device. The control devices may be configured to activate control of a zone. A zone may correspond to one or more electrical loads that are configured to be controlled by the control devices. A zone may be associated with a specific location (e.g., a living room) or multiple locations (e.g., an entire house with multiple rooms and hallways). The control devices may be configured to switch between different operational modes. An operational mode may be associated with controlling different types of electrical loads or different operational aspects of one or more electrical loads. Examples of operational modes may include a lighting control mode for controlling one or more lighting loads (e.g., which in turn may include a color control mode and an intensity control mode), an entertainment system control mode (e.g., for controlling music selection and/or the volume of an audio system), an HVAC system control mode, a winter treatment device control mode (e.g., for controlling one or more shades), and/or the like.

One or more characteristics of the control device and/or the lighting load 102, 104 described herein may be customized via an advanced programming mode (APM). Such characteristics may include, for example, an intensity level associated with a preset, a fade-on/fade-off time, enablement/disablement of visible indicators, a low-end trim (e.g., a minimum intensity level to which the lighting load 102, 104 may be set by the control device), a high-end trim (e.g., a maximum intensity level to which the lighting load 102, 104 may be set by the control device), and/or the like. Examples of an advanced programming mode for a wall-mounted load control device can be found in U.S. Pat. No. 7,190,125, issued Mar. 13, 2007, entitled PROGRAMMABLE WALLBOX DIMMER, the entire disclosure of which is hereby incorporated by reference. The control device may be manipulated to enter the advanced programming mode in various ways. For instance, the control device may be moved into the advanced programming mode via a press-and-hold or a double-tap applied to a front area of the control device. Ways to activate the advanced programming mode for a control device will be described in greater detail below.

The control device described herein may be, for example, a dimmer switch 110, a retrofit remote control device 112, a wall-mounted remote control device 114, a tabletop remote control device 116, and/or a handheld remote control device 118, as shown in FIG. 1. The dimmer switch 110 may be configured to be mounted to a standard electrical wallbox (e.g., via a yoke) and be coupled in series electrical connection between an alternating-current (AC) power source 105 and a lighting load that is wired into the control path of the dimmer switch 110 (e.g., such as the lighting load 102). The dimmer switch 110 may receive an AC mains line voltage V_{AC} from the AC power source 105, and may generate a control signal for controlling the lighting load 102. The control signal may be generated via various phase-control techniques (e.g., a forward phase-control dimming technique or a reverse phase-control dimming technique). The dimmer switch 110 may be configured to receive wireless signals (e.g., from a remote control device) representative of commands to control the lighting load 102, and generate respective control signals for executing the commands. Examples of wall-mounted dimmer switches are described in greater detail in commonly-assigned U.S. Pat. No. 7,242,150, issued Jul. 10, 2007, entitled DIMMER HAVING A POWER SUPPLY MONITORING CIRCUIT; U.S. Pat. No. 7,546,473, issued Jun. 9, 2009, entitled DIMMER HAVING A MICROPROCESSOR CONTROLLED POWER SUPPLY; and U.S. Pat. No. 8,664,881, issued Mar. 4, 2014, entitled TWO-WIRE DIMMER SWITCH FOR LOW-POWER LOADS, the entire disclosures of which are hereby incorporated by reference.

The retrofit remote control device 112 may be configured to be mounted to a mechanical switch (e.g., a toggle switch 122) that may be pre-existing in the lighting control system 100. Such a retrofit solution may provide energy savings and/or advanced control features, for example without requiring significant electrical re-wiring and/or without requiring the replacement of existing mechanical switches. As an example, a consumer may replace an existing lamp with the controllable lighting load 104, switch a toggle switch 122 that is coupled to the lighting load 104 to the on position, install (e.g., mount) the remote control device 112 onto the toggle switch 122, and associate the remote control device 112 with the lighting source 104. The retrofit remoted control 112 may then be used to perform advanced functions that the toggle switch 122 may be incapable of performing (e.g., such as dimming the intensity level of the light output, changing the color of the light output, providing feedback to a user, etc.). As shown, the toggle switch 122 is coupled (e.g., via a series electrical connection) between the AC power source 105 and an electrical receptacle 120 into which the lighting load 104 may be plugged (e.g., as shown in FIG. 1). Alternative, the toggle switch 122 may be coupled between the AC power source 105 and one or more of the lighting loads 102, 104, without the electrical receptacle 120.

The wall-mounted remote control device 114 may be configured to be mounted to a standard electrical wallbox and be electrically connected to the AC power source 105 for receiving power. The wall-mounted remote control device 114 may be configured to receive a user input and may generate and transmit a control signal (e.g., control data such as a digital message) for controlling the lighting loads 102, 104 in response to the user input. The tabletop remote control device 116 may be configured to be placed on a surface (e.g., an end table or night stand), and may be powered by a direct-current (DC) power source (e.g., a battery or an external DC power supply plugged into an electrical outlet). The tabletop remote control device 116 may be configured to receive a user input, and may generate and transmit a signal (e.g., a digital message) for controlling the lighting loads 102, 104 in response to the user input. The handheld remote control device 118 may be sized to fit into a user's hand, and may be powered by a direct-current (DC) power source (e.g., a battery or an external DC power supply plugged into an electrical outlet). The handheld remote control device 118 may be configured to receive a user input, and may generate and transmit a signal (e.g., a digital message) for controlling the lighting loads 102, 104 in response to the user input. Examples of battery-powered remote controls are described in greater detail in commonly assigned U.S. Pat. No. 8,330,638, issued Dec. 11, 2012, entitled “Wireless Battery Powered Remote Control Having Multiple Mounting Means,” and U.S. Pat. No. 7,573,208, issued Aug. 11, 2009, entitled “Method Of Programming A Lighting Preset From A Radio-Frequency Remote Control,” the entire disclosures of which are hereby incorporated by reference.

It should be appreciated that, although a lighting control system with one or more lighting loads are provided examples herein, a load control system as described herein may include more or fewer lighting loads, other types of lighting loads, and/or other types of electrical loads that may be configured to be controlled by the one or more control devices described herein. That is, the control devices are not limited to the control of just lighting loads. For example, the load control system may include one or more of and the control devices may be configured to control one or more of: a dimming ballast for driving a gas-discharge lamp; an LED driver for driving an LED light source; a dimming circuit for controlling the intensity level of a lighting load; a screw-in luminaire including a dimmer circuit and an incandescent or halogen lamp; a screw-in luminaire including a ballast and a compact fluorescent lamp; a screw-in luminaire including an LED driver and an LED light source; an electronic switch, controllable circuit breaker, or other switching device for turning an appliance on and off; a plug-in control device, controllable electrical receptacle, or controllable power strip for controlling one or more plug-in loads; a motor control unit for controlling a motor load, such as a ceiling fan or an exhaust fan; a drive unit for controlling a motorized window treatment or a projection screen; one or more motorized interior and/or exterior shutters; a thermostat for a heating and/or cooling system; a temperature control device for controlling a setpoint temperature of a heating, ventilation, and air-conditioning (HVAC) system; an air conditioner; a compressor; an electric baseboard heater controller; a controllable damper; a variable air volume controller; a fresh air intake controller; a ventilation controller; one or more hydraulic valves for use in radiators and radiant heating system; a humidity control unit; a humidifier; a dehumidifier; a water heater; a boiler controller; a pool pump; a refrigerator; a freezer; a television and/or computer monitor; a video camera; an audio system or amplifier; an elevator; a power supply; a generator; an electric charger, such as an electric vehicle charger; an alternative energy controller; and/or the like.

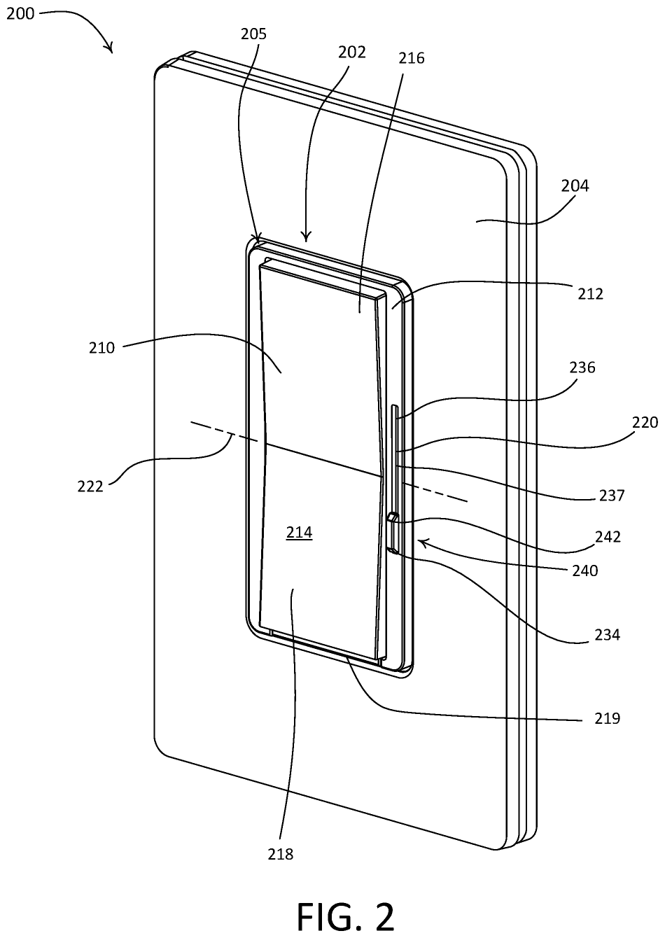

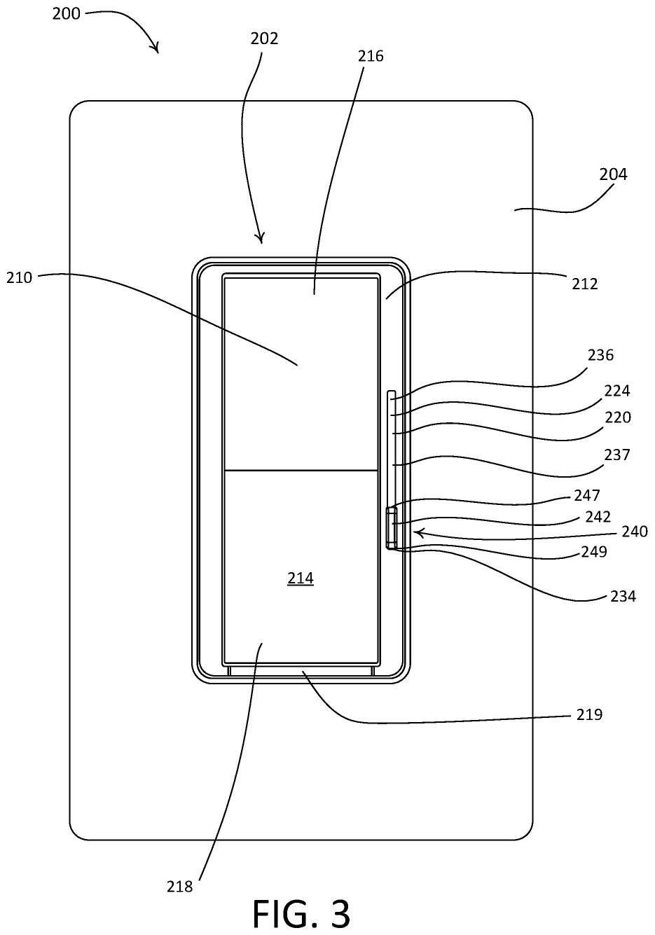

FIG. 2 is a perspective front view and FIG. 3 is a front view of an example control device 200 that may be deployed as the dimmer switch 110, the retrofit remote control device 112, and/or the wall-mounted remote control device 114 in the lighting control system 100. The control device 200 may comprise a user interface 202 and a faceplate 204. The control device 200 may be configured to control the amount of power delivered to an electrical load (e.g., the amount of power, or intensity, of a lighting load). For example, the control device 200 may be configured to turn the lighting load on or off or adjust the intensity level of the lighting load by controlling an internal load control circuit (e.g., a controllably conductive device of the control device 200) and/or by transmitting a message for controlling the lighting load via a communication circuit, e.g., via one or more wireless signals, such as radio-frequency (RF) signals.

The control device 200 may comprise an air-gap actuator 219 configured to open and close an air-gap switch (not shown) that is adapted to be electrically coupled (e.g., substantially directly electrically coupled) in series between a power source (e.g., an AC power source) and the lighting load. The air-gap switch may be opened in response to pulling the air-gap switch actuator 219 out from the control device 200 to provide an actual air-gap barrier between the power source and the lighting load to facilitate servicing of the lighting load.

The user interface 202 of the control device 200 may include an actuation member 210 that is configured to be received in an opening of a bezel 212 (e.g., a base portion) of the control device 200. The actuation member 210 may comprise a front surface 214 including an upper portion 216 and a lower portion 218. The actuation member 210 may be configured to pivot about a pivot axis 222 (e.g., a central axis) in response to a tactile actuation (e.g., a tactile input) of the upper portion 216 and the lower portion 218. Alternatively or additionally, the front surface of the actuation member 210 may comprise a touch sensitive surface (e.g., capacitive touch sensitive surface), and the control device may be responsive to touch actuations along the front surface of the actuation member 210. Examples of a control device that includes an actuation member whose front surface includes a touch sensitive surface can be found in commonly-assigned U.S. Patent Application Pub. No. US 2021/0068238, published Mar. 4, 2021, entitled CONTROL DEVICE HAVING A VISIBLE INDICATOR, the entire disclosure of which is hereby incorporated by reference. In some of these instances, the bezel 212 may comprise a touch sensitive surface (e.g., as opposed to the actuation member 210).

The control device 200 may be configured to control a lighting load of the lighting control system 100 to turn the lighting load on in response to a tactile actuation of the upper portion 216, and to turn the lighting load off in response to a tactile actuation of the lower portion 218 (or vice versa). For example, the control device 200 may include a controllably conductive device adapted to be coupled in series electrical connection between an alternating current (AC) power source and the lighting load. The control device 200 may be configured to control the amount of power delivered to the lighting load in response to actuations of the actuation member 210. For example, the control device 200 may control the controllable conductive device to connect the AC power source to the lighting load in response to an actuation of an upper portion 216 of the actuation member 210, and control the controllable conducive device to disconnect the AC power source from the lighting load in response to an actuation of a lower portion 218 of the actuation member 210. The control device 200 may include one or more tactile switches that are actuated in response to the tactile actuations of the upper and/or lower portions 216, 218 of the actuation member 210, for example, as described herein.

The control device 200 may include an analog adjustment actuator that is configured to provide a local control command of the electrical load to control a characteristic of the electrical load (e.g., intensity and/or color of a lighting load, speed of a motor, etc.), and the position of a movable component of the analog adjustment actuator may indicate a value of a characteristic of an electrical load via local control. The control device 200 is described primarily with reference to intensity control of a lighting load but is not so limited. For example, the control device 200 may include an analog intensity adjustment actuator to provide a local control command of the lighting load, such as, for example, a slider actuator 240 comprising a slider knob 242 movable along a slider slot 237.

An analog intensity adjustment actuator may include a movable component, such as a slider knob or rotatory knob, and the position of the movable component (e.g., the position of the slider knob 242 along the length of the slider slot 237 or the rotational position of the rotary knob) may indicate the commanded intensity level Lao) of the lighting load via local control. For example, the analog intensity adjustment actuator may be configured to adjust a variable characteristic, like resistance, that is variable based on the position of the movable component. Stated another way, the analog intensity adjustment actuator may include a movable component that is moveable about the bezel 212 of the control device 200, and the position of the movable component (e.g., relative to the bezel 212) may indicate the commanded intensity level Loki) of the lighting load via local control. In some examples, the analog intensity adjustment actuator may include a potentiometer (e.g., a potentiometer that is an analog circuit and/or or a digital potentiometer circuit). For instance, the analog intensity adjustment actuator may include an intensity adjustment actuator that is commonly used in an analog dimmer switch (e.g., a dimmer switch that does not include a microprocessor but allows for intensity adjustment), for example, even though the control device 200 may comprises a control circuit (e.g., as described herein). Finally, although primarily described in context of a slider actuator 240 that moves or slides along the slider slot 237 (e.g., moves continuously along the slider slot 237), in other examples the control device 200 may include a slider actuator that moves in discrete increments (e.g., steps) along the slider slot 237.

The control device 200 may be configured to control the magnitude of a load current conducted through the lighting load (e.g., and thus the intensity level of the lighting load) in response to movement of the slider knob 242 along the slider slot 237. Accordingly, the control device 200 may be configured to adjust a present intensity level L_{PRES} of the lighting load from an initial intensity level L_{INIT} to a commanded intensity level L_{CMD} in response to actuation of the intensity adjustment actuator (e.g., movement of the slider knob 242 along the slider slot 237). The initial intensity level L_{INIT} may be the intensity level of the lighting load before actuation, while the commanded intensity level L_{CMD} may be determined based on the relative position of the slider knob 242 along the slider slot 237 in response to user actuation. As such, the control device 200 may receive a local control command of the lighting load in response to actuation of the intensity adjustment actuator by the user.

When, for example, the lighting load is on, the control device 200 may control the present intensity level L_{PRES} of the lighting load in response to movement of the slider knob 242 along the slider slot 237. When the lighting load is off, the control device 200 may not adjust the present intensity level L_{PRES} of the lighting load in response to movement of the slider knob 242. But, when the lighting load is off and the upper portion 216 of the actuation member 210 is actuated, the control device 200 may turn on the lighting load to an intensity level determined based on the position of the slider knob 242 along the slider slot 237.

Although illustrated as moving in a linear, vertical direction, the slider knob 242 (e.g., and slider slot 237) may be configured to move in a linear, horizontal direction or a linear, diagonal direction across the bezel 212 and/or the actuation portion 210, and/or the slider knob 242 may be configured to move in a non-linear direction, such as a circular direction or a winding direction across the bezel 212 and/or the actuation portion 210. For instance, in some examples, the slider slot 237 may be circular (e.g., semi-circular) or another continuous non-linear shape. Further, in some examples, the analog intensity adjustment actuator may include a rotary knob (e.g., a non-continuously-rotatable rotary knob) that is configured to be rotatable with respect to the bezel 212 to provide a local control command of the lighting load. For instance, the rotary knob may be characterized by non-continuous rotation between a high-end stopping point (e.g., associated with high-end power being delivered to the electrical load, such as the high-end intensity level L_{HE} of a lighting load) and a low-end stopping point (e.g., associated with low-end power being delivered to the electrical load, such as the low-end intensity level L_{LE} of a lighting load).

The control device 200 may include a potentiometer, which may be adjusted in response to a user input provided to the slider knob 242 in order to control the amount of power delivered to the lighting load. For example, the potentiometer may generate a direct-current (DC) voltage representative of the desired amount of power to be delivered to the electrical load. In some examples, the potentiometer may provide a variable resistance based on the position of the slider knob 242 along the slider slot 237. For example, the potentiometer may be coupled to intensity adjustment actuator (e.g., the slider knob 242), for example, as described in more detail herein. In examples where the electrical load is a lighting load, the slider knob 242 may allow a user to adjust the present intensity level L_{PRES} of the lighting load from a low-end intensity level L_{LE} to a high-end intensity level L_{HE}. Alternatively, in some examples, the control device 200 may include a linear encoder, a combination of a wiper and a resistive trace on a printed circuit board of the control device 200, a mechanical or magnetic encoder, etc. instead of a potentiometer.

The slider knob 242 may be configured to move along (e.g., within) an elongated slot, such as the slider slot 237. The slider slot 237 may be an elongated opening in the bezel 212 of the control device 200. For example, the slider slot 237 may be located adjacent to the actuation member 210. Alternatively, the slider slot 237 may be located in the actuation member 210, and for example, may move in response to actuations of the actuation member 210. Further, in some instances, the slider slot 237 may be located in the faceplate 204, for example, in instances where the faceplate 204 is part of the control device 200.

The slider knob 242 may be configured to move in a linear direction, such as a vertical direction along the slider slot 237 between a low-end position 234 (as shown in FIG. 2, where the slider knob 242 is located at the bottom of the slider slot 237) and a high-end position 236 (e.g., where the slider knob 242 is located at the top of the slider slot 237). The slider knob 242 may allow for adjustment of the intensity level L of the lighting load from the low-end intensity level L_{LE} (e.g., when the slider knob 242 is located in the low-end position 234) to the high-end intensity level L_{HE} (e.g., when the slider knob 242 is located in the high-end position 236). Accordingly, the slider knob 242 may be configured to move in a vertical direction along the length of the slider slot 237 of the bezel 212, and the bezel 212 may be configured to be received in an opening of the faceplate 204.

Further, although illustrated and described as being configured to move in the vertical direction, in some examples the slider knob 242 may be configured to move in the horizontal direction. In such instances, the slider slot 237 may be located in the bezel 212 above or below the actuation member 210 (e.g., or within the actuation member 210) along the horizontal direction. Further, in such instances, the low-end position may be towards the leftmost side of the slider slot 237, while the high-end position may be towards the rightmost side of the slider slot 237.

The user interface 202 may include a visible display, such as an illumination surface 224. For example, a front surface of a diffuser 220 may define the illumination surface 224 of the user interface 202. As such, for example, the user interface 202 may comprise the length of the slider slot 237. The illumination surface 224 of the user interface 202 may be illuminated to provide feedback, such as the amount of power delivered to the electrical load. As described in more detail below, the illumination surface 224 may be illuminated using one or more light sources of the control device, such as top-firing (e.g., top-emitting) or side-firing (e.g., side-emitting) light-emitting diode (LED) light sources. Accordingly, the control device 200 may be configured to illuminate one or more internal light sources (e.g., LEDs) to illuminate the visible display (e.g., to provide feedback indicating the intensity level of the lighting load). Finally, in some examples, the control device 200 may include one or more light pipes, where each light pipe may be configured to guide light from one or more of the plurality of light sources to the linear array of visible indicators to indicate the intensity of the lighting load.

The slider slot 237 (e.g., the combination of the slider knob 242 and the illumination surface 224) may provide multiple types of feedback, such as any combination of an indication of the amount of power provided to the electrical load (e.g., the intensity of a lighting load, the speed of a ceiling fan, etc.), an indication of whether the slider knob 242 is in synchronization with (e.g., aligned with) the amount of power being provided to the electrical load, an indication of one or more characteristics of the electrical load (e.g., a color and/or color temperature of light emitted from a lighting load), and/or the like. For example, the illumination surface 224 may provide feedback indicating the present intensity level L_{PRES} of the lighting load. In examples where the control device 200 is configured to adjust a color (e.g., color temperature) of a lighting load, the illumination surface 224 may provide feedback indicating the color of the lighting load (e.g., the control device 200 may illuminate the illumination surface 224 along a color gradient for color control (e.g., cool white at one end and warm white at another end of the illumination surface 224)).

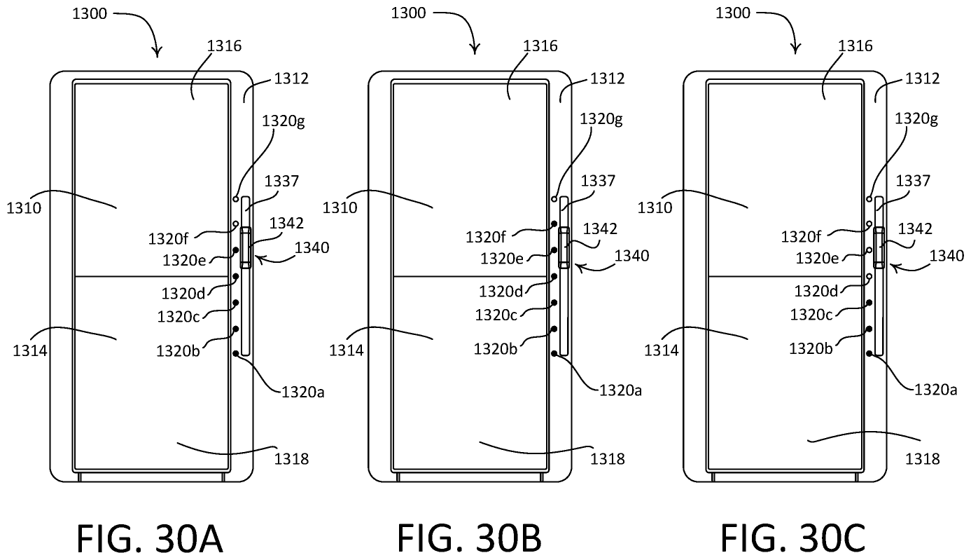

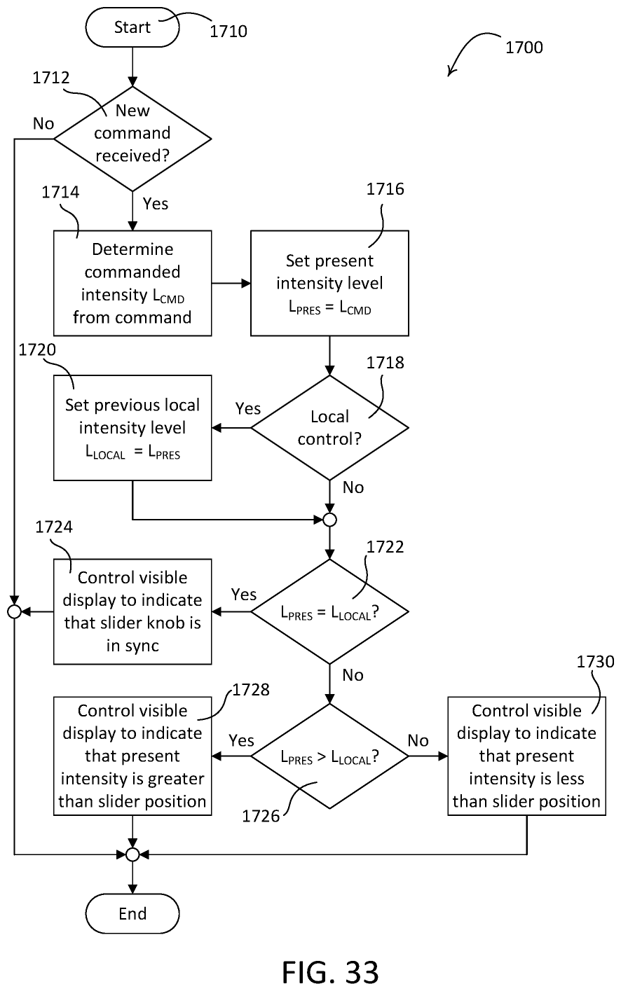

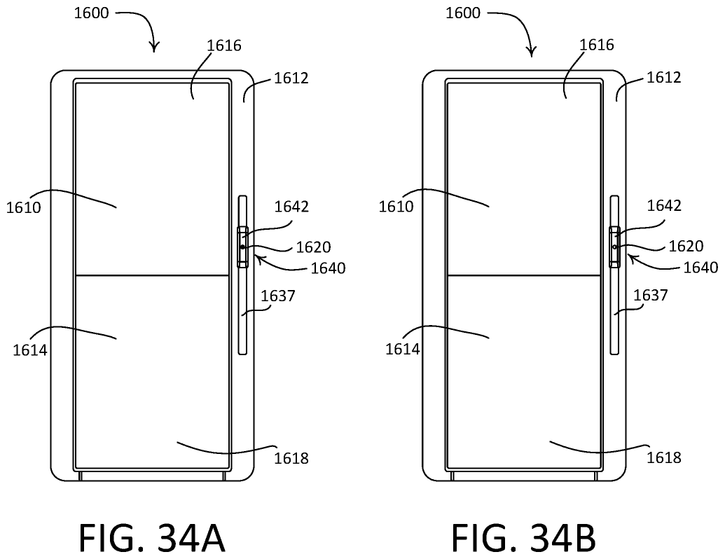

Although described in context of the illumination surface 224 within the slider slot 237, in one or more other examples, the control device 200 may include a different visible display. Foe example, the control device 200 may include a visible display that comprises a linear array of visible indicators that are configured to indicate the intensity of the lighting load. For example, each visible indicator of the linear array of visible indicators may be one or more openings in the bezel 212 (e.g., such as shown in FIG. 30A-30C). For instance, the actuation member 210 may be located between the linear array of visible indicators and the slider slot 237. In other examples, the linear array of visible indicators may be located adjacent the slider slot 237, such as between the actuation member 210 and the slider slot 237 (e.g., such as shown in FIG. 30A-30C) or between the slider slot 237 and the perimeter of the bezel 212, such that the slider slot 237 is located between the actuation member 210 and the linear array of visible indicators. Alternatively or additionally, the front surface of the bezel 212 may be illuminated with segments or a continuous light bar (e.g., the bezel 212 may be translucent, and as such, the openings may not be needed). Further, in some examples, the slider knob 242 may include a visible indicator (e.g., such as shown in FIGS. 34A-33B). For example, the slider knob 242 may include an opening for a visible indicator (e.g., a single illuminated segment) that may indicate whether the present intensity level L_{PRES} of the lighting load is in synchronization with the position of the slider knob 242 along the slider slot (e.g., by illuminating the visible indicator) or whether the present intensity level L_{PRES} of the lighting load is not in synchronization with the position of the slider knob 242 (e.g., by maintaining the visible indicator off).

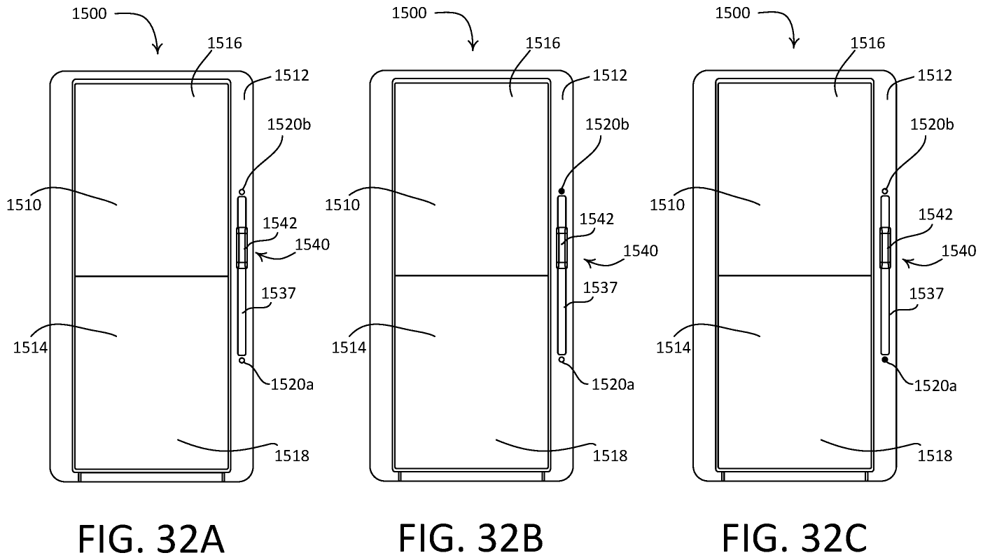

Further, in one specific example (e.g., such as shown in FIG. 32A-32C), the control device 200 may include a first visible indicator that is located above the slider slot 237 and a second visible indicator located below the slider slot 237. In such examples, the first and second indicators are used to indicate whether the present intensity level L_{PRES} of the lighting load is in synchronization with the position of the slider knob 242 along the slider slot (e.g., by maintaining the visible indicators off) or whether the present intensity level L_{PRES} of the lighting load is not in synchronization with the position of the slider knob 242 (e.g., by illuminating the first visible indicator when the present intensity level L_{PRES} of the lighting load is greater than the intensity level associated with the position of the slider knob 242, or by illuminating the second visible indicator when the present intensity level L_{PRES} of the lighting load is less than the intensity level associated with the position of the slider knob 242). Accordingly, in this example, the first and second indicators may be used to indicate whether the intensity of the lighting load, when controlled via a remote control, is out of synchronization with the corresponding intensity level associated with a position of the slider knob 242 along the slider slot 237 (e.g., whether the intensity level is above or below the corresponding intensity level associated with the position of the slider knob 242 along the slider slot 237).

Referring back to FIGS. 2 and 3, the diffuser 220 may be located adjacent (e.g., behind) the slider slot 237, for example, such that the illumination surface 224 of the user interface 202 may be visible from a front surface of the control device 200 (e.g., visible to a user standing in front of the control device 200). The diffuser 220 (e.g., the elongated portions of the diffuser 220) may be linear. In some examples, the diffuser 220 may extend along (e.g., behind) the bezel 212 adjacent the actuation member 210. Alternatively, the diffuser 220 may extend along (e.g., behind) a front surface of the actuation member 210. In some examples, the diffuser 220 may be located behind the slider knob 242 (e.g., farther from a front surface of the bezel 212 than the slider knob 242). As an example and as described below, at least a portion of the diffuser 220 may be mechanically coupled to the slider knob 242. In such instances, the diffuser 220 may be configured to move behind the slider slot 237 in response to movements of the slider knob 242. Alternatively, in some examples, at least a portion of the diffuser 220 may affixed in place (e.g., not coupled to the slider knob 242), and for instance, located behind the slider knob 242.

The control device 200 may be configured to illuminate the illumination surface 224 of the user interface 202 using one or more light sources (e.g., one or more LEDs) of the control device 200 to visibly display information, such as the intensity level of one or more lighting loads controlled by the control device 200. For example, the illumination surface 224 may be configured to be illuminated to display the amount of power delivered to an electrical load(s) (e.g., the intensity level of the lighting load(s), the amount of power delivered to a motor, e.g., that controls a fan or motorized window treatment, etc.) controlled by the control device 200 based on the position of the slider knob 242 (e.g., the position of the slider knob 242 along the slider slot 237 between the low-end position 234 and the high-end position 236). For example, the illumination surface 224 (e.g., the diffuser 220) may be configured to diffuse (e.g., spread or scatter) light received from the plurality of light sources to provide feedback (e.g., to display the amount of power delivered to an electrical load(s)).

In some examples, the illumination surface 224 of the user interface 202 may be configured to be illuminated in a plurality of segments. For instance, the illumination on the illuminated surface 224 may define a plurality of discrete segments that can be controllably illuminated by the control device 200. As described in more detail herein, the control device 200 may comprise a tunnel structure located between the plurality of light sources and the diffuser 220. The tunnel structure may include a plurality of apertures that are configured to cause the illumination surface 224 to illuminate a plurality of discrete segments along the slider slot 237. For example, the control device 200 may be configured to control which light sources of the plurality of light sources are illuminated (e.g., based on the intensity of lighting load) such that a corresponding number of segments N_{FB} on the illumination surface 224 are illuminated (e.g., approximately half the segments are illuminated when the lighting load is controlled to 50% intensity level). Further, the tunnel structure may be configured to minimize the amount of light that bleeds between adjacent segments of the illumination surface 224. For example, the tunnel structure (e.g., the apertures of the tunnel structure) may operate to prevent (e.g., substantially prevent) light emitted from a light source from causing illumination in more than one segment of the illumination surface 224.

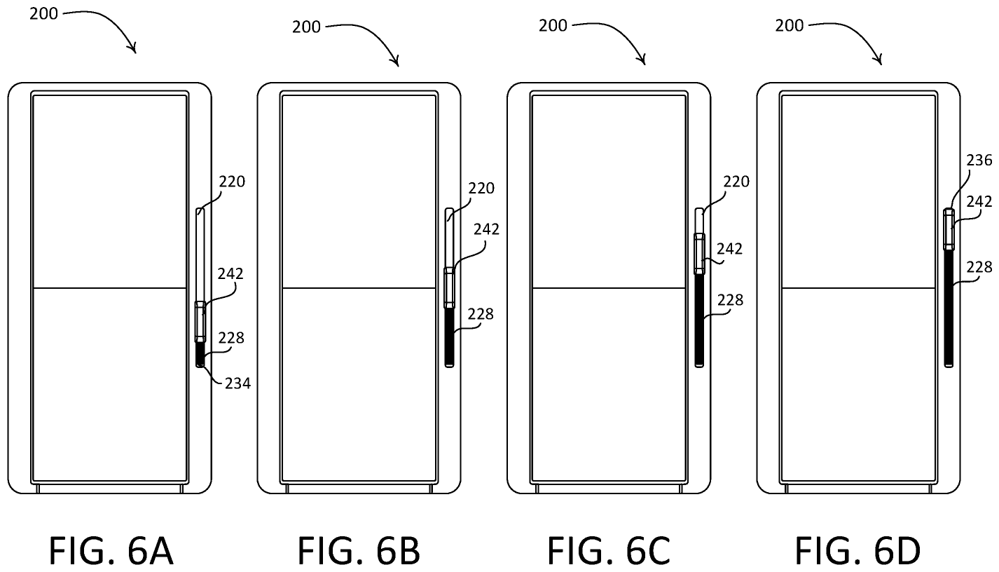

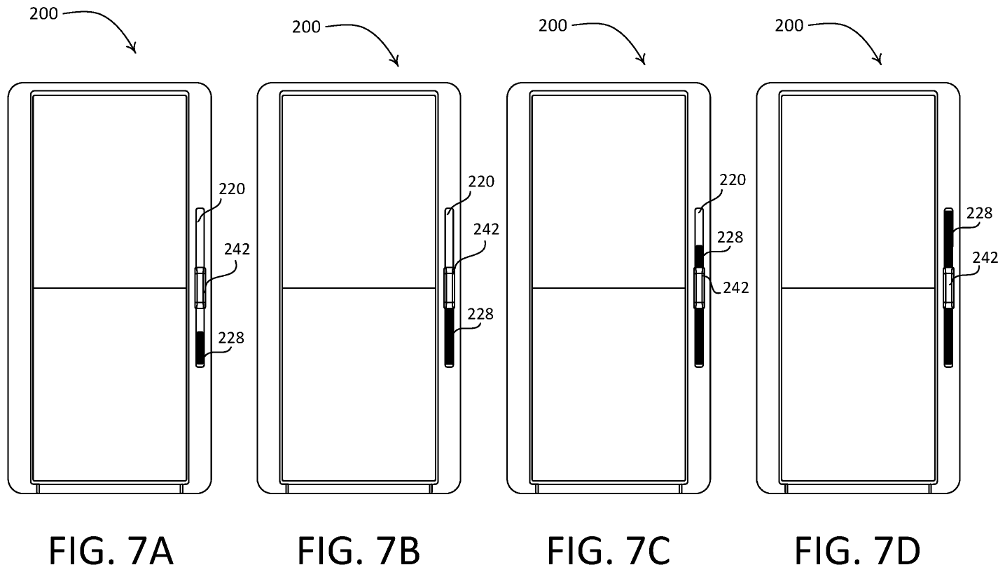

The slider knob 242 may define a length, which may be equal to or greater than the length of each of the plurality of segments. For example, the length of the slider knob 242 and/or the segments may be selected based on a desired ratio between the length of the slider knob 242 and the length of each of the plurality of segments. Further, in other examples, the illumination surface 224 of the user interface 202 may be configured to be illuminated to create a single continuous bar based on, for example, the intensity level of the lighting load(s) controlled by the control device 200 (e.g., and in some examples, the location of the slider knob 242), such as the examples illustrated in FIGS. 6A-6D and 7A-7D. Further, in examples where the control device 200 is configured to adjust the color (e.g., color and/or color temperature) of the lighting load, the illumination surface 224 of the user interface 202 may be configured to be illuminated with a gradient of colors to create a single continuous color bar based on, for example, the illuminated color of the lighting load(s) controlled by the control device 200.

The control device 200 may comprise a wireless communication circuit. The wireless communication circuit may include for example, a radio-frequency (RF) transceiver coupled to an antenna for transmitting and/or receiving RF signals. The wireless communication circuit may also include an RF transmitter for transmitting RF signals, an RF receiver for receiving RF signals, and/or an infrared (IR) transmitter and/or receiver for transmitting and/or receiving IR signals. The wireless communication circuit may be configured to transmit messages (e.g., digital messages) via one or more wireless signals (e.g., RF signals). The message may include the control data (e.g., commands) generated by the control circuit for controlling the lighting load. The wireless communication circuit may be configured to receive a message (e.g., digital message) from one or more remote control devices of the load control system (e.g., the retrofit remote control device 112, the wall-mounted remote control device 114, the tabletop remote control device 116, the handheld remote control device 118, a smart phone, a tablet, a computer, and/or the like) via the wireless communication circuit. The message may include a command to adjust the present intensity level L_{PRES} of the lighting load controlled by the control device 200 from an initial intensity level L_{INIT} of the lighting load to a commanded intensity level L_{CMD} indicated by the message (e.g., the message may include the commanded intensity level L_{CMD}). The wireless communication circuit may enable the control device 200 to receive commands for remote control of the lighting load (e.g., in additional to the local control provided via the actuation member 210 and the intensity adjustment actuator).

In response to receiving a message (e.g., a digital message) from a remote device, the control device 200 may control the lighting load to the commanded intensity level L_{CMD} indicated by the command in the message. The remote device may, for example, include any combination of the retrofit remote control device 112, the wall-mounted remote control device 114, the tabletop remote control device 116, the handheld remote control device 118, a smart phone, tablet, and/or the like. Further, the control device 200 may illuminate the illumination surface 224 of the user interface 202 to indicate the present intensity level L_{PRES} of the lighting load. Since, for example, the message may command the control device 200 to control the present intensity level L_{PRES} of the lighting load to a level that is not synchronized with (e.g., not aligned with) the position of the slider knob 242, the control device 200 may be configured to illuminate the illumination surface 224 such that the illuminated portion of the illumination surface 224 does not align with (e.g., track) the position (e.g., location) of the slider knob 242, but does indicate the present intensity level L_{PRES} of the lighting load. That is, when the commanded intensity level L_{CMD} indicated by a message received from a remote device does not correspond with the position of the slider knob 242, the control device 200 may be configured to illuminate the illumination surface 224 to indicate the present intensity level L_{PRES} of the lighting load in accordance with the received message such that the illuminated portion of the illumination surface 224 is not aligned with the position of the slider knob 242 along the slider slot 237. As such, the illuminated feedback provided via the illumination surface 224 is decoupled from the position of the slider knob 242. The control device 200 may be configured to indicate that the present intensity level L_{PRES} of the lighting load is out of synchronization with the position of the slider knob 242 along the slider slot 237 by illuminating the illumination surface 224 such that the illuminated portion of the illumination surface 224 is not aligned with the position of the slider knob 242 along the slider slot 237.

The position of the slider knob 242 along the slider slot 237 may be adjusted by a user after the control device 200 controlled the lighting load to the commanded intensity level L_{CMD} level based on a received message from a remote device (e.g., and the illuminated portion of the illumination surface 224 is not aligned with the position of the slider knob 242 along the slider slot 237). In such instances, and in response to a movement of the slider knob 242, the control device 200 may be configured to realign the illuminated portion of the illumination surface 224 with the position of the slider knob 242 and control the intensity level of the lighting load accordingly. In some examples, the control device 200 may be configured to realign the illuminated portion of the illumination surface 224 with the position of the slider knob 242 by adjusting the illuminated portion between its initial position and the position of the slider knob 242 (e.g., over an adjustment period and/or at an adjustment rate). As such, when the illuminated portion of the illumination surface 224 is not aligned with position of the slider knob 242 and the position of the slider knob 242 is adjusted, the control device 200 may be configured to control the intensity level of the lighting load based on the position of the slider knob 242 and control the one or more light sources to realign the position of the illuminated portion of the illumination surface 224 with the position of the slider knob 242. For example, when the illuminated portion of the illumination surface 224 is aligned with the position of the slider knob 242, the illuminated portion of the illumination surface 224 may end between the low-end position 234 and the high-end position 236 of the slider slot 237.

Accordingly, the control device 200 may be configured to illuminate a portion of the illumination surface 224 that is located below the slider knob 242 within the slider slot 237 in response to movement of the slider knob 242. For example, in response to movement of the slider knob 242, the control device 200 may be configured to illuminate the illumination surface 224 below the location of the slider knob 242 without illuminating any portion of the illumination surface 224 located above the slider knob 242. In such examples, the illuminated portion of the illumination surface 224 may remain at or below the slider knob 242 and may not extend above the slider knob 242 (e.g., a top edge 247 of the slider knob 242). For instance, the slider knob 242 may be made of an opaque material and the control device 200 may control the one or more light sources such that the illuminated portion of the illumination surface 224 remains at or below the slider knob 242 and does not extend above the slider knob 242. Alternatively, in some examples, the slider knob 242 may be made of a translucent (e.g., at least partially translucent) material such that the slider knob 242 is configured to allow the illuminated portion to shine through the slider knob 242 to present feedback to the user. Further, in some instances, the control device 200 may illuminate the entirety of the illumination surface 224 below the slider knob 242 in response to movements of the slider knob 242 (e.g., in a continuous or segmented manner), for example, to indicate to the user that the control device is working properly. In such instances, the control device 200 may leave the illumination surface 224 unilluminated in response to a remote control command.

However, when the control device 200 receives a message (e.g., digital message) indicating a commanded intensity level L_{CMD} of the lighting load from a remote device, the control device 200 may be configured to illuminate a portion of the illumination surface 224 in accordance with the commanded intensity level L_{CMD}, regardless of the position of the slider knob 242. This may result in the control device 200 illuminating a portion of the illumination surface 224 that extends above a top edge 247 of the slider knob 242 and/or falls below a bottom edge 249 of the slider knob 242. As such, the control device 200 may illuminate the diffuser 220 such that the illuminated portion of the illumination surface 224 is not aligned with the position of the slider knob 242 along the slider slot 237, for example, because the intensity level of the lighting load does not correspond with the position of the slider knob 242. Further, in some examples and in response to a remote command of the lighting load, the control device 200 may be configured to illuminate the upper most segment (e.g., only the upper most segment) to indicate the intensity level of the lighting load (e.g., irrespective of the position of the slider knob 242, to for example, indicate that the illumination surface 224 is decoupled from the position of the slider knob 242).

Further, if the control device 200 was turned off when the illuminated portion of the illumination surface 224 is not aligned with the position of the slider knob 242, but then control device 200 is turned back on using the actuation member 210, then the control device 200 may be configured to control the lighting load to the intensity level indicated by the slider knob 242. However, in other examples, the control device may be configured to control the lighting load to the intensity level that the lighting load was previously controlled to when the control device 200 was last turned off (e.g., which may have been based on local or remote control).

In some examples, the control device 200 may be configured to illuminate the visible display (e.g., the illuminated portion of the illumination surface 224) in different manners and/or using different parameters based on whether the control is received via a local control command (e.g., via an actuation of the actuation member 210 and/or via movement of the slider knob 242) or the control is received via a remote control command (e.g., a remote message received via a remote control device). For instance, the control device 200 may be configured with multiple ranges (e.g., buckets) that are used when determining which light sources to illuminate to indicate the present intensity level L_{PRES} of the lighting load. Each bucket may define one or more of an upper threshold and a lower threshold, where the thresholds define the boundaries between the multiple buckets. The threshold(s) of the buckets may be defined in terms of the dimming range of the control device 200 (e.g., values across a dimming range, such as 0-255 dimming range). In some examples, the buckets may be used to indicate which light sources of the control device 200 are to be illuminated such that a corresponding number of segments N_{FB} are illuminated (e.g., to generate the illuminated portion of the illumination surface 224) based on the present intensity level L_{PRES} of the lighting load.

The control device 200 may be configured with different buckets based on whether the command is received via local control or remote control (e.g., local control buckets or remote control buckets). If a single set of buckets is used irrespective of whether a command to change the present intensity level L_{PRES} is received via local control or remote control, the feedback provided by way of the visible display (e.g., the illuminated surface of the user interface 224, such as the one or more segments) may be misleading (e.g., confusing, distorted, and/or unexpected) to the user. For example, the single set of buckets may appropriately provide feedback (e.g., feedback that is not misleading) when the control device receives a remote-control command of the lighting load (e.g., receives a message including a command from a remote device). But, if the same set of buckets is used and the control device receives a local control command of the lighting load (e.g., via the actuation member 210 and/or the slider actuator 240 comprising the slider knob 242), the illuminated portion of the illumination surface may extend above the slider knob, which may result in feedback that confuses the user. Or, if the single set of buckets appropriately provides feedback (e.g., feedback that is not misleading) when the control device receives a local control command of the lighting load, then the same set of buckets may result in feedback that confuses the user if they are used in response to remote control of the lighting load. As such, in some examples, the control device may be configured with different buckets that are used based on whether a command to change the present intensity level L_{PRES} of the lighting load is received via local control or remote control. For instance, the buckets used in response to a local control command (e.g., local control buckets) may define different thresholds than the buckets used in response to a remote control command (e.g., remote control buckets).

Further, in some examples, the visible display may be a continuous light bar (e.g., instead of a plurality of discrete segments). In such examples, the control device 200 may be configured to determine an end of the continuous light bar differently based on whether the control is received via a local control command or a remote control command. In some examples, the control device 200 may determine the end of the continuous light bar using different techniques (e.g., a local control technique and a remote control technique). Alternatively or additionally, the control device 200 may determine different pulse-width modulating (PWM) duty cycles to drive one or more of the light source based on whether the control is received via a local control command or a remote control command.

In some examples, as noted herein, the control device 200 may include a first visible indicator that is located above the slider slot 237 and a second visible indicator located below the slider slot 237 (e.g., as shown in FIG. 32A-32C). In such examples, the control device 200 may be configured to illuminate the first visible indicator and/or the second visible indicator to indicate that the present intensity level L_{PRES} of the lighting load is out of synchronization with the position of the slider knob 242 along the slider slot 237. For example, the control device 200 may be configured to illuminate the first visible indicator to indicate that the lighting load is controlled via a remote device and the present intensity level L_{PRES} of the lighting load is greater than a corresponding intensity level associated with a position of the slider knob 242 along the slider slot 237, and configured to illuminate the second visible indicator to indicate that the lighting load is controlled via the remote device and the present intensity level L_{PRES} of the lighting load is less than a corresponding intensity level associated with a position of the slider knob 242 along the slider slot 237. In such examples, the control device may be configured to cause both the first and second visible indicators to remain off when the lighting load is being controlled via local control (e.g., via the slider actuator 240).

Finally, in some examples, the slider knob 242 of the control device 200 may include a visible indicator (e.g., an aperture that is configured to be illuminated by a light source), and the control device 200 may be configured to illuminate the visible indicator to indicate that the present intensity level L_{PRES} of the lighting load is in synchronization with the position of the slider knob 242 along the slider slot 237 (e.g., as shown in FIG. 33A-C). For example, the control device 200 may be configured to illuminate the visible indicator located on the slider knob 242 in response to local control of the lighting load, and be configured to not illuminate the visible indicator located on the slider knob 242 in response to remote control of the lighting load.

The control device 200 may change operating mode in response to the actuation or adjustment of a combination of the actuation member 210 and slider knob 242 and/or a reception of a remote control command via an external device (e.g., a mobile application residing on a smartphone and/or tablet that is configured with short-range wireless communication (e.g., using the BLUETOOTH LOW-ENERGY (BLE) protocol), for example. For instance, the control device 200 may change the operating mode in response to the actuation of the lower portion 218 of the action member 210 and by dragging the slider knob 242 from the top of the slider slot 237 to the bottom of the slider slot 237. In another example, the control device may change the operating mode in response to the reception of a control signal from an external device (e.g., possibly via a system controller).

One example of a change in operating mode is a change between an intensity control mode and a color control mode (e.g., a color temperature control mode and/or a full color spectrum control mode). Another example of a change in operating mode is a change between a normal operating mode and a commissioning mode that is used to associate the control device 200 with a remote control device. Yet another example of a change in operating mode is a change between a normal operating mode to an advanced programming mode. As described herein, an advanced programming mode may allow configuration and/or adjustment of one or more operating characteristics of the control device and/or a lighting load of the lighting control system 100, such as the low-end intensity level L_{LE} (e.g., a minimum intensity level) and/or the high-end low-end intensity level L_{HE} (e.g., a maximum intensity level) of the lighting load.

During an advanced programming mode as described herein, the slider knob 242 may be actuated to adjust an operating characteristic (e.g., such as the high-end intensity level L_{LE}, the low-end intensity level L_{HE}, etc.) of the control device. An example of a control device having an advanced programming mode is described in greater detail in commonly-assigned U.S. Pat. No. 7,190,125, issued Mar. 13, 2007, entitled PROGRAMMABLE WALLBOX DIMMER, the entire disclosure of which is hereby incorporated by reference.

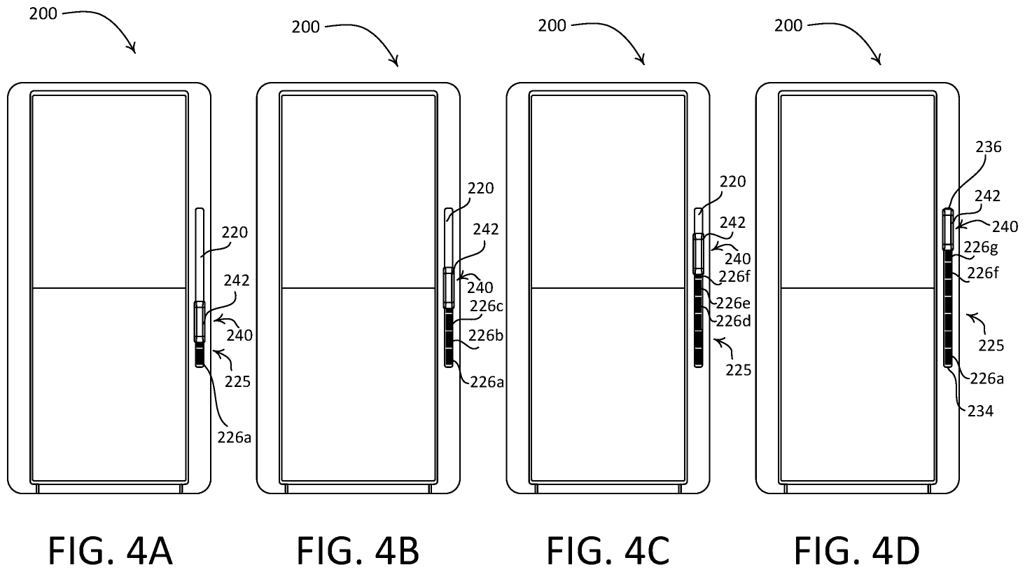

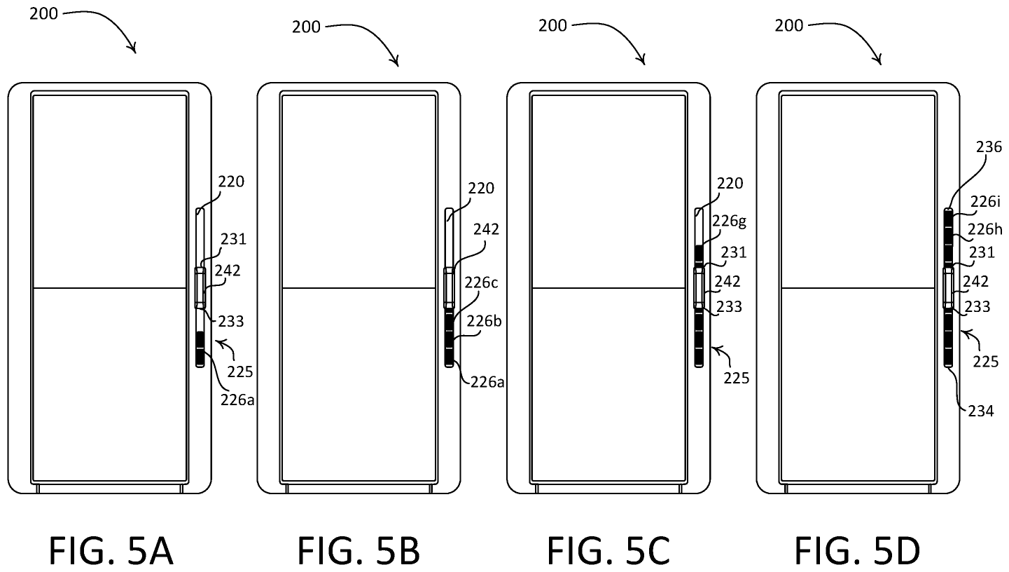

FIG. 4A-4D are front views of the control device 200 illustrating the illumination surface 224 of the user interface 202 illuminated in segments at various levels based on the position of the slider knob 242 along the slider slot 237. FIG. 5A-5D are front views of the control device 200 illustrating the illumination surface 224 illuminated in segments at various levels based on received messages irrespective of the position of the slider knob 242 along the slider slot 237. As shown in FIG. 4A-4D, the illumination surface 224 may be configured to be illuminated as a segmented bar 225 a plurality of segments 226a-226i (e.g., the illumination of the illumination surface 224 may define a plurality of discrete segments that can be controllably illuminated by the control device 200). It should be appreciated that the segments 226h and 226i are not shown in the figures, but reside above the segment 226g. The control device 200 may comprise a tunnel structure located between the plurality of light sources and the diffuser 220, where, for example, the tunnel structure may include a plurality of apertures that are configured to cause the illumination surface 224 to be illuminated as a plurality of discrete segments along the slider slot 237. In the examples shown in FIG. 4A-4D, the illumination surface 224 is configured to be illuminated in nine discrete segments 226a-226i, wherein the segment 226a is closest to the low-end position 234 of the slider slot 237, and the segment 226i is closest to the high-end position 236 of the slider slot 237.

In FIG. 4A-4D, the control device 200 may be configured to illuminate the illumination surface 224 of the user interface 202 based on the position of the slider knob 242 along the slider slot 237. In the examples illustrated in FIG. 4A-4D, the control device 200 may be configured to illuminate the illumination surface 224 below the location of the slider knob 242 without illuminating any portion of the illumination surface 224 located above the slider knob 242. In such examples, the illuminated portion of the illumination surface 224 may remain at or below the slider knob 242 and may not extend above the slider knob 242. For instance, when the slider knob 242 is moved, the control device 200 may adjust the illuminated portion of the illumination surface 224 (e.g., the number of illuminated segments 226a-226i) to indicate the present intensity level L_{PRES} of the lighting load and to remain at or below the slider knob 242.

As noted above, the slider knob 242 may define a length, which may be equal to or greater than the length of each of the plurality of segments. In the examples illustrated in FIGS. 4A-4D and 5A-5D, the illumination surface 224 may define nine discrete segments of illumination. A length of the slider knob 242 and/or the segments of illumination may be selected based on a desired ratio between the length of the slider knob 242 and the length of each of the plurality of segments. For example, the length of the slider knob 242 may be at least two times longer than the length of each of the plurality of segments. As an example, the slider knob 242 may be approximately 0.26 inches long, while each segment is approximately 0.11 inches long. In some examples, the length of the slider knob 242 and/or the segments may be selected based on a desired ratio between the length of the slider knob 242 and/or the length of each of the plurality of segments with respect to a length of the slider slot 237. For example, the length of the slider knob 242 may be approximately 26% of the length of the slider slot 237, and the length of each of the plurality of segments may be approximately 11% of the length of the slider slot 237. Further, in some instances, the length of the slider slot 237 may be approximately 1 inch long.

In some examples, the length of each segment and/or the length of the slider knob 242 may be determined such that the illumination and de-illumination (e.g., turning off) of each segment occurs behind the slider knob 242. For example, the slider knob 242 and/or segments may be sized such that, as the slider knob 242 is moved upwards along the slider slot 237, the illumination of each segment occurs behind the slider knob 242. Further, and for example, the slider knob 242 and/or the segments may be sized such that, as the slider knob 242 is moved downwards along the slider slot 237, the de-illumination (e.g., turning off) of each segment occurs behind the slider knob 242. As such, a user of the control device 200 may be unable to see a segment turn on or off while the slider knob 242 is moved along the slider slot 237, which may create a more pleasant user experience.

In some examples, the control device 200 may be configured to illuminate an entire segment when the present intensity level L_{PRES} reaches a bucket associated with that segment. For instance, in the example where the illumination on the illumination surface 224 defines nine, discrete segments (e.g., such as is shown in FIG. 4A-4D), the control device 200 may be configured to illuminate the first segment while the present intensity level L_{PRES} is between 0-11%, the first and second segments when the present intensity level L_{PRES} is between 12-22% (e.g., illuminate the second segment when the present intensity level L_{PRES} is greater than or equal to 12%), the first, second, and third segments when the present intensity level L_{PRES} is between 23-33% (e.g., illuminate the third segment when the present intensity level L_{PRES} is greater than or equal to 23%), etc., and all nine segments when the present intensity level L_{PRES} is between 89-100%.

Referring FIG. 5A-5D, and as noted herein, the control device 200 may be configured to adjust the present intensity level L_{PRES} of the lighting load based on messages received from one or more remote devices (e.g., the retrofit remote control device 112, the wall-mounted remote control device 114, the tabletop remote control device 116, the handheld remote control device 118, a smart phone, tablet, and/or the like). The messages may include a command to adjust the present intensity level L_{PRES} of the lighting load controlled by the control device 200 to a commanded intensity level L_{CMD}. In such instances, the control device 200 may adjust the present intensity level L_{PRES} of the lighting load to an intensity level that does not align with the position of the slider knob 242, and the control device 200 may be configured to illuminate a portion of the illumination surface 224 of the user interface 202 that does not align with the position of the slider knob 242 in the slider slot 237.

For example, in FIG. 5A, the control device 200 may be configured to adjust the present intensity level L_{PRES} of the lighting load to a commanded intensity level L_{CMD} that is less than the intensity level associated with the position of the slider knob 242 along the slider slot 237 based on a received message from a remote device, and the control device 200 may be configured to illuminate a portion of the illumination surface 224 that does not align with the position of the slider knob 242 in the slider slot 237 (e.g., remains below the bottom edge 249 of the slider knob 242). In the example of FIG. 5A, the present intensity level L_{PRES} of the lighting load may be between 12-22% since the first and second segments 226a, 226b are illuminated. For example, the commanded intensity level L_{CMD} in the received message may be 15% (e.g., between 12-22%). In response to receiving the message, the control device 200 may control the present intensity level L_{PRES} of the lighting load to the commanded intensity level L_{CMD} indicated by the received message (e.g., 15%), and illuminate the first and second segments 226a, 226b to indicate the present intensity level L_{PRES} of the lighting load even though the illuminated portion of the illumination surface 224 does not align with the position of the slider knob 242.

In FIG. 5B, the control device 200 may be configured to adjust the present intensity level L_{PRES} of the lighting load to a commanded intensity level L_{CMD} that is at or just below the position of the slider knob 242 based on a received message from a remote device, and the control device 200 may be configured to illuminate a portion of the illumination surface 224 that appears to align with the position of the slider knob 242 in the slider slot 237 (e.g., the illuminated portion may be aligned with or close enough that it is not discernible). In the example of FIG. 5B, the present intensity level L_{PRES} of the lighting load may be between 34-55% since the illuminated portion of the illumination surface 224 ends behind the slider knob 242 and either the first through fourth segments 226a-226d or the first through fifth segments 226a-226e are illuminated. For example, the commanded intensity level L_{CMD} in the received message may be 50%. In response to receiving the message, the control device 200 may control the present intensity level L_{PRES} of the lighting load to the commanded intensity level L_{CMD} indicated by the received message (e.g., 50%), and illuminate the first through fifth segments 226a-226e) of the illumination surface 224 to indicate the present intensity level L_{PRES} of the lighting load. In this example, it just so happens that the illuminated portion of the illumination surface 224 does appear to align with the position of the slider knob 242.

In FIG. 5C, the control device 200 may be configured to adjust the present intensity level L_{PRES} of the lighting load to a commanded intensity level L_{CMD} that is greater than the intensity level associated with the position of the slider knob 242 based on a received message from a remote device, and the control device 200 may be configured to illuminate a portion of the illumination surface 224 that does not align with the position of the slider knob 242 in the slider slot 237 (e.g., remains above the top edge 247 of the slider knob 242). In the example of FIG. 5C, the present intensity level L_{PRES} of the lighting load may be between 67-77% since the first through seventh segments 226a-226g are illuminated. For example, the commanded intensity level L_{CMD} in the received message may be 75% (e.g., between 67-77%). In response to receiving the message, the control device 200 may control the present intensity level L_{PRES} of the lighting load to the commanded intensity level L_{CMD} indicated by the received message, and illuminate the first through seventh segments 226a-226g to indicate the present intensity level L_{PRES} of the lighting load even though the illuminated portion of the illumination surface 224 does not align with the position of the slider knob 242.

Similarly, in FIG. 5D, the control device 200 may be configured to adjust the present intensity level L_{PRES} of the lighting load to a commanded intensity level L_{CMD} that is less than the intensity level associated with the position of the slider knob 242 along the slider slot 237 based on a received message from a remote device, and the control device 200 may be configured to illuminate a portion of the illumination surface 224 that does not align with the position of the slider knob 242 in the slider slot 237 (e.g., remains above the top edge 247 of the slider knob 242). In the example of FIG. 5D, the present intensity level L_{PRES} of the lighting load may be between 89-100% since the first and second segments 226a, 226b are illuminated. For example, the commanded intensity level L_{CMD} in the received message may be 95% (e.g., between 89-100%). In response to receiving the message, the control device 200 may control the present intensity level L_{PRES} of the lighting load to the intensity level indicated by the received message, and illuminate the first through ninth segments 226a-226i to indicate the present intensity level L_{PRES} of the lighting load even though the illuminated portion of the illumination surface 224 does not align with the position of the slider knob 242. According, in response to receiving a remote control command, the control device 200 may be configured to illuminate a portion of the illumination surface 224 to provide feedback that provides an indication that the present intensity level L_{PRES} is not aligned with the position of the slider knob 242, an indication of whether the present intensity level L_{PRES} is higher or lower than an intensity associated with the position of the slider knob 242, and/or an a relative indication of just how far off the present intensity level L_{PRES} is from the intensity associated with the position of the slider knob 242.

Further, in some examples, the control device may be configured to illuminate segments (e.g., only those segments) that are visible and not hidden behind the slider knob 242. Also, in other examples, the control device 200 may only illuminate the upper most segment (e.g., just the fifth segment when the intensity level is between 44-55% rather than the first through fifth segments 226a-226e), for example, to indicate that the control device 200 is presently controlling the amount of power delivered to the electrical load based on a control message from an external device and not based on the position of the slider knob 242 (e.g., when the illuminated portion and the slider knob 242 are mis-aligned).

The control device 200 may be configured to realign the illuminated portion of the illumination surface 224 (e.g., the segments 226a-226i) with the position of the slider knob 242 if the position of the slider knob 242 moves (e.g., when the illuminated portion was unsynchronized with the position of the slider knob 242, such as after controlling the lighting load and the illuminated portion of the illumination surface 224 in response to a message received from a remote device). For example, if, based on a received message from a remote device, the control device 200 is controlling the present intensity level L_{PRES} of the lighting load to an intensity level that is different than the intensity level associated with the position of the slider knob 242 (e.g., as shown in FIG. 5A, 5C, 5D) and the position of the slider knob 242 of the control device 200 is later adjusted, the control device 200 may realign the illuminated portion of the illumination surface 224 (e.g., the segments 226a-226i) with the position of the slider knob 242 in the slider slot 237 (e.g., as illustrated in FIG. 4A-4D) and control the present intensity level L_{PRES} of the lighting load accordingly. In some instances, when the control device 200 realigns the illuminated portion of the illumination surface 224 with the position of the slider knob 242, the control device 200 may adjust the illuminated portion of the illumination surface 224 (e.g., the segments 226a-226i) to the position of the slider knob 242 (e.g., over an adjustment period and/or at an adjustment rate).

As such, the control device 200 may be configured to align the illuminated portion of the illumination surface 224 (e.g., the segments 226a-226i) with the position of the slider knob 242 when the slider knob 242 is used to control the present intensity level L_{PRES} of a lighting load, while also being configured to control the lighting load in response to messages received from remote devices and provide feedback accordingly, even if the intensity level indicated by the message does not align with the position of the slider knob 242. Therefore, the control device 200 may always provide feedback regarding the present intensity level L_{PRES} of the lighting load regardless of the position of the slider knob 242.

FIG. 6A-6D are front views of the control device 200 illustrating the illumination surface 224 of the user interface 202 being illuminated in a continuous bar 228 at various levels based on the position of the slider knob 242 along the slider slot 237. FIG. 7A-7D are front views of the control device 200 illustrating the illumination surface 224 being illuminated in a continuous bar 228 at various levels based on received messages irrespective of the position of the slider knob 242 along the slider slot 237. As shown in FIG. 6A-6D, the illumination surface 224 may be configured to be illuminated as a continuous bar 228, for example, instead of a plurality of discrete segments, such as is illustrated in FIG. 4A-4D. The illuminated portion of the continuous bar 228 may be configured to end at any level between the low-end position 234 and the high-end position 236 of the illumination surface 224, based on the present intensity level L_{PRES} of the lighting load. Examples of a control device that is configured to illuminate a continuous bar can be found in commonly-assigned U.S. Patent Application Pub. No. US 2021/0068238, published Mar. 4, 2021, entitled CONTROL DEVICE HAVING A VISIBLE INDICATOR, the entire disclosure of which is hereby incorporated by reference.

In the examples illustrated in FIG. 6A-6D, the control device 200 may be configured to illuminate the illumination surface 224 below the location of the slider knob 242 without illuminating any portion of the illumination surface 224 located above the slider knob 242. In such examples, the illuminated portion of the illumination surface 224 (e.g., the continuous bar 228) may remain at or below the slider knob 242 and may not extend above the slider knob 242. For instance, when the slider knob 242 is moved, the control device 200 may adjust illuminated portion of the illumination surface 224 to indicate the present intensity level L_{PRES} of the lighting load and to remain at or below the slider knob 242.

Referring to FIG. 7A-7D, the control device 200 may be configured to adjust the present intensity level L_{PRES} of the lighting load based on messages received from one or more remoted devices (e.g., the retrofit remote control device 112, the wall-mounted remote control device 114, the tabletop remote control device 116, the handheld remote control device 118, a smart phone, tablet, and/or the like). The messages may include a command to adjust the present intensity level L_{PRES} of the lighting load controlled by the control device 200 to a commanded intensity level L_{CMD}. In such instances, the control device 200 may adjust the present intensity level L_{PRES} of the lighting load to an intensity level that does not align with the position of the slider knob 242, and the control device 200 may be configured to illuminate a portion of illumination surface 224 that does not align with the position of the slider knob 242 in the slider slot 237.

For example, in FIG. 7A, the control device 200 may be configured to adjust the present intensity level L_{PRES} of the lighting load to an intensity level that is less than the intensity level associated with the position of the slider knob 242 based on a received message from a remote device, and the control device 200 may be configured to illuminate a portion of the illumination surface 224 that does not align with the position of the slider knob 242 in the slider slot 237 (e.g., remains below the bottom edge 249 of the slider knob 242).

In FIG. 7B, the control device 200 may be configured to adjust the present intensity level L_{PRES} of the lighting load to an intensity level that is at, just above, or just below the position of the slider knob 242 based on a received message from a remote device, and the control device 200 may be configured to illuminate a portion of the illumination surface 224 that appears to align with the position of the slider knob 242 in the slider slot 237 (e.g., the illuminated portion may be aligned with the slider knob 242 or close enough that it is not discernible). In this example, it just so happens that the illuminated portion of the illumination surface 224 (e.g., the continuous bar 228) does appear to align with the position of the slider knob 242.

In FIGS. 7C and 7D, the control device 200 may be configured to adjust the present intensity level L_{PRES} of the lighting load to an intensity level that is greater than the intensity level associated with the position of the slider knob 242 based on a received message from a remote device, and the control device 200 may be configured to illuminate a portion of the illumination surface 224 in the slider slot 237 that rises above the top edge 247 of the slider knob 242.

The control device 200 may be configured to realign the illuminated portion of the illumination surface 224 with the position of the slider knob 242 if the position of the slider knob 242 moves (e.g., when the illuminated portion was unsynchronized with the position of the slider knob 242, such as after controlling the load and the illuminated portion of the illumination surface 224 in response to a message received from a remote device). For example, if, based on a received message from a remote device, the control device 200 is controlling the present intensity level L_{PRES} of the lighting load to an intensity level that is different than the intensity level associated with the position of the slider knob 242 (e.g., as shown in FIG. 7A, 7C, 7D) and the position of the slider knob 242 of the control device 200 is later adjusted, the control device 200 may realign the illuminated portion of the illumination surface 224 (e.g., the continuous bar 228) with the position of the slider knob 242 in the slider slot 237 (e.g., as illustrated in FIG. 6A-6D) and control the present intensity level L_{PRES} of the lighting load accordingly. In some instances, when the control device 200 realigns the illuminated portion of the illumination surface 224 with the position of the slider knob 242, the control device 200 may adjust the illuminated portion of the illumination surface 224 (e.g., the continuous bar 228) to the position of the slider knob 242 (e.g., over an adjustment period and/or at an adjustment rate).

As such, the control device 200 may be configured to align the illuminated portion of the illumination surface 224 (e.g., the continuous bar 228) with the position of the slider knob 242 when the slider knob 242 is used to control the present intensity level L_{PRES} of a lighting load, while also being configured to control the load in response to messages received from remote devices and provide feedback accordingly, even if the commanded intensity level L_{CMD} indicated by the message does not align with the position of the slider knob 242. Therefore, the control device 200 may always provide feedback regarding the present intensity level L_{PRES} of the lighting load (e.g., using the continuous bar 228) regardless of the position of the slider knob 242.

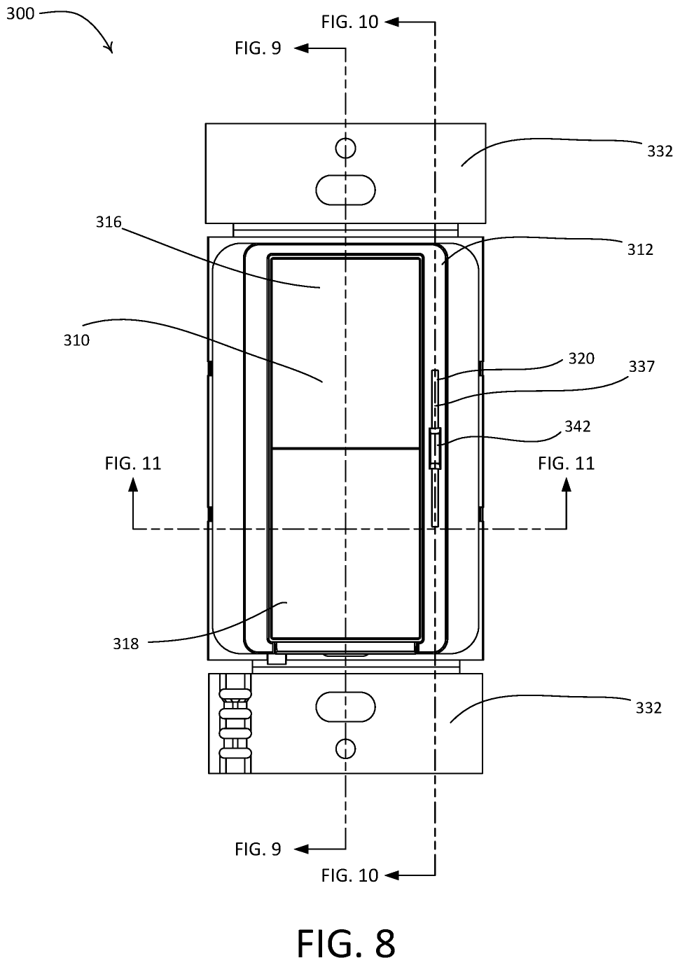

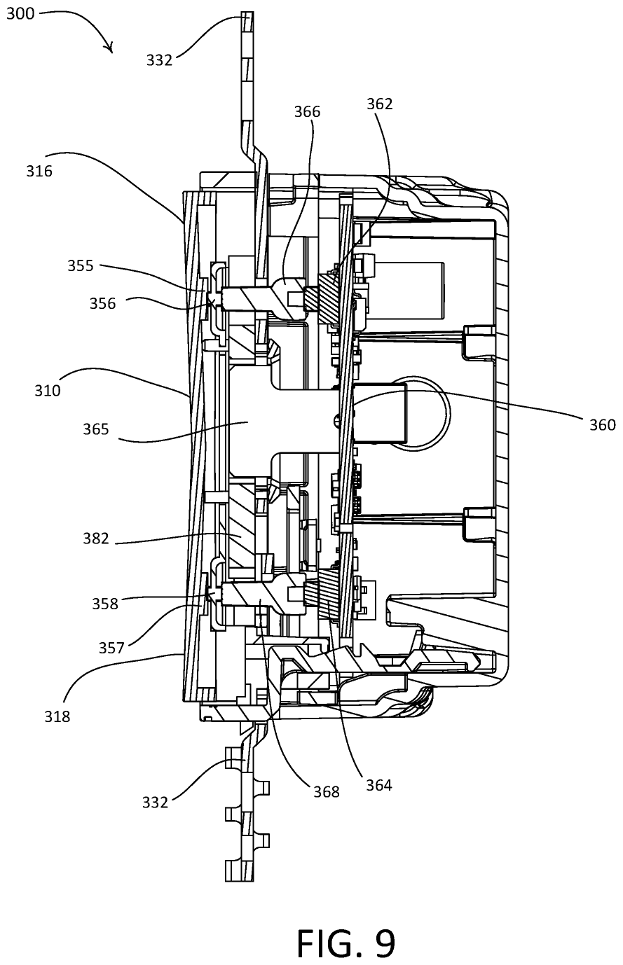

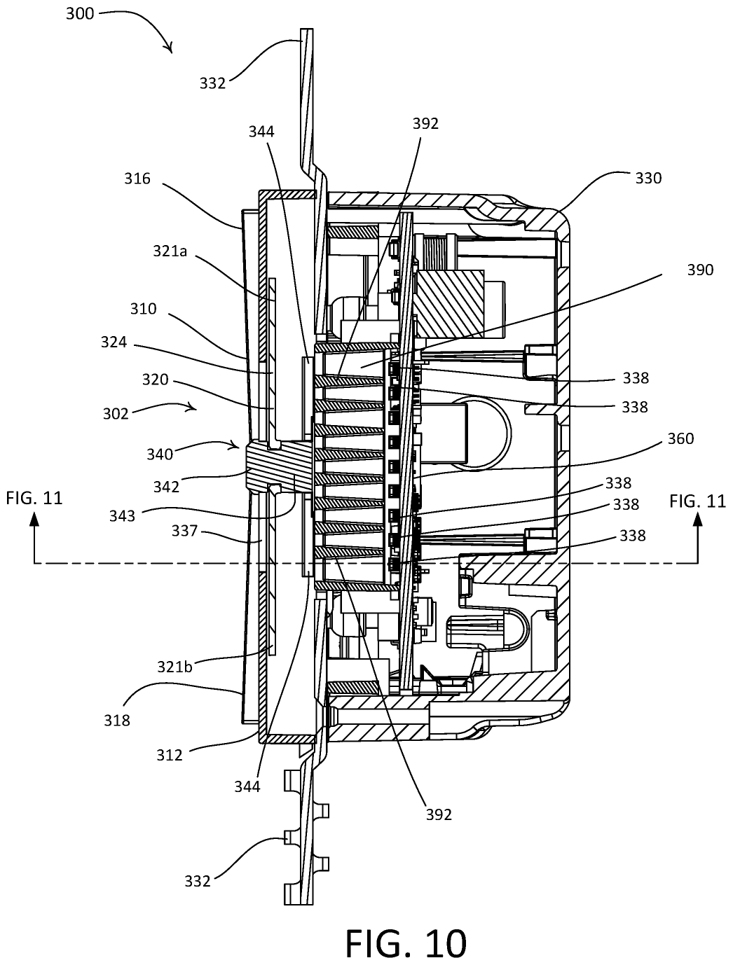

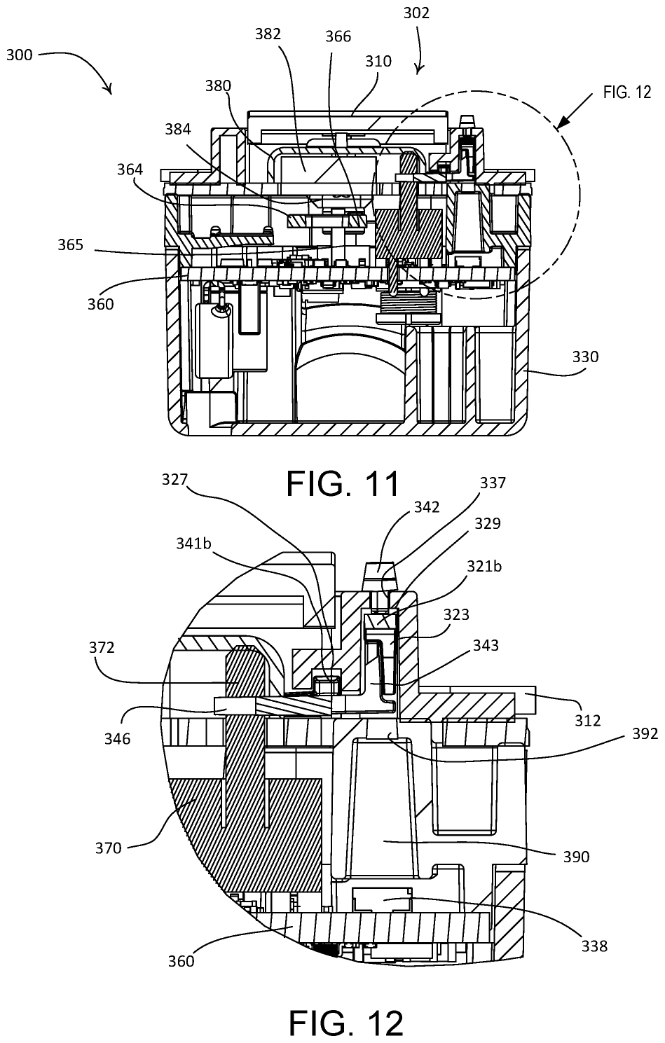

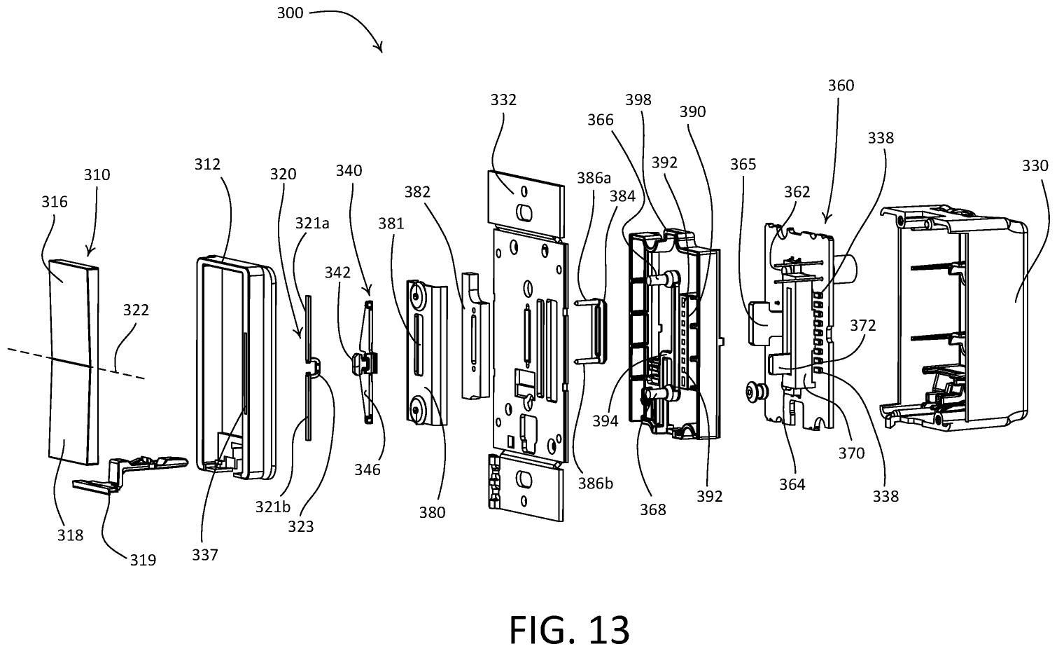

FIG. 8 is a front view of an example control device 300 that may be deployed as the dimmer switch 110, the retrofit remote control device 112, and/or the wall-mounted remote control device 114 in the lighting control system 100. The control device 300 may be an example of the control device 200. For example, the control device 300 may be configured to provide visible feedback via an illumination surface of a diffuser in a similar manner as described with respect to the control device 200 (e.g., as shown in FIGS. 4A-4D, FIGS. 5A-5D, FIGS. 6A-6D, and/or FIGS. 7A-7D). The control device 300 may be configured to be installed in an electrical wallbox with a faceplate (e.g., the faceplate 204). FIG. 9 is a cross-sectional view of the control device 300 taken through the center of the control device 300 (e.g., through the line shown in FIG. 8). FIG. 10 is a cross-sectional view of the control device 300 taken through along the center of a slider slot 337 and a slider knob 342 of the control device 300 (e.g., through the line shown in FIG. 8). FIG. 11 is a top cross-sectional view of the control device 300 taken through the line shown in FIG. 8. FIG. 12 is a magnified view of the cross-sectional view of the control device 300 of FIG. 11. FIG. 13 is a partially exploded view of the control device 300.

The control device 300 may comprise a user interface 302 (e.g., the user interface 202). The control device 300 may be configured to control the amount of power delivered to an electrical load, such as a lighting load. The control device 300 may be configured to control the lighting load, for example, to turn the lighting load on or off (e.g., in response to actuations of an actuation member) and/or adjust a present intensity level L_{PRES} of the lighting load. For example, the control device 300 may control the lighting load by controlling an internal load control circuit (e.g., a controllably conductive device of the control device 300) and/or by transmitting a message for controlling the lighting load via a communication circuit (e.g., a wireless signal via a wireless communication circuit). When the control device 300 is a wall-mounted dimmer switch, the control device 300 may comprise an enclosure (e.g., an enclosure back cover 330) for housing load control circuitry of the dimmer switch.

The user interface 302 of the control device 300 may include an actuation member 310 that is configured to be mounted to a base portion 312 (e.g., a bezel) of the control device 300. The actuation member 310 may comprise a front surface 314 including an upper portion 316 and a lower portion 318. The actuation member 310 may be configured to pivot about a pivot axis 322 (e.g., a central axis) in response to a tactile actuation (e.g., a tactile input) of the upper portion 316 and the lower portion 318. Alternatively or additionally, the front surface of the actuation member 310 may comprise a touch sensitive surface, and the control device may be responsive to touch actuations along the front surface of the actuation member 310. In some of these instances, the actuation member 310 may be rigidly affixed to the base portion 312 (e.g., the actuation member 310 may be configured to not pivot about an axis).

The control device 300 may be configured to control a lighting load of a lighting control system to turn the lighting load on in response to a tactile actuation of the upper portion 316, and to turn the lighting load off in response to a tactile actuation of the lower portion 318 (or vice versa). For example, the control device 300 may include a controllably conductive device adapted to be coupled in series electrical connection between an alternating current (AC) power source and the lighting load. The control device 300 may be configured to control the amount of power delivered from the AC power source to the lighting load (e.g., to control the present intensity level L_{PRES} of the lighting load) in response to actuations of the actuation member 310. For example, the control device 300 may control the controllable conductive device to connect the AC power source to the lighting load in response to an actuation of the upper portion 316 of the actuation member 310, and control the controllable conducive device to disconnect the AC power source from the lighting load in response to an actuation of the lower portion 318 of the actuation member 310. The control device 300 may include one or more tactile switches that are actuated in response to the tactile actuations of the upper and/or lower portions 316, 318 of the actuation member 310, for example, as described herein.

The control device 300 may include an analog intensity adjustment actuator, such as a slider actuator 340 comprising a slider body 344 and the slider knob 342. The control device 300 may control the magnitude of a load current conducted through the lighting load (e.g., to adjust a present intensity level L_{PRES} of the lighting load) in response to movement of the slider knob 342 along the slider slot 337. For example, when the lighting load is on, the control device 300 may control the present intensity level L_{PRES} of the lighting load in response to movement of the slider knob 342 along the slider slot 337. When the lighting load is off, the control device 300 may not adjust the present intensity level L_{PRES} of the lighting load in response to movement of the slider knob 342. But, when the lighting load is off and the upper portion 316 of the actuation member 310 is actuated, the control device 300 may turn on the lighting load to an intensity level determined based on the position of the slider knob 342 within the slider slot 337.

The slider knob 342 may be configured to move along (e.g., behind) an elongated slot, such as the slider slot 337. The slider slot 337 may be an elongated opening in the base portion 312 of the control device 300. For example, the slider slot 337 may be located adjacent to the actuation member 310. Alternatively, the slider slot 337 may be located in the actuation member 310, and for example, may move in response to actuations of the actuation member 310. The slider knob 342 may be configured to move in a vertical direction along the slider slot 337 between a low-end position 334 and a high-end position 336. The slider knob 342 of the slider actuator 340 may allow for adjustment of the intensity level L of the lighting load between the low-end intensity level L_{LE} (e.g., when the slider knob 342 is located in the low-end position 334) to the high-end intensity level L_{HE} (e.g., when the slider knob 342 is located in the high-end position 336). Accordingly, the slider knob 342 may be operable to move in a vertical direction along the length of the slider slot 337 of the base portion 312, and the base portion 312 may be configured to be received in an opening of the faceplate 304. Further, although illustrated as moving in a linear, vertical direction, the slider knob 342 may be configured to move behind a similarly configured slider slot 337 in a linear, horizontal direction or a linear, diagonal direction across the base portion 312 and/or the actuation portion 310, and/or the slider knob 342 may be configured to move behind a similarly configured slider slot 337 in a non-linear direction, such as a circular direction or a winding direction across the base portion 312 and/or the actuation portion 310.

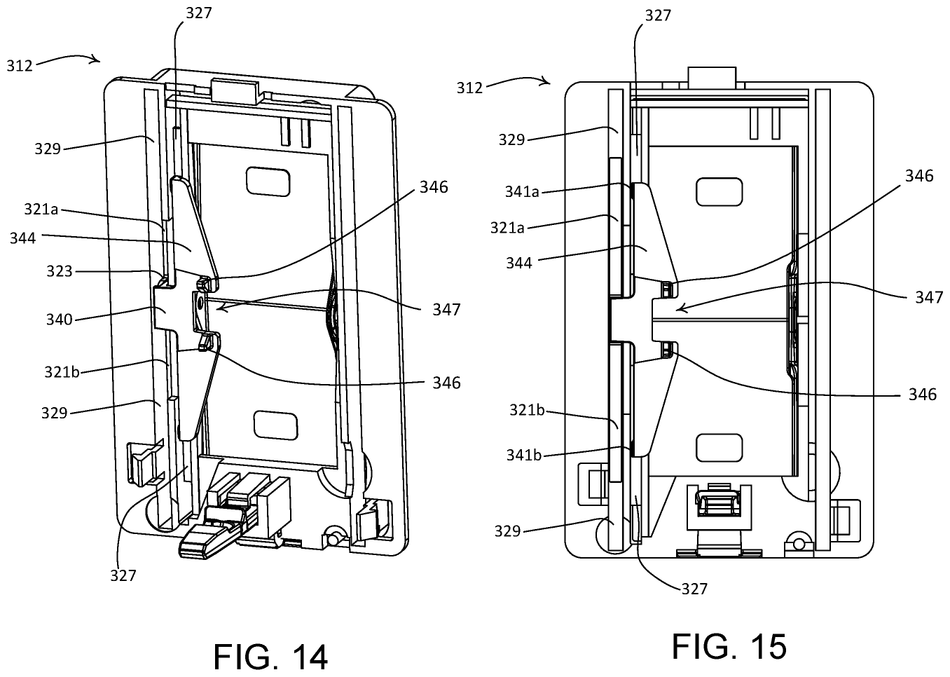

The control device 300 may include a potentiometer 370, which may be adjusted in response to a user input provided from the slider knob 342 in order to control the amount of power delivered to the lighting load. As noted below, the potentiometer 370 may be mounted to a main printed circuit board (PCB) 360 of the control device 300. The potentiometer 370 may generate a direct-current (DC) voltage representative of the desired amount of power to be delivered to the electrical load. In some examples, the potentiometer 370 provides a variable resistance based on the position of the slider knob 342. For example, a potentiometer shaft 372 of the potentiometer 370 may be coupled to the slider actuator 340. A more detailed explanation of how the potentiometer shaft 372 may be coupled to the slider actuator 340 is described below with reference to FIG. 14-18. When the slider knob 342 is moved along the slider slot 337, the movement of the slider actuator 340 may cause the potentiometer shaft 472 to be adjusted accordingly. In examples where the electrical load is a lighting load, the potentiometer shaft 372 may allow a user to adjust the intensity level of the attached lighting load from a low-end intensity level L_{LE} to a high-end intensity level L_{HE}. Alternatively, in some examples, the control device 300 may include a linear encoder, a combination of a wiper and a resistive trace on the main PCB 340 of the control device 300, a mechanical or magnetic encoder, etc. instead of a potentiometer.

The load control device 300 may include an enclosure that includes an enclosure back cover 330 and an enclosure frame 398. The enclosure back cover 330 may house the load control circuitry of the control device 300. Although illustrated with the enclosure, in some examples, such as when the control device 300 is a wireless, remote control device, the enclosure may be omitted. In such examples, the control device 300 may connect to a base that is affixed to the toggle or paddle actuator of a standard light switch. When the control device 300 is a wall-mounted dimmer switch, the control device 300 may comprise a yoke 332 that may be connected to the enclosure back cover 330 and may be configured to mount the control device 300 to an electrical wallbox.

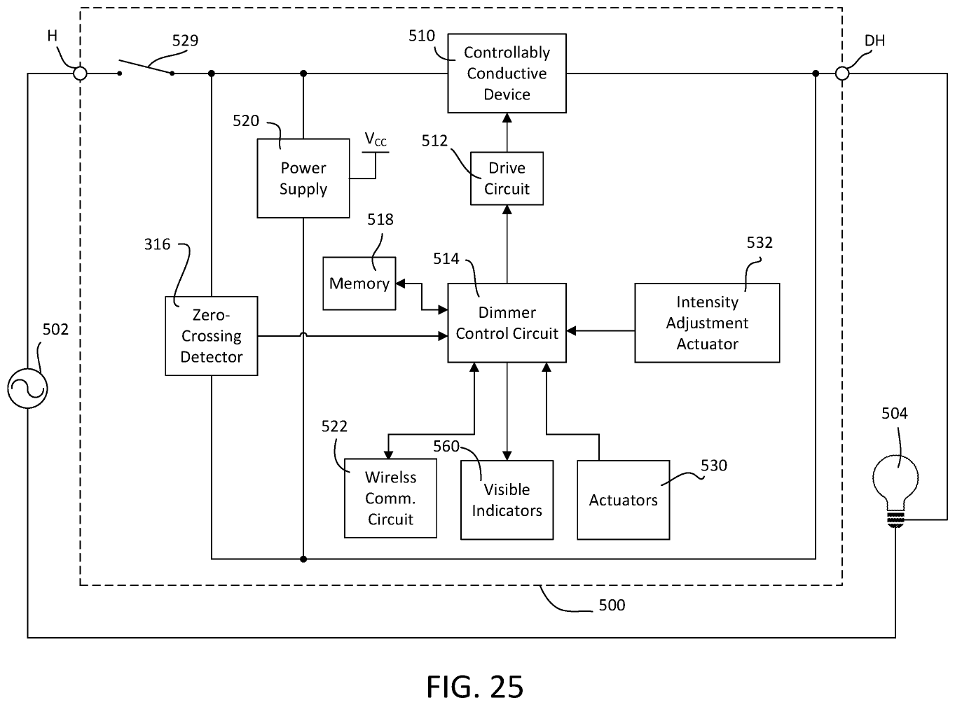

The control circuitry used to control the present intensity level L_{PRES} of the lighting load may be mounted to the main PCB 360. For example, the main PCB 360 may have mounted thereto any combination of a control circuit (e.g., a primary control circuit), memory, a drive circuit, one or more controllably conductive devices, a zero-crossing detector, a low-voltage power supply, etc. (e.g., as shown in FIG. 25). The control circuit mounted to the main PCB 360 may be operatively coupled to a control input of the controllably conductive device, for example, via the drive circuit. The control circuit may be used for rendering the controllably conductive device conductive or non-conductive, for example, to control the amount of power delivered to the lighting load and thus the present intensity level L_{PRES} of the lighting load. The control device 300 may also include mechanical switches, such as first and second tactile switches 362, 364 mounted to the main PCB 360. The mechanical switch may be configured to be actuated in response to actuations (e.g., tactile actuations) of the upper portion 316 and the lower portion 318 of the actuation member 310, respectively (e.g., to turn the electrical load on and off). In some examples, the control device 300 may be configured to control a lighting load of the lighting control system to turn the lighting load on in response to an actuation of the first tactile switch 362, and to turn the lighting load off in response to an actuation of the second tactile switch 364 (or vice versa). The control device may comprise an antenna having a feed loop located on an antenna feed loop PCB 365 and a radiating loop located on an antenna radiating loop PCB 382. An example of the antenna is described in greater detail in commonly-assigned U.S. Pat. No. 7,362,285, issued Apr. 22, 2008, entitled COMPACT RADIO FREQUENCY TRANSMITTING AND RECEIVING ANTENNA AND CONTROL DEVICE EMPLOYING SAME, the entire disclosure of which is hereby incorporated by reference.

The control device 300 may include a rubber membrane 380 that allows the actuator member 310 to pivot. For example, the rubber membrane 380 may enable the actuation member 310 to pivot about the pivot axis 322 in response to a tactile actuation of the upper portion 316 and the lower portion 318. The rubber membrane 380 may be located at the center of the back of the actuation member 310. The rubber membrane 380 may define the pivot axis 322 of the actuation member 310. The rubber membrane 380 may include an opening 381 that accepts an antenna feed loop PCB 365 that is mounted to the main PCB 360.

The feed loop on the antenna feed loop PCB 365 may be electrically coupled to the communication circuit of the control device 300. The feed loop on the antenna feed loop PCB 365 and the radiating loop on the antenna radiating loop PCB 382 may in combination allow for wireless signals (e.g., RF signals and/or IR signals) to be radiated out of the control device 300. The control device 300 may also include an antenna feed loop PCB clamp 384 that includes first and second deformable heat stakes 386a, 386b. By deforming (e.g., melting) the heat stakes 386a, 386b, the antenna feed loop PCB clamp 384 may be configured to secure the antenna radiating loop PCB 382 and the rubber membrane 380 to the yoke 332. The antenna feed loop PCB 365 may extend through the enclosure frame 398 of the control device 300, the antenna feed loop PCB clamp 384, the yoke 332, the antenna radiating loop PCB 382, and the rubber membrane 380.

The tactile actuation of the actuation member 310 may cause one of the first and second tactile switches 362, 364 of the main PCB 360 to be actuated (e.g., as shown in FIG. 9). For example, when the upper portion 316 of the actuation member 310 is actuated, a first post 355 of the actuation member 310 may be moved toward the main PCB 360. The first post 355 may contact a first rubber membrane 356, which may deflect inward and contact a first spacer rod 366. The deflection of first rubber membrane 356 may cause the first spacer rod 366 to move toward and actuate the first tactile switch 362 of the main PCB 360. Similarly, when the lower portion 318 of the actuation member 310 is actuated, a second post 357 of the actuation member 310 may be moved toward the main PCB 360. The second post 357 may contact a second rubber membrane 358, which may deflect inward and contact a second spacer rod 368. The deflection of second rubber membrane 358 may cause the second spacer rod 368 to move toward and actuate the second tactile switch 364 of the main PCB 360.

Further, the rubber membrane 380 may cause the actuation member 310 to be self-centered when not being actuated (e.g., when the user is not applying pressure to either the upper or lower portions 316, 318 of the actuation member 310). For example, the inclusion of the rubber membrane 380, which may be centered and independent from the first and second posts 355, 357 (e.g., and/or the first and second spacer rods 366, 368) may ensure that the actuation member 310 is centered when in a rest state (e.g., which may not occur if the actuation member 310 was balanced on each post 355, 357, since they may have different tolerances and/or spring rates). Further, since the first and second posts 355, 357 do not serve as pre-load generators for the actuation member 310, the upper portion 316 and the lower portion 318 of the actuation member 310 may have a shorter tolerance stack, which may allow for the upper and lower portions 316, 318 to have a shorter actuation distance of the upper portion 316 and the lower portion 318 of the actuation member 310, respectively (e.g., a shorter distance to cause the actuation of the first and second tactile switches 362, 364) and/or a shorter minimum product depth of the control device 300.

The user interface 302 of the control device 300 may comprise a visible display, such as an illumination surface 324. For example, a front surface of a diffuser 320 may act as the illumination surface 324 of the control device 300. The diffuser 320 may comprise a first elongated portion 321a (e.g., a first diffuser and/or a first portion of a diffuser) and a second elongated portion 321b (e.g., a second diffuser and/or a second portion of the diffuser). The diffuser 320 may be mechanically coupled to the slider body 344 the slider actuator 340 that also includes the slider knob 342. For example, the diffuser 320 and the slider actuator 340 may be attached to the base portion 312 of the control device 300, for example, as described below with reference to FIG. 14-18. In such instances, the diffuser 320 may be configured to move behind the slider slot 337 in response to movements of the slider knob 342. The diffuser 320 (e.g., the first and second elongated portions 321a, 321b) may be linear. When configured, the diffuser 320 may reside behind the slider slot 337 in the base portion 312 of the control device 300.

The control device 300 may be configured to illuminate the illumination surface 324 of the user interface 302 using one or more light sources 338 (e.g., one or more LEDs) of the control device 300 to visibly display information, such as the present intensity level L_{PRES} of one or more lighting loads controlled by the control device 300. For example, the illumination surface 324 may be configured to be illuminated to display the amount of the power delivered to an electrical load(s) (e.g., the present intensity level L_{PRES} of the lighting load(s)) controlled by the control device 300 based on the position of the slider knob 342 (e.g., the position of the slider knob 342 along the slider slot 337 between the low-end position 334 and the high-end position 336). For example, the illumination surface 324 (e.g., the diffuser 320) may be configured to diffuse (e.g., spread or scatter) light received from the plurality of light sources 338 to provide feedback (e.g., to display the amount of power delivered to an electrical load(s)).

The control device may include first and second spacer rods 366, 368, a light guide structure (e.g., a tunnel structure) 390, and a connector structure 394 (e.g., as shown in FIG. 10, FIG. 12, and FIG. 13). The connector structure 394 may be configured to connect the first and second spacer rods 366, 368 to the enclosure frame 398.

The control device 300 may also comprise a light guide structure (e.g., a tunnel structure) 390, which may also be formed as part of the enclosure frame 398. The light guide structure 390 that may be configured to guide light from one or more light sources 338 located inside of the enclosure back cover 330 to the illumination surface 324 of the user interface 302. For example, the light guide structure 390 may include one or more apertures 392, which may be the same or different sizes. For example, top and bottom apertures 392 may each be larger than the other apertures 392 (e.g., as shown in FIG. 13). Further, the apertures 392 may be wider on the side closest to the light sources 338 and narrower at the side closest to the diffuser 320 (e.g., the apertures 392 may have a cross-sectional cone shape).

The light sources 338 may comprise one or more light-emitting diodes (LEDs) mounted to the main PCB 360 housed between the enclosure back cover 330 and the enclosure frame 398. In some examples, the light guide structure 390 may include the same number of apertures 392 as the number of light sources 338 on the main PCB 360. Further, the main PCB 360 may be coupled to the enclosure frame 398 such that the light sources 338 are aligned with the apertures 392 of the light guide structure 390 (e.g., each light source 338 may be located directly under a single aperture 392), or alternatively, such that the light sources 338 are offset from the apertures 392 (e.g., each light source 338 may be located between two apertures 392, for example, so that light does not emit directly up the aperture 392 into the diffuser 320).

The apertures 392 of the light guide structure 390 and the light sources 338 may be configured to cause the illumination surface 324 of the user interface 302 to be illuminated in the plurality of segments (e.g., the segments 326a-326i as shown in FIG. 4A-4D and/or FIG. 5A-5D). For example, the apertures 392 may be configured to segment the light illuminated by the light sources 338 prior to the light entering the diffuser 320. Further, the light guide structure 390 may be configured to minimize the amount of light that bleeds between adjacent segments of the illumination surface 324. For example, the light guide structure 390 (e.g., the apertures 392 of the light guide structure 390) may operate to prevent (e.g., substantially prevent) light emitted from a light source 338 from causing illumination in more than one segment of the illumination surface 324. For example, the distance between the apertures 392 and the light sources 338 may influence the clarity or discreteness of each segment of the plurality of segments (e.g., so that the segments 392). For instance, the control device 300 may be configured such that the distance between the apertures 392 and the light sources 338 is minimized (e.g., the light sources 338 may be within 1 mm of the apertures 392). In some examples, the distance between the apertures 392 and the light sources 338 may be the distance between the light guide structure 390 where apertures end 392 and the light sources 338. For instance, the light guide structure 390 may end before reaching the light sources 338. Alternatively, the light guide structure 390 may end at the PCB 360 to envelope (e.g., cover) a light source 338 in each aperture 392. Further, the control device 300 may be configured such that the distance between the apertures 392 and the diffuser 320 is such that there is some distance but is generally minimized (e.g., the apertures 392 may be approximately within the range of 0.3 mm to 1 mm from the diffuser 320). In some examples, the distance between an end of an aperture 392 and the diffuser 320 should be configured such that the light emitting from the aperture 392 projects onto the diffuser 320, but not so great that it increases the amount of light that bleeds between adjacent segments.

Further, in some examples, the base portion 312 may be configured to reduce the amount of light that bounces within the light guide structure 390 because, for example, the bouncing of light may result in the plurality of segments looking less refined or fuzzy. For example, the base portion 312, such as an interior surface of the base portion 312, may be painted (e.g., painting black or another dark color) or coated such that the light generated by the light sources 338 is less prone to bounce or reflect between the apertures 392. Further, in some examples, the main PCB 360 may be coated or painted with a dark color (e.g., black) to reduce or prevent the amount of light that bleeds between adjacent segments.

However, in instances where the control device 300 is configured to illuminate the illumination surface 324 of the user interface 302 in a continuous bar (e.g., the continuous bar 328 as shown in FIG. 6A-6D and/or FIG. 7A-7D), the apertures 392 (e.g., or the light guide structure 390 entirely) may be omitted from the control device 300. For instance, the control device 300 may include the light guide structure 390 that includes a single, elongated aperture 392 in examples where the control device 300 is configured to illuminate the diffuser 320 in a continuous bar. Further, in some examples, the control device 300 may include one or more light pipes, where each light pipe may be configured to guide light from one or more of the plurality of light sources to illuminate the diffuser 320 in a continuous bar. Further, in some examples, the light guide structure 390 may be omitted, for instance, in examples where the control device 300 is configured to illuminate the diffuser 320 in a continuous bar.

The slider knob 342 may define a length, and the length of the slider knob 342 may be equal to or greater than the length of each of the plurality of segments of the illumination surface 324, for example, as described with reference to the slider knob 242 of the control device 200. In one example, the illumination surface 324 may be illuminated into one or more of nine, discrete segments of illumination. A length of the slider knob 342 and/or the segments may be selected based on a desired ratio between the length of the slider knob and the length of each of the plurality of segments. Further, in some examples, the illumination surface 324 of the user interface 302 may be configured to be illuminated to create a single continuous bar based on, for example, the intensity level of the lighting load(s) controlled by the control device 300 (e.g., and in some examples, the location of the slider knob 342), such as the examples illustrated in FIGS. 6A-6D and 7A-7D.

The control device 300 may comprise a wireless communication circuit. The wireless communication circuit may include for example, a radio-frequency (RF) transceiver coupled to an antenna for transmitting and/or receiving RF signals. The wireless communication circuit may also include an RF transmitter for transmitting RF signals, an RF receiver for receiving RF signals, and/or an infrared (IR) transmitter and/or receiver for transmitting and/or receiving IR signals. The wireless communication circuit may be configured to transmit a control signal that includes the control data (e.g., a digital message) generated by the control circuit to the lighting load. The wireless communication circuit may be configured to receive a message (e.g., digital message) from one or more remote control devices of the load control system (e.g., the retrofit remote control device 112, the wall-mounted remote control device 114, the tabletop remote control device 116, the handheld remote control device 118, a smart phone, a tablet, a computer, and/or the like). The message may include a command to adjust the present intensity level L_{PRES} of the lighting load controlled by the control device 300 from an initial intensity level L_{INIT} of the lighting load to a commanded intensity level L_{CMD} indicated by the message.

In response to receiving a message from a remote device, the control device 300 may control the lighting load to the commanded intensity level L_{CMD}. Further, the control device 300 may illuminate the illumination surface 324 of the user interface 302 to indicate the intensity level of the lighting load. Since, for example, the message may command the control device 300 to control the intensity level of the lighting load to a level that is not synchronized with (e.g., aligned with) the position of the slider knob 342, the control device 300 may be configured to illuminate the illumination surface 324 such that the illuminated portion of the illumination surface 324 does not align with (e.g., track) the position (e.g., location) of the slider knob 342, but does indicate the intensity level of the lighting load. That is, when the commanded intensity level L_{CMD} indicated by a message received from a remote device does not correspond with the position of the slider knob 342, the control device 300 may be configured to illuminate the illumination surface 324 to indicate the intensity level of the lighting load in accordance with the received message such that the illuminated portion of the illumination surface 324 is not aligned with the position of the slider knob 342 along the slider slot 337 (e.g., as described with reference to FIG. 5A-5D and FIG. 7A-7D). As such, the illuminated feedback provided via the diffuser 320 may be decoupled from the position of the slider knob 342.

The position of the slider knob 342 along the slider slot 337 may be adjusted by a user after the control device 300 controlled the lighting load to the commanded intensity level L_{CMD} based on a received message from a remote device (e.g., and the illuminated portion of the illumination surface 324 is not aligned with the position of the slider knob 342 along the slider slot 337). In such instances, and in response to a movement of the slider knob 342, the control device 300 may be configured to realign the illuminated portion of the illumination surface 324 with the position of the slider knob 342 and control the intensity level of the lighting load accordingly. In some examples, the control device 300 may be configured to realign the illuminated portion of the illumination surface 324 with the position of the slider knob 342 by adjusting the illuminated portion from its original position to the position of the slider knob 342 (e.g., over an adjustment period). As such, when the illuminated portion of the illumination surface 324 is not aligned with position of the slider knob 342 and the position of the slider knob 342 is adjusted, the control device 300 may be configured to control the intensity level of the lighting load based on the position of the slider knob 342 and control the one or more light sources to realign the position of the illuminated portion of the illumination surface 324 with the position of the slider knob 342.

Accordingly, the control device 300 may be configured to illuminate a portion of the illumination surface 324 that is located below the slider knob 342 within the slider slot 337 in response to movement of the slider knob 342 (e.g., as illustrated in FIG. 4A-4D and FIG. 6A-6D). For example, in response to movement of the slider knob 342, the control device 300 may be configured to illuminate the illumination surface 324 below the location of the slider knob 342 without illuminating any portion of the illumination surface 324 located above the slider knob 342. In such examples, the illuminated portion of the illumination surface 324 may remain at or below the slider knob 342 and may not extend above the slider knob 342 (e.g., a top edge of the slider knob 342). For instance, the slider knob 342 may be made of an opaque material (e.g., a reflective color, such as white) and the control device 300 may control the one or more light sources such that the illuminated portion of the illumination surface 324 remains at or below the slider knob 342 and does not extend above the slider knob 342. Further, in some instances, the control device 300 may illuminate the entirety of the illumination surface 324 below the slider knob 342 in response to movements of the slider knob 342 (e.g., in a continuous or segmented manner).

However, when the control device 300 receives a message indicating a commanded intensity level L_{CMD} of the lighting load from a remote device, the control device 300 may be configured to illuminate a portion of the illumination surface 324 in accordance with the commanded intensity level L_{CMD}, regardless of the position of the slider knob 342. This may result in the control device 300 illuminating a portion of the illumination surface 324 that extends above a top edge 347 of the slider knob 342 and/or falls well below a bottom edge 349 of the slider knob 342. As such, the control device 300 may illuminate the illumination surface 324 such that the illuminated portion of the illumination surface 324 is not aligned with the position of the slider knob 342 along the slider slot 337, for example, because the present intensity level L_{PRES} of the lighting load does not correspond with the position of the slider knob 342.

Further, if the control device 300 was turned off when the illuminated portion is not aligned with the position of the slider knob 342, but then control device 400 is turned back on using the actuation member 310, then the control device 300 may be configured to control the lighting load to the intensity level indicated by the slider knob 342. However, in other examples, the control device may be configured to control the lighting load to the intensity level that the lighting load was controlled to when the control device 300 was turned off, irrespective of the position of the slider knob 342.

FIG. 14 and FIG. 15 illustrate rear perspective views of the base portion 312 with the actuation portion 310, the slider actuator 340, and the diffuser 320 installed. The base portion 312 (e.g., bezel) of the control device 300 may include an elongated slot, such as the slider slot 337. As noted herein, the slider slot 337 may be an elongated opening in the base portion 312 of the control device 300. In some examples, the slider slot 337 may be located adjacent to the actuation member 310. A rear side of the base portion 312 may define a first channel 327 and a second channel 329. The first channel 327 may be configured to receive the slider body 344 of the slider actuator 340 (e.g., one or more nubs of the slider body 344). The second channel 329 may be configured to receive the diffuser 320 (e.g., the elongated portions of the diffuser 320). The second channel 329 may also include the slider slot 337. For example, the second channel 329 may be longer (e.g., and wider) than the slider slot 337 such that the illumination on the illumination surface 324 (e.g., the segmented bar) may be seen through the slider slot 337. Further, the second channel 329 may support the diffuser 320 while the slider knob 342 is moved, for example, to ensure that the first and second elongated portions 321a, 321b stay within the second channel 329 and the slider slot 337.

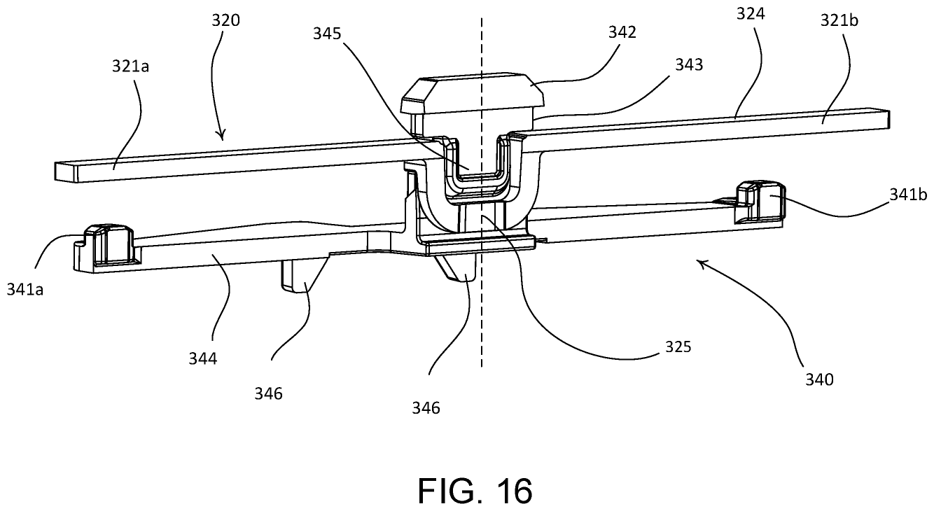

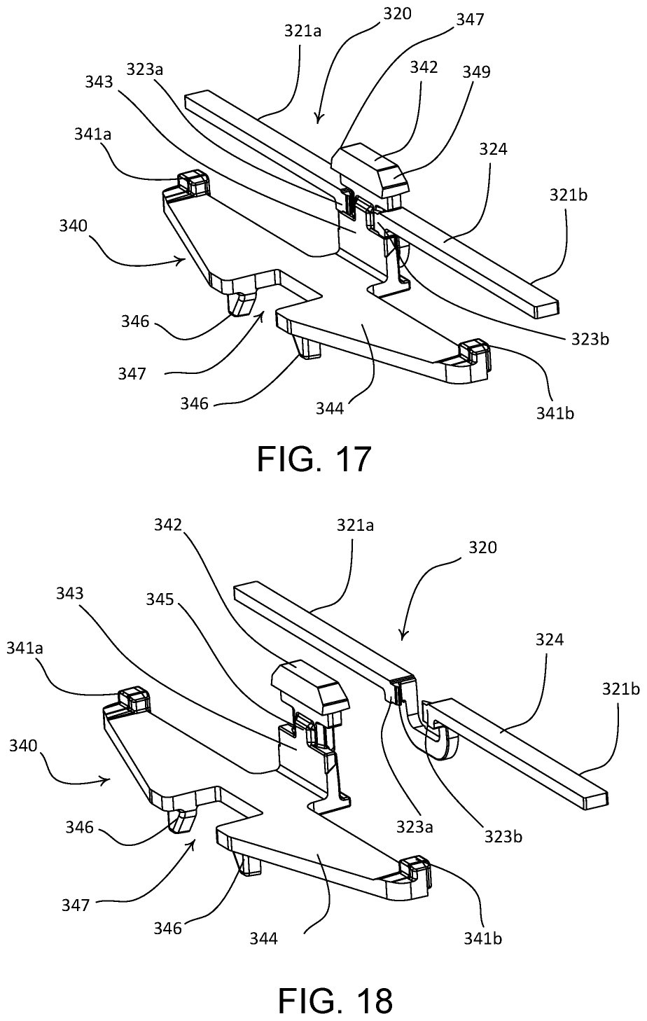

FIG. 16 illustrates a side, perspective view of the diffuser 320 and the slider actuator 340 coupled together. FIG. 17 illustrates a front, perspective view of the diffuser 320 and the slider actuator 340 coupled together. FIG. 18 illustrates the front, perspective view of the diffuser 320 and the slider actuator 340 when they are separated from one another. The diffuser 320 may be an example of the diffuser 220 of the load control device 200. The slider actuator 340 may be an example of the slider actuator 240 of the load control device 200.

As noted herein, the diffuser 320 may include the first elongated portion 321a and the second elongated portion 321b. The first and second elongated portions 321a, 321b (e.g., the illumination surface of the first and second elongated portions 321a, 321b) may be configured to diffuse light transmitted from the light sources 338 through the light guide structure 390 and out through the illumination surface 324 of the user interface 302 and through the slider slot 337 to provide feedback to the user. The diffuser 320 may also include two snaps 323a, 323b that connect the diffuser 320 to the slider actuator 340, for example, through a snap-fit connection. The snaps 323a, 323b may loosely couple the diffuser 320 to the slider actuator 340, such that the diffuser 320 is able to pivot about the pivot axis 325.

The slider actuator 340 may include the slider knob 340 that resides at the end of a slider shaft 343. As noted herein, the slider knob 340 may be configured to be moved (e.g., by a user) to adjust the amount of power delivered to an electrical load by the control device 300. For example, the slider knob 342 may be configured to move along an elongated path (e.g., in a vertical direction) along the slider slot 337 between the low-end position 334 and the high-end position 336 of the slider slot 337. In examples where the electrical load is a lighting load(s), the slider knob 342 may allow for adjustment of the intensity level L of the lighting load from the low-end intensity level L_{LE} (e.g., when the slider knob 342 is located in the low-end position 334) to the high-end intensity level L_{HE} (e.g., when the slider knob is located in the high-end position 336).

The slider shaft 343 may extend between the slider body 344 and the slider knob 342. As noted above, the snaps 323a, 323b may be configured to engage the slider shaft 343 to enable a connection (e.g., a loose snap-fit connection) between the slider actuator 340 and the diffuser 320. When connected, the slider shaft 343 may be configured to pivot about a pivot axis 325, which may be located where the snaps 323a, 323b contacts the slider shaft 343. The pivot axis 325 may allow for the diffuser 320 and/or slider actuator 340 to pivot in response to, for example, transverse force caused by movement of the slider knob 342 along the slider slot 337.

The slider actuator 340 may include the slider body 344 that includes one or more nubs, such as nubs 341a, 341b, one or more protrusions 346, and a notch 347. The slider body 344 may be coupled to the slider shaft 343, for example, at a substantially perpendicular angle. The notch 347 may be sized to receive the potentiometer shaft 372. Further, the protrusions 346 may be sloped into towards the notch 347, and the sloped shape of the protrusions 346 may facilitate the receiving of the potentiometer shaft 372 into the notch 347 (e.g., during manufacturing). As such, when installed, the slider actuator 340 may be mechanically coupled to the potentiometer shaft 372 such that movement of the slider knob 342 along the slider slot 347 causes the position of the potentiometer shaft 372 to move, and in response the control device 300 to adjust the amount of power delivered to the electrical load. Further, in such examples, the slider knob 342 may be offset from the notch 347. Therefore, when coupled together, the potentiometer shaft 372 may not be located directly below the slider knob 342 (e.g., due to the slider body 344 being coupled to the slider shaft 343 at a substantially perpendicular angle).

Referring back to FIG. 14 and FIG. 15, the first and second elongated portions 321a, 321b of the diffuser 320 may be configured to reside within and travel along the second channel 329 on the rear side of the base portion 312. Further, the nubs 341a, 341b may be configured to reside within (e.g., snap within) the first channel 327. The nubs 341a, 341b may be configured travel along the first channel 327 during movement of the slider knob 342 along the slider slot 337. As such, the nubs 341a, 341b may be configured to support the slider actuator 340 as the slider knob 342 is moved along the slider slot 337. The base portion 312 is configured to allow for the slider actuator 340 and diffuser 320 to move (e.g., in unison) in response to movements of the slider knob 342 along the slider slot 337 in the base portion 312. Further, since the slider actuator 340 may be mechanically coupled to the potentiometer shaft 372 (e.g., via the protrusions 346 and the notch 347), any movement of the slider knob 342 along the slider slot 337 may cause the position of the potentiometer shaft 372 to move, and in response the control device 300 to adjust the amount of power delivered to the electrical load. Finally, it should be appreciated that the nubs 341a, 341b residing within the first channel 327 and/or the first and second elongated portions 321a, 321b residing within the second channel 329 may reduce transverse and/or rotational force on the diffuser 320 and/or slider actuator 340 in response to movement of the slider knob 342 along the slider slot 337.

The control device 300 may comprise an air-gap switch 319 adapted to be electrically coupled (e.g., substantially directly electrically coupled) in series between a power source (e.g., an AC power source) and the controllable light source. In some examples, the air-gap switch 319 may not comprise a bidirectional semiconductor switch (e.g., such as a triac or one or more field-effect transistors) for controlling the amount of power delivered to the electrical load device using a phase-control dimming technique (e.g., as in a standard dimmer switch). When the air-gap switch 319 is closed, a load voltage is developed across the lighting load and is substantially undistorted from the AC line voltage produced by the AC power source. The air-gap switch 319 may be opened to provide an actual air-gap barrier between the power source and the lighting load to facilitate servicing of the lighting load.

The control device 300 may change an operating mode of the control device 300 in response to the actuation or adjustment of a combination of the actuation member 310 and slider knob 342 and/or via an external device (e.g., a mobile application residing on a smartphone and/or tablet that is configured with short-range wireless communication (e.g., BLE), for example. For instance, the control device 300 may change the operating mode in response to the actuation of the lower portion 318 of the action member 310 and by dragging the slider knob 342 from the top of the slider slot 337 to the bottom of the slider slot 337. In another example, the control device may change the operating mode in response to the reception of a control signal from an external device (e.g., from the external device to a hub of the load control system and from the hub to the control device 300).

One example of a change in operating mode is a change between an intensity control mode and a color control mode (e.g., a color temperature control mode and/or a full color spectrum control mode). Another example of a change in operating mode is a change between a normal operating mode and a commissioning mode that is used to associate the control device 300 with an electrical load. Yet another example of a change in operating mode is a change between a normal operating mode to an advanced programming mode. As described herein, an advanced programming mode may allow configuration and/or adjustment of one or more operating characteristics of the control device and/or a lighting load of the lighting control system 100, such as a low-end trim (e.g., a minimum intensity level) and/or a high-end trim (e.g., a maximum intensity level) of the lighting load.

During an advanced programming mode as described herein, the slider knob 342 may be adjusted to adjust an operating characteristic (e.g., such as a low-end trim) of the control device. The diffuser 320 may be affixed to the actuation member 310, and as such, the diffuser 320 may be configured to move when the actuation member 310 pivots. An example of a control device having an advanced programming mode is described in greater detail in commonly-assigned U.S. Pat. No. 7,190,125, issued Mar. 13, 2007, entitled PROGRAMMABLE WALLBOX DIMMER, the entire disclosure of which is hereby incorporated by reference.

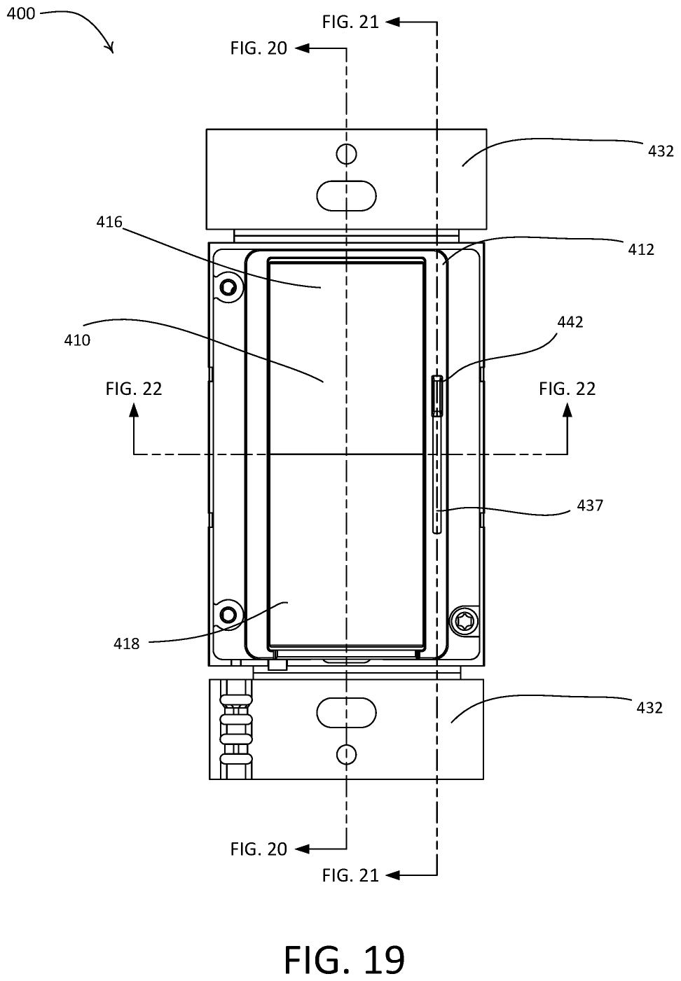

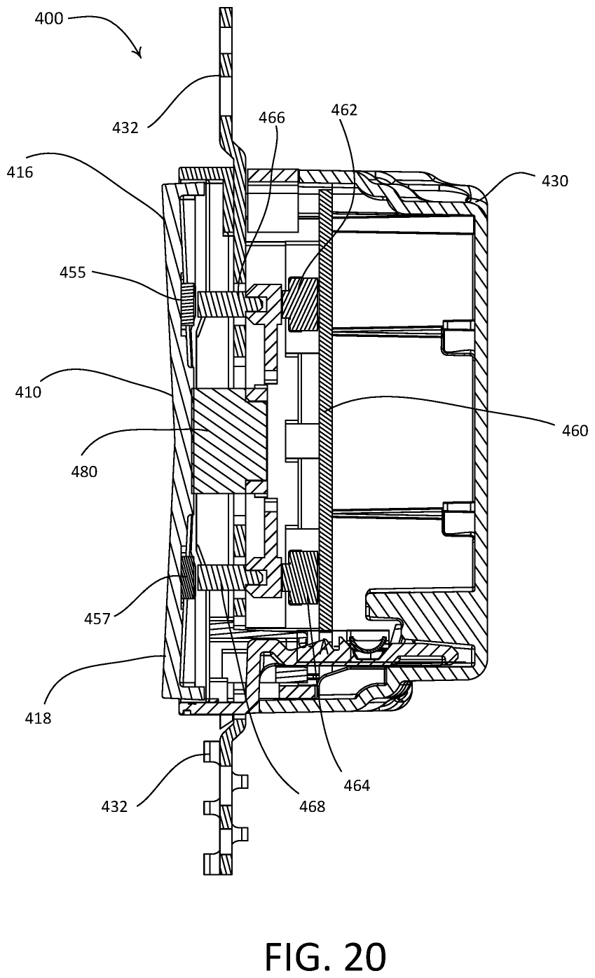

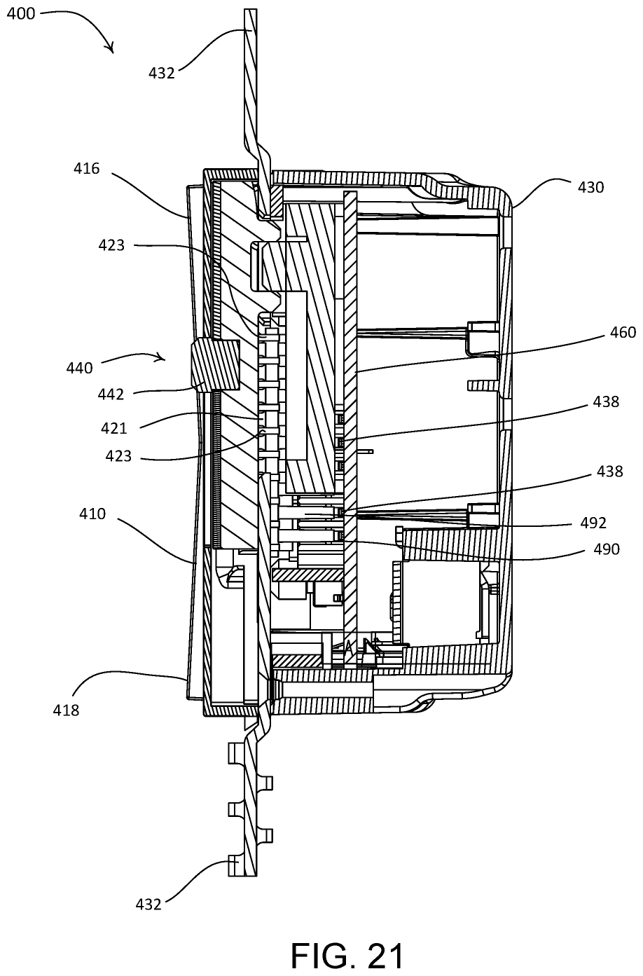

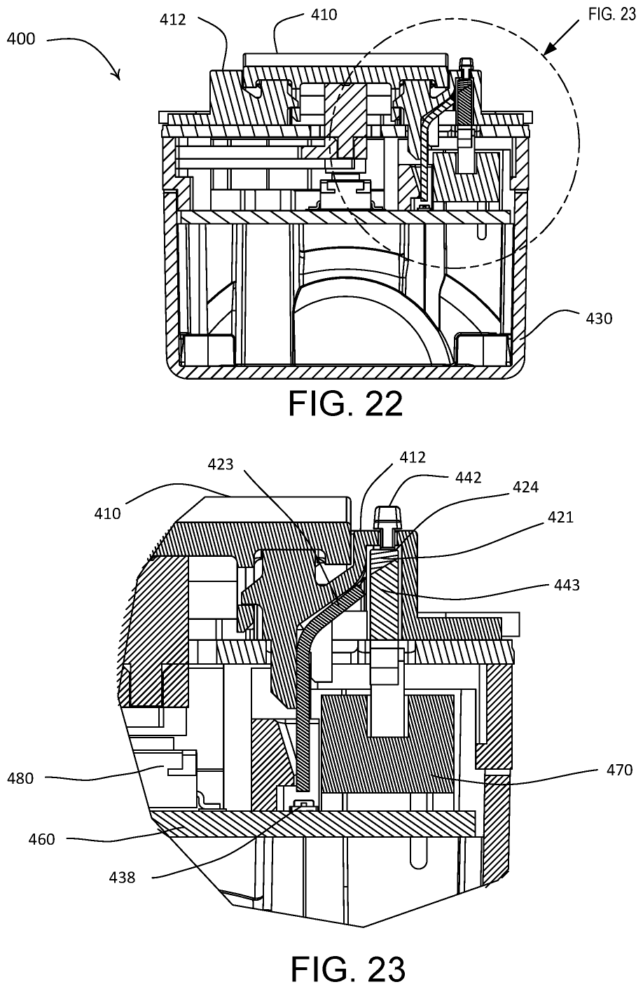

FIGS. 19-24 illustrate various perspective views of an example control device 400 that may be deployed as a dimmer switch of the load control system illustrated in FIG. 1. The control device 400 may be an example of the control device 200 and/or the control device 300. For example, the control device 300 may be configured to be provide feedback via a visible display, such as an illumination surface of a diffuser bar in a similar manner as described with respect to the control device 200 (e.g., FIG. 4A-4D, FIG. 5A-5D, FIG. 6A-6D, and/or FIG. 7A-7D). Although not illustrated, the control device 400 may be configured to be mounted in an electrical wallbox with a faceplate.

The control device 400 may comprise a user interface 402. The control device 400 may be configured to control the amount of power delivered to a lighting load. For example, the control device 400 may be configured to turn the lighting load on or off (e.g., in response to actuations of an actuation member), or adjust the intensity level of the lighting load by controlling an internal load control circuit (e.g., a controllably conductive device of the control device 400) and/or by transmitting a message for controlling the lighting load via a communication circuit (e.g., a wireless signal via a wireless communication circuit). When the control device 200 is a wall-mounted dimmer switch, the control device 400 may comprise an enclosure (e.g., the enclosure 430) for housing load control circuitry of the dimmer switch.

The user interface 402 of the control device 400 may include an actuation member 410 that is configured to be mounted to a base portion 412 (e.g., a bezel) of the control device 400. The actuation member 410 may comprise a front surface 414 including an upper portion 416 and a lower portion 418. The actuation member 410 may be configured to pivot about a pivot axis 422 (e.g., a central axis) in response to a tactile actuation (e.g., a tactile input) of the upper portion 416 and the lower portion 418. Alternatively or additionally, the front surface of the actuation member 410 may comprise a touch sensitive surface, and the control device may be responsive to touch actuations along the front surface of the actuation member 410. In some of these instances, the actuation member 410 may be rigidly affixed to the base portion 412 (e.g., the actuation member 410 may be configured to not pivot about an axis).

The control device 400 may be configured to control a lighting load of a lighting control system to turn the lighting load on in response to a tactile actuation of the upper portion 416, and to turn the lighting load off in response to a tactile actuation of the lower portion 418 (or vice versa). For example, the control device 400 may include a controllably conductive device adapted to be coupled in series electrical connection between an alternating current (AC) power source and the lighting load. The control device 400 may be configured to control the amount of power delivered to the lighting load in response to actuations of the actuation member 410. For example, the control device 400 may control the controllable conductive device to connect the AC power source to the lighting load in response to an actuation of an upper portion 416 of the actuation member 410, and control the controllable conducive device to disconnect the AC power source from the lighting load in response to an actuation of a lower portion 418 of the actuation member 410. The control device 400 may include one or more tactile switches that are actuated in response to the tactile actuations of the upper and/or lower portions 416, 418 of the actuation member 410, for example, as described herein.

The control device 400 may include an analog intensity adjustment actuator. The analog intensity adjustment actuator may comprise a movable component that is configured to move relative to the base portion 412, and the position of the moveable component (e.g., relative to the base portion 412) may be indicative of the amount of power provided by the control device 400 to the electrical load. For instance, the user may be configured to move the moveable component and, in response, the control device 400 may be configured to adjust the amount of power delivered to the electrical load based on the position of the movable component. In the illustrated example of FIGS. 19-24, the analog intensity adjustment actuator may include a slider actuator 440 comprising a slider knob 442, a slider body 443, and one or more protrusions 446. The control device 400 may control the magnitude of a load current conducted through the lighting load (e.g., the intensity level of the light load) in response to movement of the slider knob 442. For example, when the lighting load is on, the control device 400 may control the intensity level of the lighting load in response to movement of the slider knob 442. When the lighting load is off, the control device 400 may not adjust the intensity level of the lighting load in response to movement of the slider knob 442. But, when the lighting load is off and the upper portion 416 of the actuation member 410 is actuated, the control device 400 may turn on the lighting load to an intensity level determined based on the position of the slider knob 442.

The slider knob 442 may be configured to move along (e.g., behind) an elongated slot, such as a slider slot 437. The slider slot 437 may be an elongated opening in the base portion 412 of the control device 400. For example, the slider slot 437 may be located adjacent to the actuation member 410. Alternatively, the slider slot 437 may be located in the actuation member 410, and for example, may move in response to actuations of the actuation member 410. The slider knob 442 may be configured to move in a vertical direction along the slider slot 437 between a low-end position 434 and a high-end position 436. The slider knob 442 may allow for adjustment of the intensity level L of the lighting load from the low-end intensity level L_{LE} (e.g., when the slider knob 442 is located in the low-end position 434) to the high-end intensity level L_{HE} (e.g., when the slider knob 442 is located in the high-end position 436). Accordingly, the slider knob 442 may be operable to move in a vertical direction along the length of the slider slot 437 of the base portion 412, and the base portion 412 may be configured to be received in an opening of the faceplate 404. In some examples, the slider knob 442 may be snapped into and retained by the slider slot. For instance, the slider knob 442 may be wider than the slider slot 437 and, during manufacturing, the slider slot 437 may be configured to temporarily deform when the slider knob 442 is pressed through from a rear side of the slider slot 437 towards a front surface 414 of the actuation member 410. Although illustrated as extending along a vertical direction along the base portion 412, in other examples, the slider slot 437 may extend in a horizontal direction (e.g., and be located above or below the actuation member 410). Further, in some examples, the control device may include multiple adjustment actuators, such as a first actuator that is configured to move in a vertical direction (e.g., to control the intensity of a lighting load) and a second actuator that is configured to move in a horizontal direction (e.g., to control a color, such as color temperature, of the lighting load).

The control device 400 may include a potentiometer 470, which may be adjusted in response to a user input provided from the slider knob 442 in order to control the amount of power delivered to the lighting load. For example, the potentiometer 470 may generate a direct-current (DC) voltage representative of the desired amount of power to be delivered to the electrical load. In some examples, the potentiometer 470 provides a variable resistance based on the position of the slider knob 442. For example, a potentiometer shaft 472 of the potentiometer 470 may be coupled to the slider actuator 440. For instance, the potentiometer shaft 472 may be mechanically coupled to or engaged by one or more protrusions 446 of the slider actuator 440. As such, when the slider knob 442 is moved along the slider slot 437, the protrusions 446 also move and cause the potentiometer shaft 472 to be adjusted accordingly. In examples where the electrical load is a lighting load, the potentiometer shaft 472 may allow a user to adjust the intensity level of the attached lighting load from a low-end intensity level L_{LE} to a high-end intensity level L_{HE}. Alternatively, in some examples, the control device 400 may include a linear encoder, a combination of a wiper and a resistive trace on a PCB of the control device 200, a mechanical or magnetic encoder, etc. instead of a potentiometer.

The control device 400 may comprise a diffuser 420. The diffuser 420 may be part of the slider actuator 440. For example, the front surface of the slider actuation 440 may include the diffuser 420. Further, the control device 400 may comprise a visible display, such as an illumination surface 424. For example, a front surface of the diffuser 420 may act as the illumination surface 424 of the control device 400. The diffuser 420 may be located within and/or behind the slider slot 437. In some examples, the diffuser 420 may extend along the base portion 412 adjacent the actuation member 410. Alternatively, the diffuser 420 may extend along a front surface of the actuation member 410. In some examples, the diffuser 420 may be located behind the slider knob 442 (e.g., as illustrated). The diffuser 420 may be linear. Further, although described with reference to the illumination surface 424, in other examples, the visible display of the control device 400 may take other forms, such as, a plurality of visible indicators (e.g., a linear array of visible indicators, such as that illustrated in FIG. 30A-30C), a first visible indicator located above the slider slot 437 and a second visible indicator located below the slider slot 437 (e.g., such as that shown in FIGS. 32A-32C), a visible indicator located in the slider knob 442 (e.g., such as that shown in FIGS. 34A-34B), a plurality of discrete segments that are configured on the front surface of the base portion outside of the slider slot (e.g., between the actuation member 410 and the slider slot 437), and/or the like.

The control device 400 may also include one or more light pipes 423, which may have a curved or bent shape, for example, and be configured to guide light from one or more light sources 438 of the control device 400 to the diffuser 420 to provide feedback to the user of the control device 400. For example, as illustrated in FIG. 23, a light source 438 may be controlled to illuminate light. The illuminated light may be guided by a light guide structure 490 of the control device 400 (e.g., as described below) towards a light pipe 423. The light pipe 423 may receive the illuminated light and guide (e.g., reflect) it up the light pipe 423 and towards the illumination surface 424 to provide feedback (e.g., intensity level feedback) to the user via the slider slot 437. As illustrated, the light pipe 423 may be curved, and the top of the light pipe 423 may guide the light out of the light pipe 423 and into the diffuser 420. The slider body 443 (e.g., at least a top surface (e.g., a top diagonal surface) of the slider body 443) may be a uniform, reflective color, such as white, to ensure that a uniform amount of light is illuminated out of the diffuser 420. In some examples, there may be an equal number of light pipes 423 as light sources 438. And further, in some examples, each light pipe 423 associated with (e.g., aligned with) a light source 438.

In some examples, the slider actuator 440 and the diffuser 420 may be mechanically coupled to the base portion 412 (e.g., a rear surface of the base portion 412 within the slider slot 437). As such, in the control device 400, the diffuser 420 may remain stationary throughout any movement of the slider knob 442.

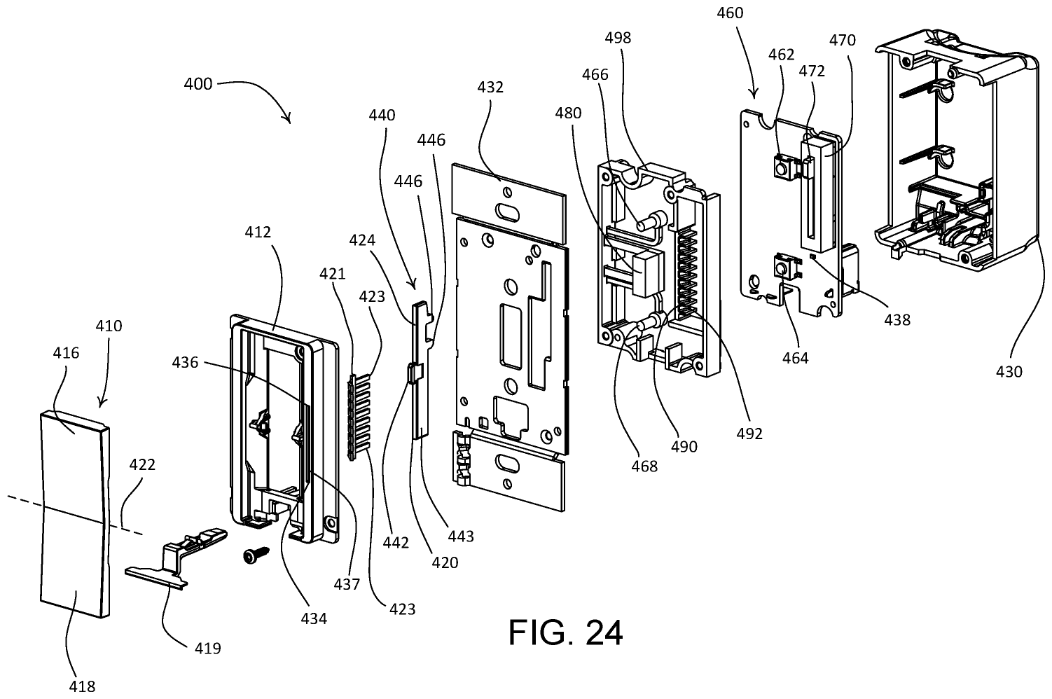

The control device 400 may be configured to illuminate the illumination surface 424 of the user interface 402 using one or more light sources 438 (e.g., one or more LEDs) of the control device 200 to visibly display information, such as the intensity level of one or more lighting loads controlled by the control device 400 (e.g., although only one light source 438 is illustrated in FIG. 24, the control device 400 may include a plurality of light sources 438). For example, the illumination surface 424 may be configured to be illuminated to display the amount of power delivered to an electrical load(s) (e.g., the intensity level of the lighting load(s)) controlled by the control device 400 based on the position of the slider knob 442 (e.g., the position of the slider knob 442 along the slider slot 437 between the low-end position 434 and the high-end position 436). For example, the illumination surface 424 (e.g., the diffuser 420) may be configured to diffuse (e.g., spread or scatter) light received from the plurality of light sources 438 to provide feedback (e.g., to display the amount of power delivered to an electrical load(s)). Alternatively or additional, the control device 400 may be configured to illuminate the illumination surface 424 to indicate whether the present intensity L_{PRES} of the lighting load is in synchronization with (e.g., aligned with) or not in synchronization with the position of the slider knob 424 along the slider slot 437.

The control device 400 may also comprise a back cover 498 that includes a light guide structure (e.g., a tunnel structure) 490 and first and second spacer rods 466, 468. The light guide structure 490 that may be configured to conduct light from one or more light sources 438 located inside of the enclosure 430 to the diffuser 420. For example, the tunnel structure 490 may define a plurality of cavities 492, which may be the same or different sizes. Further, the light sources 438 may comprise one or more light-emitting diodes (LEDs) mounted to a main printed circuit board (PCB) 460 housed in the enclosure 430. In some examples, the light guide structure 490 may include the same number of cavities 492 as the number of light sources 438 on the main PCB 460. Further, the main PCB 460 may be coupled to the back cover 498 such that the light sources 438 are aligned with the cavities 492 of the light guide structure 490 (e.g., each light source 438 may be located directly under a single aperture 492), or alternatively, such that the light sources 438 are offset from the cavities 492 (e.g., each light source 438 may be located between two cavities 492, for example, so that light does not emit directly up the cavities 492 into the diffuser 420). Further, in some examples, the size (e.g., diameter) of the cavities 492 may be shrink as the cavity gets closer to a light source 438, for example, to reduce the amount of light that bleeds between cavities 492.

The cavities 492 of the light guide structure 490 and the light sources 438 may be configured to cause the illumination surface 424 of the user interface 402 to be illuminated in a continuous bar of illumination, such as that shown with respect to FIG. 6A-6D and FIG. 7A-7D. However, in other examples, the control device 400 may include a light guide (e.g., such as the tunnel structure 390) that causes the illumination surface 424 to illuminate in one or more discrete segments.

The control device 400 may comprise the wireless communication circuit. The wireless communication circuit may include for example, a radio-frequency (RF) transceiver coupled to an antenna for transmitting and/or receiving RF signals. The wireless communication circuit may also include an RF transmitter for transmitting RF signals, an RF receiver for receiving RF signals, and/or an infrared (IR) transmitter and/or receiver for transmitting and/or receiving IR signals. The wireless communication circuit may be configured to transmit a control signal that includes the control data (e.g., a digital message) generated by the control circuit to the lighting load. The wireless communication circuit may be configured to receive a message (e.g., digital message) from one or more remote control devices of the load control system (e.g., the retrofit remote control device 112, the wall-mounted remote control device 114, the tabletop remote control device 116, the handheld remote control device 118, a smart phone, a tablet, a computer, and/or the like). The message may include a command to adjust the intensity level of the lighting load controlled by the control device 400.

In response to receiving a message from a remote device, the control device 400 may control the lighting load to the commanded intensity level L_{CMD}. Further, the control device 400 may illuminate the illumination surface 424 of the user interface 402 to indicate the intensity level of the lighting load. Since, for example, the message may command the control device 400 to control the intensity level of the lighting load to a level that is not synchronized with (e.g., aligned with) the position of the slider knob 442, the control device 400 may be configured to illuminate the illuminated surface 424 such that the illuminated portion of the illumination surface 424 does not align with (e.g., track) the position (e.g., location) of the slider knob 442, but does indicate the intensity level of the lighting load. That is, when the commanded intensity level L_{CMD} indicated by a message received from a remote device does not correspond with the position of the slider knob 442, the control device 400 may be configured to illuminate the illumination surface 424 to indicate the intensity level of the lighting load in accordance with the received message such that the illuminated portion of the illumination surface 424 is not aligned with the position of the slider knob 442 along the slider slot 437. As such, the illuminated feedback provided via the illumination surface 424 is decoupled from the position of the slider knob 442.

The position of the slider knob 442 along the slider slot 437 may be adjusted by a user after the control device 400 controlled the lighting load to the commanded intensity level L_{CMD} based on a received message from a remote device (e.g., and the illuminated portion 424 is not aligned with the position of the slider knob 442 along the slider slot 437). In such instances, and in response to a movement of the slider knob 442, the control device 400 may be configured to realign the illumination surface 424 with the position of the slider knob 442 and control the intensity level of the lighting load accordingly. In some examples, the control device 400 may be configured to realign the illumination surface 424 with the position of the slider knob 442 by adjusting the illuminated portion between its original position and the position of the slider knob 442 (e.g., over an adjustment period). As such, when the illuminated portion of the illumination surface 424 is not aligned with position of the slider knob 442 and the position of the slider knob 442 is adjusted, the control device 400 may be configured to control the intensity level of the lighting load based on the position of the slider knob 442 and control the one or more light sources to realign the position of the illuminated portion of the illumination surface 424 with the position of the slider knob 442.

Accordingly, the control device 400 may be configured to illuminate a portion of the illumination surface 424 that is located below the slider knob 442 within the slider slot 437 in response to movement of the slider knob 442. For example, in response to movement of the slider knob 442, the control device 400 may be configured to illuminate the illumination surface 424 below the location of the slider knob 442 without illuminating any portion of the illumination surface 424 located above the slider knob 442. In such examples, the illuminated portion of the illumination surface 424 may remain at or below the slider knob 442 and may not extend above the slider knob 442 (e.g., a top edge of the slider knob 442). For instance, the slider knob 442 may be made of an opaque material (e.g., a reflective color, such as white) and the control device 400 may control the one or more light sources such that the illuminated portion of the illumination surface 424 remains at or below the slider knob 442 and does not extend above the slider knob 442.

However, when the control device 400 receives a message indicating a commanded intensity level L_{CMD} of the lighting load from a remote device, the control device 400 may be configured to illuminate a portion of the illumination surface 424 in accordance with the commanded intensity level L_{CMD}, regardless of the position of the slider knob 442. This may result in the control device 400 illuminating a portion of the illumination surface 424 that extends above a top edge 447 of the slider knob 442 and/or falls well below a bottom edge 449 of the slider knob 442. As such, the control device 400 may illuminate the illumination surface 424 such that the illuminated portion is not aligned with the position of the slider knob 442 along the slider slot 437, for example, because the intensity level of the lighting load does not correspond with the position of the slider knob 442.

Further, if the control device 400 was turned off when the illuminated portion of the illumination surface 424 is not aligned with the position of the slider knob 442, but then control device 400 is turned back on using the actuation member 410, then the control device 400 may be configured to control the lighting load to the intensity level indicated by the slider knob 442. However, in other examples, the control device may be configured to control the lighting load to the intensity level that the lighting load was controlled to when the control device 400 was turned off, irrespective of the position of the slider knob 442.

The load control device 400 may include a rear enclosure 430 that may house the load control circuitry of the control device 400. Although illustrated with the rear enclosure 430, in some examples, such as when the control device 400 is a wireless, remote control device, the enclosure 430 may be omitted. In such examples, the control device 400 may connect to a base that is affixed to the toggle or paddle actuator of a standard light switch. When the control device 400 is a wall-mounted dimmer switch, the control device 400 may comprise a yoke 432 that may be connected to the enclosure 430 and may be configured to mount the control device 400 to an electrical wallbox.

The control device 400 may include a main PCB 460 that includes the load control circuitry used to control an amount of power delivered to an electrical load. For example, the main PCB 460 may include any combination of a control circuit (e.g., a primary control circuit), memory, a drive circuit, one or more controllably conductive devices, a zero-crossing detector, a low-voltage power supply, etc. (e.g., as shown in FIG. 25). The control circuit of the main PCB 460 may be operatively coupled to a control input of the controllably conductive device, for example, via the drive circuit. The control circuit may be used for rendering the controllably conductive device conductive or non-conductive, for example, to control the amount of power delivered to the electrical load. The control device 400 (e.g., the main PCB 460) may also include mechanical switches, such as first and second tactile switches 462, 464, that are configured to be actuated in response to actuations (e.g., tactile actuations) of the upper portion 416 and the lower portion 418 of the actuation member 410, respectively (e.g., to control turning the load on and off). In some examples, the control device 400 may be configured to control a lighting load of the lighting control system to turn the load on in response to an actuation of the first tactile switch 462, and to turn the load off in response to an actuation of the second tactile switch 464 (or vice versa).

The tactile actuation of the actuation member 410 may cause one of the first and second tactile switches 462, 464 of the main PCB 460 to be actuated. For example, when the upper portion 416 of the actuation member 410 is actuated, a first post 455 of the actuation member 410 may be moved toward the main PCB 460. The first post 455 may contact a first spacer rod 466, which may cause the first spacer rod 466 to move toward and actuate the first tactile switch 462 of the main PCB 460. Similarly, when the lower portion 418 of the actuation member 410 is actuated, a second post 457 of the actuation member 410 may be moved toward the main PCB 460. The second post 457 may contact a second spacer rod 468, which may cause the second spacer rod 468 to move toward and actuate the second tactile switch 464 of the main PCB 460.

A back cover 498 of the control device 400 may include a spring 480 that enables the actuation member 410 to pivot about the pivot axis 422 in response to a tactile actuation of the upper portion 416 and the lower portion 418. The spring 480 may be located at the center of the back of the actuation member 410. The spring 480 may define the pivot axis 422 of the actuation member 410. The spring 480 may be biased against the back of the actuation member 410 to maintain the actuation member 410 in a rest state. The spring 480 may cause the actuation member 410 to be self-centered when not being actuated. For example, the inclusion of the spring 480, which may be centered and independent from the first and second posts 455, 457, may ensure that the actuation member 410 is centered when in a rest state (e.g., which may not occur if the actuation member 410 was balanced on each post 455, 457, since they may have different tolerances and/or spring rates). Further, since the first and second posts 455, 457 do not serve as pre-load generators for the actuation member 410, the upper portion 416 and the lower portion 418 of the actuation member 410 may have a shorter tolerance stack, which may allow for the upper and lower portions 416, 418 to have a shorter actuation distance and/or a shorter minimum product depth of the control device.

The control device 400 may comprise an air-gap switch 419 adapted to be electrically coupled (e.g., substantially directly electrically coupled) in series between a power source (e.g., an AC power source) and the controllable light source. In some examples, the air-gap switch 419 may not comprise a bidirectional semiconductor switch (e.g., such as a triac or one or more field-effect transistors) for controlling the amount of power delivered to the electrical load device using a phase-control dimming technique (e.g., as in a standard dimmer switch). When the air-gap switch 419 is closed, a load voltage is developed across the lighting load and is substantially undistorted from the AC line voltage produced by the AC power source. The air-gap switch 419 may be opened to provide an actual air-gap barrier between the power source and the lighting load to facilitate servicing of the lighting load.

The control device 400 may change an operating mode of the control device 400 in response to the actuation or adjustment of a combination of the actuation member 410 and slider knob 442 and/or via an external device (e.g., a mobile application residing on a smartphone and/or tablet that is configured with short-range wireless communication (e.g., BLE), for example. For instance, the control device 400 may change the operating mode in response to the actuation of the lower portion 418 of the action member 410 and by dragging the slider knob 442 from the top of the slider slot 437 to the bottom of the slider slot 437. In another example, the control device may change the operating mode in response to the reception of a control signal from an external device (e.g., from the external device to a hub of the load control system and from the hub to the control device 400).

One example of a change in operating mode is a change between an intensity control mode and a color control mode (e.g., a color temperature control mode and/or a full color spectrum control mode). Another example of a change in operating mode is a change between a normal operating mode and a commissioning mode that is used to associate the control device 400 with an electrical load. Yet another example of a change in operating mode is a change between a normal operating mode to an advanced programming mode. As described herein, an advanced programming mode may allow configuration and/or adjustment of one or more operating characteristics of the control device and/or a lighting load of the lighting control system 100, such as a low-end trim (e.g., a minimum intensity level) and/or a high-end trim (e.g., a maximum intensity level) of the lighting load.

During an advanced programming mode as described herein, the slider knob 442 may be adjusted to adjust an operating characteristic (e.g., such as a low-end trim) of the control device. The diffuser 420 may be affixed to the actuation member 410, and as such, the diffuser 420 may be configured to move when the actuation member 410 pivots. An example of a control device having an advanced programming mode is described in greater detail in commonly-assigned U.S. Pat. No. 7,190,125, issued Mar. 13, 2007, entitled PROGRAMMABLE WALLBOX DIMMER, the entire disclosure of which is hereby incorporated by reference.

FIG. 25 is a simplified block diagram of an example control device 500 (e.g., a dimmer switch) that may be deployed as, for example, the dimmer switch 110 of the lighting control system 100, the control device 200 of FIGS. 2-7, the control device 300 of FIG. 8-18, and/or the control device 400 of FIGS. 19-24. The control device 500 may include a hot terminal H that may be adapted to be coupled to an AC power source 502. The control device 500 may include a dimmed hot terminal DH that may be adapted to be coupled to an electrical load, such as a lighting load 504. The control device 500 may include a controllably conductive device 510 coupled in series electrical connection between the AC power source 502 and the lighting load 504. The controllably conductive device 510 may control the amount of power delivered to the lighting load. The controllably conductive device 510 may include a suitable type of bidirectional semiconductor switch, such as, for example, a triac, a field-effect transistor (FET) in a rectifier bridge, two FETs in anti-series connection, or one or more insulated-gate bipolar junction transistors (IGBTs). An air-gap switch 529 may be coupled in series with the controllably conductive device 510. The air-gap switch 529 may be opened and closed in response to actuations of an air-gap actuator (e.g., the air-gap switch 219). When the air-gap switch 529 is closed, the controllably conductive device 510 is operable to conduct current to the load. When the air-gap switch 529 is open, the lighting load 504 is disconnected from the AC power source 502.

The control device 500 may include a dimmer control circuit 514. The dimmer control circuit 514 may include one or more of a processor (e.g., a microprocessor), a microcontroller, a programmable logic device (PLD), a field programmable gate array (FPGA), an application specific integrated circuit (ASIC), or any suitable controller or processing device. The dimmer control circuit 514 may be operatively coupled to a control input of the controllably conductive device 510, for example, via a gate drive circuit 512. The dimmer control circuit 514 may be used for rendering the controllably conductive device 510 conductive or non-conductive, for example, to control the amount of power delivered to the lighting load 504. The dimmer control circuit 514 may receive a control signal representative of the zero-crossing points of the AC mains line voltage of the AC power source 502 from a zero-crossing detector 516. The dimmer control circuit 514 may be operable to render the controllably conductive device 510 conductive and/or non-conductive at predetermined times relative to the zero-crossing points of the AC waveform using a phase-control dimming technique. The dimmer control circuit 514 may be configured to control the magnitude of a load current conducted through the lighting load(s) so as to control an intensity level of the lighting load 504 across a dimming range between a low-end intensity level L_{LE} and a high-end intensity level L_{HE}. For example, the dimmer control circuit 514 may be configured to control the intensity level of the lighting load 504 to a number N_{INT} (e.g., 255) of intensity levels between the low-end intensity level L_{LE} and the high-end intensity level L_{HE}.

The control device 500 may include a memory 518. The memory 518 may be communicatively coupled to the dimmer control circuit 514 for the storage and/or retrieval of, for example, operational settings, such as, lighting presets and associated preset light intensities. The memory 518 may be implemented as an external integrated circuit (IC) or as an internal circuit of the dimmer control circuit 514. The control device 500 may include a power supply 520. The power supply 520 may generate a direct-current (DC) supply voltage V_{CC} for powering the dimmer control circuit 514 and the other low-voltage circuitry of the control device 500. The power supply 520 may be coupled in parallel with the controllably conductive device 510. The power supply 520 may be operable to conduct a charging current through the lighting load 504 to generate the DC supply voltage V_{CC}.

The memory 518 may comprise computer-executable instructions or machine-readable instructions that include one or more portions of the procedures described herein. The dimmer control circuit 514 may access the instructions from memory 518 for being executed to cause the dimmer control circuit 514 to operate as described herein, or to operate one or more other devices as described herein. The memory 518 may comprise computer-executable instructions for executing configuration software. The computer-executable instructions may be executed to perform the procedure 900, 1000, 1100, 1200, 1700, and/or 1800, as described herein. Further, the memory 518 may have stored thereon one or more settings and/or control parameters associated with the control device 500.

The dimmer control circuit 514 may be responsive to local control of the lighting load, such as user inputs received from actuators 530 and/or an analog intensity adjustment actuator 532, such as a potentiometer (e.g., the potentiometer 270). The dimmer control circuit 514 may control the controllably conductive device 510 to adjust the intensity level of the lighting load 504 in response to the user inputs (e.g., tactile actuations) received via the actuators 530 and/or the analog intensity adjustment actuator 532. For example, the dimmer control circuit 514 may determine a commanded intensity level Um) based on user inputs (e.g., tactile actuations) received via the actuators 530 and/or the analog intensity adjustment actuator 532. The dimmer control circuit 514 may receive respective input signals from the actuators 530 in response to tactile actuations of the actuators 530 (e.g., in response to movements of the actuators 530). For example, the actuators 530 may be actuated in response to tactile actuations of an upper portion and/or a lower portion of the actuation member of the control device.

The analog intensity adjustment actuator 532 may be configured to be adjusted in response to a user input provided from a slider knob (e.g., the slider knob 242 of the slider actuator 240) in order to control the amount of power delivered to the lighting load. In examples where the analog intensity adjustment actuator 532 comprises a potentiometer, the potentiometer may provide a variable resistance based on the position of the slider knob. The analog intensity adjustment actuator 532 may generate a direct-current (DC) voltage representative of the desired amount of power to be delivered to the electrical load. The dimmer control circuit 514 may determine a commanded intensity level L_{CMD} based on the DC voltage. The dimmer control circuit 514 may receive the DC voltage and adjust the amount of power delivered to the lighting load 504 accordingly. The analog intensity adjustment actuator 532 may allow a user to adjust the intensity level of the attached lighting load from a low-end intensity level L_{LE} to a high-end intensity level L_{HE}. Alternatively, in some examples, the control device 500 may include a linear encoder, a combination of a wiper and a resistive trace on a PCB of the control device 200, a mechanical or magnetic encoder, etc. instead of a potentiometer.

The dimmer control circuit 514 may be configured to illuminate visible indicators 560 (e.g., a light source 338, such as LEDs, and/or an aperture that is configured to be illuminated by a light source 338) to provide feedback of a status of the lighting load 504, in response to movement of the analog intensity adjustment actuator 532, to indicate a status of the control device 500. For example, the dimmer control circuit 514 may be configured to illuminate visible indicators 560 to indicate whether the position of the analog intensity adjustment actuator 532 is in synchronization with the present intensity L_{PRES} of the lighting load. Alternatively or additionally, the dimmer control circuit 514 may be configured to illuminate visible indicators 560 to indicate the present intensity L_{PRES} of the lighting load (e.g., in response to both a local control command and/or a remote control command).

The visible indicators 560 may be configured to illuminate a visible display of the control device, such as an illumination surface of a diffuser (e.g., the diffuser 220), and/or to serve as indicators of various conditions. As one example, when the control device 500 is in an idle mode (e.g., a period in which a user is not interacting with the control device 500, for example, as determined by a timeout period), the dimmer control circuit 514 may be configured to cause the visible indicators 560 to illuminate the illumination surface at an intensity level that is lower than an intensity level used to indicate the amount of power delivered to the electrical load when in an active mode (e.g., illuminate the entire illuminated surface at the intensity level that is lower than the intensity level used during the normal mode of operation).

The control device 500 may comprise the wireless communication circuit 522, for example, to receive remote control of the lighting load 504. The wireless communication circuit 522 may include for example, a radio-frequency (RF) transceiver coupled to an antenna for transmitting and/or receiving RF signals. The wireless communication circuit 522 may also include an RF transmitter for transmitting RF signals, an RF receiver for receiving RF signals, or an infrared (IR) transmitter and/or receiver for transmitting and/or receiving IR signals. The wireless communication circuit 522 may be configured to transmit a control signal that includes the control data (e.g., a digital message) generated by the dimmer control circuit 514 to the lighting load 504.

The wireless communication circuit 532 may be configured to receive a message (e.g., digital message) from one or more remote control devices of the load control system (e.g., the retrofit remote control device 112, the wall-mounted remote control device 114, the tabletop remote control device 116, the handheld remote control device 118, a smart phone, tablet, and/or the like), and provide the message (e.g., data from the message) to the dimmer control circuit 514. The message may include a command to adjust the intensity level of the lighting load controlled by the control device 500. The message may comprise an indication of a commanded intensity level L_{CMD} of the lighting load 504. In response to the message, the dimmer control circuit 514 may control the amount of power delivered to the lighting load 504 and control the visible indicators 560 to provide feedback indicating the amount of power delivered to the lighting load 504 via an illuminated surface of the control device 500. For example, the dimmer control circuit 514 may be configured to adjust the present intensity level L_{PRES} of the lighting load 504 to an intensity level that is different from (e.g., greater than or less than) the intensity level associated with the position of the potentiometer 532 (e.g., the position of the slider knob) based on a received message from a remote device. Further, the dimmer control circuit 514 may be configured to illuminate the visible indicators 560 to illuminate a portion of the illumination surface that does not align with the position of the slider knob of the control device 500.

When providing feedback by illuminating the illumination surface of the user interface with a number of discrete segments, the control device (e.g., the dimmer switch 110, the control device 200, the control device 300, and/or the control device 400) may determine the number of segments to illuminate based on the commanded intensity level L_{CMD}. The control device may be configured to break the dimming range up into a number of buckets (e.g., subranges), where each bucket is associated with a particular segment or number of segments. For example, each bucket may be defined but one or more thresholds, and the threshold may be defined in terms of intensity level L across the dimming range (e.g., a dimming range of 0-255). For instance, the control device may determine which bucket the commanded intensity level Lon) falls within, and based on the bucket, illuminate a number of corresponding segments of the visible display. Accordingly, the control device may be configured to use multiple buckets when determining which of the light sources of the control device (e.g., the light sources 338 and/or the light sources 438) are to be illuminated such that a corresponding number of segments N_{FB} are illuminated (e.g., on the illumination surface of the user interface) based on the commanded intensity level L_{CMD} of the lighting load.

The control device may be configured with different buckets based on whether the command is received via local control or remote control (e.g., local control buckets or remote control buckets). If a single set of buckets is used irrespective of whether a command to change the intensity level is received via local control or remote control, the feedback provided by way of the visible display (e.g., the illuminated surface of the user interface, such as the one or more segments) may be misleading (e.g., confusing, distorted, and/or unexpected) to the user. For example, the single set of buckets may appropriately provide feedback (e.g., feedback that is not misleading) when the control device receives a remote-control command of the lighting load (e.g., receives a message including a command from a remote device). But, if the same set of buckets is used and the control device receives a local control command of the lighting load (e.g., via the actuation member 210 and/or the slider actuator 240 comprising the slider knob 242), the illuminated portion of the illumination surface may extend above the slider knob, which may result in feedback that confuses the user. As such, in some examples, the control device may be configured with different buckets that are used based on whether a command to change the present intensity level L_{PRES} of the lighting load is received via local control or remote control. For instance, the buckets used in response to a local control command (e.g., local control buckets) may define different thresholds than the buckets used in response to a remote control command (e.g., remote control buckets).

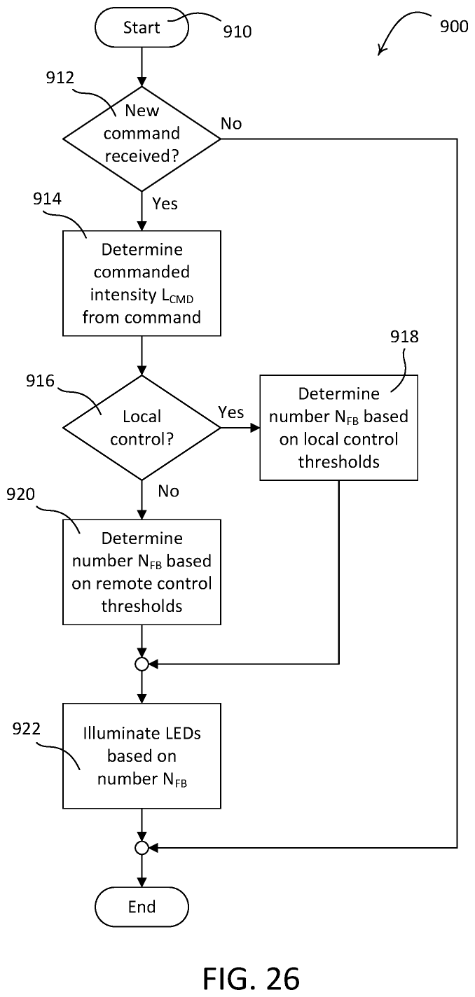

FIG. 26 is a flowchart of an example procedure 900 for determining a number N_{FB} of segments of a visible display of a control device (e.g., the dimmer switch 110, the control device 200, the control device 300, and/or the control device 400) to illuminate based on whether a command to adjust a present intensity level L_{PRES} of the lighting load 102 is received via local control or remote control. For example, the control device may receive a command via local control from a user interface of the control device or via remote control from a remote device (e.g., the retrofit remote control device 112, the wall-mounted remote control device 114, the tabletop remote control device 116, the handheld remote control device 118, a smart phone, tablet, and/or the like). The procedure 900 may be executed by a control circuit of a control device, for example, the dimmer control circuit 514 of the control device 500. The procedure 900 may, for example, ensure that the visible display (e.g., the illuminated surface of the user interface) appropriately provides feedback (e.g., feedback that is not misleading) that indicates the intensity of the lighting load irrespective of whether the amount of power is controlled via local control or remote control. For examples, and as noted herein, the control circuit may be configured with different buckets (e.g., sets of buckets) for determining the number N_{FB} of segments to illuminate that indicates the intensity of the lighting load based on whether the control circuit receives a local control command or a remote control command of the lighting load. The control circuit may execute the procedure 900 periodically and/or in response to receiving a new user command to control (e.g., change) the present intensity level L_{PRES} of the lighting load to a commanded intensity level L_{CMD}.

The procedure 900 may start at 910. At 912, the control circuit may determine whether a new command is received. The new command may be a command to adjust the present intensity level L_{PRES} of the lighting load controlled by the control device to a commanded intensity level L_{CMD}. For instance, the present intensity level L_{PRES} of the lighting load may be at an initial intensity level L_{INIT} (e.g., which may be zero if the lighting load is off), and the new command may indicate the commanded intensity level L_{CMD}. The control circuit may then control the present intensity level L_{PRES} of the lighting load to the commanded intensity level L_{CMD}. If the control circuit determines that a new command is not received at 912, the control circuit may exit the procedure 900. If the control circuit determines that a new command is received at 912, the control circuit may determine the commanded intensity level L_{CMD} indicated by the command at 914.

At 916, the control circuit may determine whether the command is received via local control of the lighting load. As described herein, the user command may be received in response to local control of the lighting load and/or remote control of the lighting load. The control circuit may receive a command via local control, for example, by detecting an actuation of an actuation member (e.g., the actuation member 210) and/or movement of an intensity adjustment actuator of the control device (e.g., the slider actuator 240 comprising a slider knob 242). The control circuit may determine the commanded intensity level L_{CMD} based on local control (e.g., based on the position of the slider knob 242). The control circuit may receive a command via remote control, for example, via a message received from a remote device. For example, as noted herein, the control device may receive message (e.g., digital messages via wireless signals from the remote device) representative of commands to control the lighting load, and generate respective control signals for executing the commands. The message may include the commands (e.g., control data) generated by the control circuit for controlling the lighting load, such as a command to adjust the present intensity level L_{PRES} of the lighting load controlled by the control device. For instance, the message may include an indication of the commanded intensity level L_{CMD}.

If the control circuit determines that the command is a local control command of the lighting load at 916, the control circuit may determine the number N_{FB} of segments of the visible display to be illuminated based on a set of local control buckets at 918. However, if the control circuit determines that the command is not a local control command of the lighting load (e.g., determines that the command is a remote control command of the lighting load) at 916, the control circuit may determine the number of segments N_{FB} of the visible display to be illuminated based on a set of remote control buckets at 920. For example, and as noted herein, the control circuit may be configured to illuminate a number of segments of a visible display of the control device to indicate the amount of power delivered to the electrical load. For example, the user interface of the control device may include an illumination surface (e.g., the illuminated surface 224 defined by the diffuser 220), and the control circuit may be configured to control one or more light sources of the control device (e.g., the light sources 338 and/or the light sources 438) to illuminate one or more of a plurality of discrete segments on the illuminated surface of the user interface. The buckets (e.g., local and remote control buckets) may indicate which of the one or more light sources of the control device are to be illuminated to illuminate the number N_{FB} of segments (e.g., on the illumination surface of the diffuser) based on the commanded intensity level L_{CMD}. The local control buckets may be different from the remote control buckets (e.g., the thresholds that define the local control buckets may be different from the thresholds that define the remote control buckets).

After determining whether to use the local control buckets or the remote control buckets to determine the number N_{FB} of segments to be illuminated, the control circuit may be configured to illuminate the visible display based on the number of segments N_{FB} at 922, before exiting the procedure 900. For example, the control circuit may be configured to control one or more light sources of the control device, such as LEDs (e.g., turn on or off the light sources 338 and/or the light sources 438), to illuminate the number of segments N_{FB} to indicate the commanded intensity level L_{CMD} of the lighting load. Although described in the context of a number N_{FB} of segments, the visible display of the control device may be, in some examples, a continuous light bar, and in such examples, the commanded intensity level L_{CMD} may indicate which light sources to illuminate to control the end point of the continuous light bar to indicate the intensity level of the lighting load, where the indicated end point may be different for local control and remote control. Finally, although described in context of controlling the intensity level of a lighting load, the control circuit may control the amount of power delivered a different electrical load, such as those described herein, and may be configured to perform the procedure 900 to ensure that the control device appropriately provides feedback (e.g., feedback that is not misleading) that indicates the amount of power delivered to the electrical load irrespective of whether the amount of power is controlled in response to a local control command or a remote control command.

As noted above, in some examples, the control device may be configured to illuminate the visible display (e.g., the illuminated portion of the illumination surface 224) in different manners and/or using different parameters based on whether the control is received via a local control command (e.g., via an actuation of the actuation member 210 and/or via movement of the slider knob 242) or the control is received via a remote control command (e.g., a message received via a remote control device). For instance, the control device may be configured with multiple buckets that are used when determining which light sources to illuminate to indicate the intensity of the lighting load. Each bucket may define one or more of an upper threshold and a lower threshold, where the thresholds define the boundaries between the multiple buckets. For example, the threshold(s) of the buckets may be defined in terms of the dimming range of the control device 200 (e.g., values across a dimming range, such as 0-255 dimming range). In some examples, the buckets may be used to indicate which light sources of the control device 200 are to be illuminated such that a corresponding number of segments N_{FB} are illuminated (e.g., to generate the illuminated portion of the illumination surface 224) based on the intensity level of the lighting load.

The control device may be configured with different buckets based on whether the command is received via local control or remote control (e.g., local control buckets or remote control buckets). If a single set of buckets is used irrespective of whether a command to change the intensity level is received via local control or remote control, the feedback provided by way of the visible display (e.g., the illuminated surface of the user interface 224, such as the one or more segments) may be misleading to the user, so the control device may be configured with different buckets based on whether the command is received via local control or remote control. For example, when the control device is providing feedback based on a first set of buckets (e.g., the remote control buckets), and the control device receives a new command that triggers the use of a different set of buckets (e.g., the local control buckets), there may be situations where the feedback travels in the opposite direction as the intensity of the lighting load, or vice versa (e.g., an additional segment is illuminated although the intensity is being decreased, or vice versa). For instance, the use of two sets of buckets may introduce the potential for inconsistencies in the feedback provided by the control device due to the difference between the buckets (e.g., where the buckets are used to determine when to turn on and/or off particular light sources of the control device). This could cause an issue where dimming down could cause the control device to illuminate a segment above the presently illuminated segment even though the intensity level of the lighting load is being decreased, or vice versa. Such issues may arise, for example, during small changes in the intensity level of the lighting load.

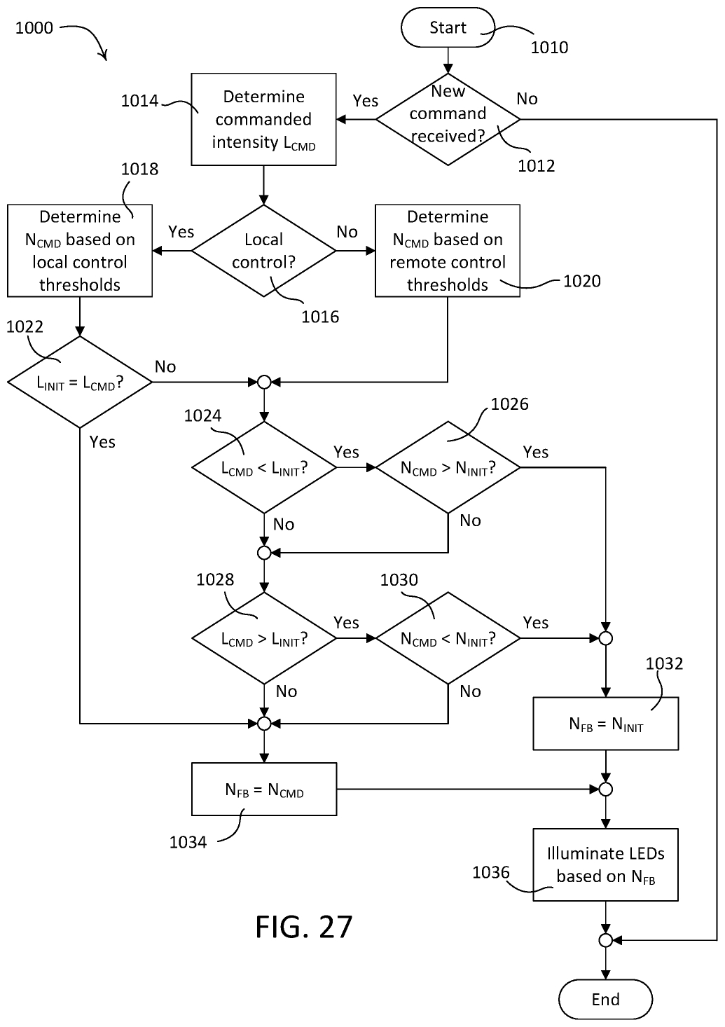

FIG. 27 is a flowchart of an example procedure 1000 for determining a number N_{FB} of segments of a visible display of a control device (e.g., the dimmer switch 110, the control device 200, the control device 300, and/or the control device 400) to illuminate based on whether a command to adjust a present intensity level L_{PRES} of an electrical load (e.g., the lighting load 102) is received via local control or remote control. For example, the control device may receive a command via local control from a user interface of the control device or from a remote device (e.g., the retrofit remote control device 112, the wall-mounted remote control device 114, the tabletop remote control device 116, the handheld remote control device 118, a smart phone, tablet, and/or the like). The procedure 1000 may be executed by a control circuit of a control device, for example, the dimmer control circuit 514 of the control device 500. The procedure 1000 may, for example, ensure that the visible display (e.g., the illuminated surface of a user interface of the control device) does not provide misleading feedback due to the difference between the local and remote control buckets (e.g., an additional segment is illuminated although the intensity is being decreased, or vice versa). The control circuit may execute the procedure 1000 periodically and/or in response to receiving a new user command to control (e.g., change) the present intensity level L_{PRES} of the lighting load from an initial intensity level L_{INIT} to a commanded intensity level L_{CMD}.

The procedure 1000 may start at 1010. The control circuit may receive a new command at 1012. It should be appreciated that 1012, 1014, and 1016 may be the same as 912, 914, and 916, respectively, of the procedure 900. As such, the description will not be duplicated. If the control circuit determines that the command is a local control of the lighting load at 1016, the control circuit may determine a commanded number N_{CMD} of segments of the visible display to be illuminated based on local control buckets at 1018. However, if the control circuit determines that the command is not a local control of the lighting load (e.g., determines that the command is a remote control of the lighting load) at 1016, the control circuit may determine the commanded number N_{CMD} of segments of the visible display to be illuminated based on remote control buckets at 1020. As described below, when performing the procedure 1000, the number N_{FB} of segments that the control circuit will illuminate may be set to the commanded number N_{CMD} of segments or an initial number N_{INIT} of segments, where the initial number N_{INIT} of segments are the number of segments that the control circuit was illuminating when the new command at 1012 was received.

At 1022, the control circuit may determine whether the initial intensity level L_{INIT} of the lighting load is equal to the commanded intensity level L_{CMD} of the lighting load. The initial intensity level L_{INIT} of the lighting load will be equal to the commanded intensity level L_{CMD} when the command received at 1012 does not indicate a change in the present intensity level L_{PRES} of the lighting load. If the initial intensity level L_{INIT} is equal to the commanded intensity level L_{CMD} at 1022, the control circuit may set the number of segments N_{FB} to be equal to a commanded number N_{CMD} of segments at 1034, and the control circuit may illuminate the visible display based on the number N_{FB} of segments at 1036, before exiting the procedure 1000

However, if the initial intensity level L_{INIT} is not equal to the commanded intensity level L_{CMD} at 1022 (e.g., the new command is a command to change the intensity of the lighting load), the control circuit may determine whether the commanded intensity level L_{CMD} is less than the initial intensity level L_{INIT} at 1024 (e.g., to determine if the control device is decreasing the present intensity level L_{PRES} of the lighting load). If the control circuit determines that the commanded intensity level L_{CMD} is less than the present intensity level L_{INIT} at 1024, the control circuit may determine whether the commanded number N_{CMD} of segments is greater than the initial number of segments N_{INIT} at 1026 (e.g., to determine if the commanded number N_{CMD} of segments will cause the feedback of the present intensity level L_{PRES} to move in the opposite direction as expected due to the actual change in the present intensity level L_{PRES} of the lighting load). As noted herein, there may be situations where, although the new command is a command to decrease the present intensity level L_{PRES} of the lighting load (e.g., yes at 1024), due to a switch between the sets of the control buckets (e.g., from remote control buckets to local control buckets, and vice versa), the commanded number N_{CMD} of segments may be greater than the initial number N_{INIT} of segments. If the commanded number N_{CMD} of segments is greater than the initial number N_{INIT} of segments at 1026, the control circuit may set the number N_{FB} of segments to be equal to the initial number N_{INIT} of segments at 1032 (e.g., as opposed to the commanded number of segments N_{CMD}), for example, to maintain the number N_{FB} of segments constant and to prevent a situation where the illuminated feedback may travel in the opposite direction as the present intensity level L_{PRES} of the lighting load is being adjusted (e.g., an additional segment being illuminated although the intensity is being decreased). If the control circuit determines that the commanded number N_{CMD} of segments is not greater than the initial number N_{INIT} of segments at 1026, the control circuit may determine that the commanded intensity level L_{CMD} is not greater than the present intensity level L_{PRES} at 1028 (e.g., since the commanded intensity level L_{CMD} was less than the initial intensity level L_{INIT} at 1024). The control circuit may then set the number N_{FB} of segments to be equal to the commanded number N_{CMD} of segments at 1034, where the commanded number N_{CMD} of segments was determined at 1018 or 1020.

If the control circuit determines that the commanded intensity level L_{CMD} is not less than the present intensity level L_{PRES} at 1024, the control circuit may determine whether the commanded intensity level L_{CMD} is greater than the present intensity level L_{PRES} at 1028 (e.g., to determine if the control device is increasing the present intensity level L_{PRES} of the lighting load). If the control circuit determines that the commanded intensity level L_{CMD} is greater than the present intensity level L_{INIT} at 1028, the control circuit may determine whether the commanded number N_{CMD} of segments is less than the initial number N_{INIT} of segments at 1030 (e.g., to determine if the commanded number N_{CMD} of segments will cause the feedback of the present intensity level L_{PRES} to move in the opposite direction as expected due to the actual change in the present intensity level L_{PRES} of the lighting load). If the control circuit determines that the commanded number N_{CMD} of segments is not less than the initial number N_{INIT} of segments at 1030, the control circuit may set the number N_{FB} of segments to be equal to the commanded number N_{CMD} of segments at 1034, where the commanded number Novo of segments was determined at 1018 or 1020. If the control circuit determines that the commanded number N_{CMD} of segments is less than the initial number N_{INIT} of segments at 1030, the control circuit may set the number N_{FB} of segments to be equal to the initial number N_{INIT} of segments at 1032 (e.g., as opposed to the commanded number N_{CMD} of segments), for example, to maintain the number N_{FB} of segments constant and to prevent a situation where the illuminated feedback may travel in the opposite direction as the present intensity level L_{PRES} of the lighting load is being adjusted (e.g., a lesser number of segments being illuminated even though the intensity is being increased).

After the control circuit determines whether to set the number N_{FB} of segments to be equal to the initial number N_{INIT} of segments at 1032 or the commanded number Novo of segments at 1034, the control circuit may be configured to illuminate the visible display based on the number N_{FB} of segments at 1036, before exiting the procedure 1000. For example, the control circuit may be configured to control one or more light sources of the control device, such as LEDs (e.g., the light sources 338 and/or the light sources 438), to illuminate the number N_{FB} of segments to indicate the commanded intensity level L_{CMD} or the initial intensity level L_{INIT} of the lighting load. Although described in the context of a number N_{FB} of segments, the visible display of the control device may be, in some examples, a continuous light bar, and in such examples, the commanded intensity level L_{CMD} may indicate which light sources to illuminate to control the end point of the continuous light bar to indicate the intensity level of the lighting load, where the indicated end point may be different for local control and remote control. Finally, although described in context of controlling the intensity level of a lighting load, the control circuit may control the amount of power delivered a different electrical load, such as those described herein, and may be configured to perform the procedure 900 to ensure that the control device appropriately provides feedback (e.g., feedback that is not misleading) that indicates the amount of power delivered to the electrical load irrespective of whether the amount of power is controlled via a local control or a remote control.

A control device (e.g., the dimmer switch 110, the control device 200, the control device 300, and/or the control device 400) may be configured, in some examples, to adjust the one or more light sources of the control device (e.g., the light sources 338 and/or the light sources 438) to provide feedback by way of the visible display (e.g., the illuminated surface of the diffuser, such as the one or more segments) in response to a command to change the intensity level of the lighting load (e.g., adjust using an adjustment rate and/or adjustment period). For example, the control device may be configured to change the number N_{FB} of illuminated segments with respect to time (e.g., fade) to adjust the illuminated portion between its original position (e.g., based on the initial intensity level L_{INIT}) and the newly commanded intensity level L_{CMD} (e.g., over an adjustment period and/or at an adjustment rate) in response to a remote control command. For instance, the control device may change the number N_{FB} of illuminated segments with respect to time (e.g., fade) to adjust the illuminated portion, which results in the segments being turned on one-by-one in sequence over time or turned off one-by-one in sequence over time. The control device may use an adjustment period and/or an adjustment rate when changing the illuminated portion based on whether the command is received via local control or remote control and/or the magnitude of the change in the present intensity level L_{PRES}. For example, the control device may be configured to use an adjustment period and/or an adjustment rate when the command is received via remote control (e.g., from a remote control device), but not when the command is received via local control (e.g., via an intensity adjustment actuator, such as a slider control). In these examples, the control device may be configured as such to ensure that the user receives substantially instantaneous feedback while they are actuating (e.g., moving) the intensity adjustment actuator on the control device, and may also be configured to adjust the illuminated portion over time when the command is received from a remote device.

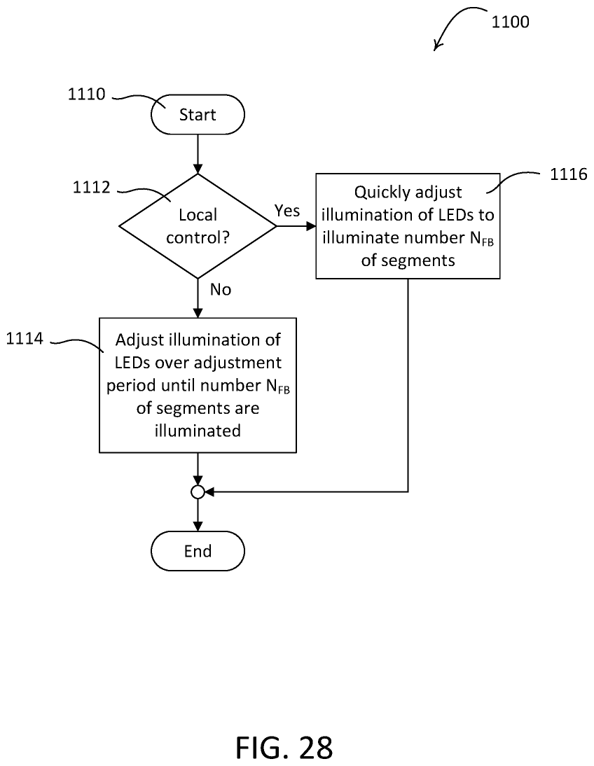

FIG. 28 is a flowchart of an example procedure 1100 for adjusting on and/or off one or more light sources (e.g., one or more LEDs) of a control device (e.g., the dimmer switch 110, the control device 200, the control device 300, and/or the control device 400) on and/or off based on whether a command to adjust a present intensity level L_{PRES} of a lighting load is received from a user interface of the control device or from a remote device. The procedure 1100 may be executed by a control circuit of a control device, for example, the dimmer control circuit 514 of the control device 500. The procedure 1100 may be executed, for example, to change the number N_{FB} of illuminated segments with respect to time (e.g., fade) to indicate the change in the present intensity level L_{PRES} of a lighting load when the command to change the present intensity level L_{PRES} is received via remote control (e.g., from a remote device), and to substantially instantaneously change the illuminated portion of the visible display to indicate the change in the present intensity level L_{PRES} of the lighting load when the command is received via local control (e.g., via an intensity adjustment actuator of the control device, such as a slider control). The control circuit may execute the procedure 1100 in response to receiving a new user command to control (e.g., change) the intensity level of the lighting load.

The procedure 1100 may start at 1110. At 1112, the control circuit may determine whether a new command is received via local control of the lighting load. As described herein, the command may be received in response to local control of the lighting load and/or remote control of the lighting load. The control circuit may receive a command via local control, for example, by detecting an actuation of an actuation member (e.g., the actuation member 210) and/or movement of an intensity adjustment actuator of the control device (e.g., the slider actuator 240 comprising a slider knob 242). The control circuit may determine a commanded intensity level L_{CMD} based on local control (e.g., based on the position of the slider knob 242). The control circuit may receive a command via remote control, for example, via a message received from a remote device. For example, as noted herein, the control device may receive messages (e.g., digital messages via wireless signals from the remote device) representative of commands to control the lighting load, and generate respective control signals for executing the commands. The message may include the commands (e.g., control data) generated by the control circuit for controlling the lighting load, such as a command to adjust the present intensity level L_{PRES} of the lighting load controlled by the control device. The message may include an indication of the commanded intensity level L_{CMD}.

If the control circuit determines that the command was not received via local control at 1112 (e.g., the command was received from a remote control device), the control circuit may adjust the illumination of the visible display over time at 1114 by adjusting over time the number of segments that are illuminated until the number N_{FB} of segments are illuminated (e.g., where the number N_{FB} of segments may be determined based on the commanded intensity level L_{CMD} and/or determined using the procedure 900 or the procedure 1000). For example, at 1114, the control circuit may adjust the illumination of the visible display over an adjustment period (e.g., approximately 500 ms) at an adjustment rate until the number N_{FB} of segments are illuminated. For example, the control device may be configured to align the illuminated portion of the visible display (e.g., from the initial number N_{INIT} of segments to the commanded number N_{CMD} of segments N_{CMD}) by adjusting the illuminated portion between its original segment (e.g., based on the initial intensity level L_{INIT}) and the segment associated with the commanded number N_{CMD} of segments N_{CMD} (e.g., commanded intensity level L_{CMD}) over the adjustment period and/or at the adjustment rate.

However, if the control circuit determines that the command was received via a local control at 1112, the control circuit may adjust (e.g., quickly adjust) the illumination of the visible display based on the number of segments N_{FB} (e.g., which may be determined based on the commanded intensity level L_{CMD} and/or determined using the procedure 900 or the procedure 1000) at 1116. For example, at 1116, the control circuit may adjust the illumination of the visible display substantially instantaneously (e.g., without using an adjustment period and/or with a significantly smaller adjustment period than used during 1114), for example, so that the end of the illuminated portion remains behind the slider knob of the control device. For instance, the control device may be configured to align the illuminated portion of the visible display (e.g., from the present number of segments N_{PRES} to the number of segments N_{CMD}) by substantially instantaneously changing the illuminated portion from its original position (e.g., based on the present intensity level L_{PRES}) and the new commanded intensity level L_{CMD} (e.g., without using the adjustment period and/or with a significantly smaller adjustment period than used during 1114). Accordingly, using the procedure 1100, the control device may be configured to adjust the illumination of the visible display over an adjustment period and/or at an adjustment rate when the command is received from a remote control device, but not when the command is received via a local control (e.g., via an intensity adjustment actuator, such as a slider control). Finally, it should be appreciated that, in some examples, the control device may be configured to determine the number of segments N_{FB} at 1114 and/or 1116, in response to receiving a new command, using the procedure 900 or the procedure 1000.

Further, in some examples, the control device may be configured to adjust the illuminated portion of a visible display (e.g., the illumination surface 424 of the diffuser 420) between its original position (e.g., based on the present intensity level L_{PRES}) and the newly commanded intensity level L_{CMD} substantially instantaneously when the commanded intensity level L_{CMD} is received via local control when (e.g., only when) the adjustment of the intensity level is less than a threshold amount (e.g., the magnitude of the change between the initial intensity level L_{INIT} and the commanded intensity level L_{CMD} is less than the threshold). Otherwise (e.g., if the adjust of the intensity level is greater than the threshold amount and/or if the command is received via remote control), the control device may be configured to adjust the illuminated portion between its original position (e.g., based on the present intensity level L_{PRES}) and the newly commanded intensity level Um) (e.g., over an adjustment period and/or at an adjustment rate).

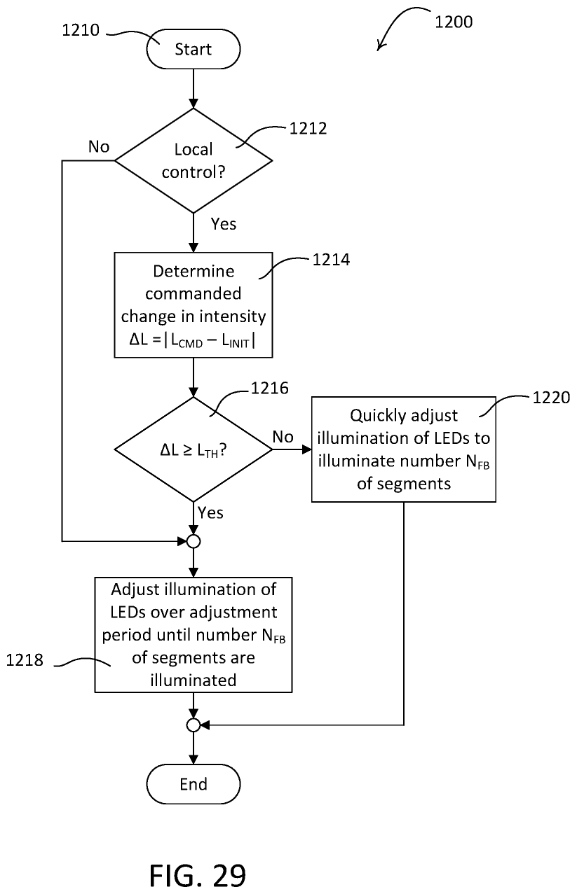

FIG. 29 is a flowchart of an example procedure 1200 for adjust on and/or off, with respect to time, one or more light sources (e.g., one or more LEDs) of a control device (e.g., the dimmer switch 110, the control device 200, the control device 300, and/or the control device 400) based on whether a command to adjust the present intensity level L_{PRES} of a lighting load is received from a user interface of the control device or from a remote device, and further based on the size of the change to the intensity. The procedure 1200 may be executed by a control circuit of a control device, for example, the dimmer control circuit 514 of the control device 500. The procedure 1200 may be executed, for example, to adjust the illuminated portion of the visible display to indicate the change in the intensity of a lighting load when the command to change the intensity of the lighting load is received from a remote device or when received via local control and the change is greater than a threshold intensity change, and also to substantially instantaneously change the illuminated portion of the visible display to indicate the change in the intensity of the lighting load when the command is received via local control and the change is less than the threshold intensity change. The control circuit may execute the procedure 1200 in response to receiving a new user command to control (e.g., change) the present intensity level L_{PRES} of the lighting load.

The procedure 1200 may start at 1210. At 1212, the control circuit may determine whether a new command is received via a local control of the lighting load. As described herein, the command may be received in response to local control of the lighting load and/or remote control of the lighting load. The local control of the lighting load may, for example, be received via an actuation of an actuation member (e.g., the actuation member 210) and/or via movement of an intensity adjustment actuator of the control device (e.g., the slider actuator 240 comprising a slider knob 242). The control circuit may determine a commanded intensity level L_{CMD} based on the local control (e.g., based on the position of the slider knob 242). The remote control of the lighting load may be received via a message received from a remote device. For example, as noted herein, the control device may receive wireless signals (e.g., from the remote device) representative of commands to control the lighting load, and generate respective control signals for executing the commands. The message may include the control data (e.g., commands) generated by the control circuit for controlling the lighting load, such as a command to adjust the present intensity level L_{PRES} of the lighting load controlled by the control device. The message may include an indication of the commanded intensity level L_{CMD}.

At 1214, the control circuit may determine a magnitude of a change ΔL between the initial intensity level L_{INIT} and the commanded intensity level L_{CMD}. For example, the control circuit may determine the magnitude of the change ΔL between the initial intensity level L_{INIT} and the commanded intensity level L_{CMD} by calculating the absolute value of the difference between the commanded intensity level L_{CMD} and the initial intensity level L_{INIT}. For instance, in some examples, the control circuit may store a plurality of values (e.g., 256 values), where each value is associated with a different intensity level between the low-end intensity level L_{LE} and the high-end intensity level L_{HE}. In such examples, the absolute change ΔL may be a numerical value.

At 1216, the control circuit may determine whether the magnitude of the change ΔL is greater than or equal to a threshold L_{TH}. If the control circuit determine that the absolute change ΔL is greater than or equal to the threshold L_{TH} at 1216, the control circuit may change the number N_{FB} of illuminated segments of the illuminated portion of the visible display (e.g., based on the number of segments N_{FB}) over an adjustment period to indicate the change in the intensity of a lighting load at 1218. The number of segments N_{FB} may be determined, for example, based on the commanded intensity level L_{CMD} and/or the procedure 900 or the procedure 1000. For example, at 1218, the control circuit may adjust the illuminated portion of the visible display over an adjustment period (e.g., approximately 500 ms) and/or at an adjustment rate until the number N_{FB} of segments are illuminated. For example, the control device may be configured to align the illuminated portion of the visible display (e.g., from the present number of segments Nis to the number of segments N_{CMD}) by adjust the illuminated portion between its original position (e.g., based on the initial intensity level L_{INIT}) and the commanded position (e.g., based on the commanded intensity level L_{CMD}) over the adjustment period and/or at the adjustment rate at 1218.

However, if the control circuit determines the absolute change ΔL is less than the threshold L_{TH} at 1216, the control circuit may adjust (e.g., quickly adjust) the illuminated portion of the visible display based on the number of segments N_{FB} 1220. The number of segments N_{FB} may be determined, for example, based on the commanded intensity level L_{CMD} and/or the procedure 900 or the procedure 1000. For example, at 1220, the control circuit may adjust the illumination of the visible display substantially instantaneously (e.g., without using an adjustment period and/or with a significantly smaller adjustment period than used during 1218), for example, so that the end of the illuminated portion remains behind the slider knob of the control device. Accordingly, using the procedure 1200, the control device may be configured to adjust the illuminated portion of its visible display between its original position (e.g., based on the present intensity level L_{PRES}) and the commanded position (e.g., based on the commanded intensity level L_{CMD}) substantially instantaneously when the commanded intensity level L_{CMD} is received via a local control and the absolute difference of the intensity adjustment is less than a threshold amount, and configured to adjust the illuminated portion between its original position and the commanded position over an adjustment period when the absolute difference is greater than the threshold and/or when the command is received from a remote control device. Finally, in some examples, the control device may be configured to determine the number of segments N_{FB} at 1114 and/or 1116, in response to receiving a new command, using the procedure 900 or the procedure 1000.

FIG. 30A-30C are front views of an example control device 1300 illustrating a visible display that is comprised of a plurality of visible indicators. The control device 1300 may be an example of the control device 200, the control device 300, the control device 400, and/or the control device 500. Since the control device 1300 may be an example (e.g., alternative example) of the control device 200, the control device 300, the control device 400, and/or the control device 500, the description of every component of the control device 1300 will not be repeated. For example, similar to the control device 200, the control device 1300 may comprise an actuation portion 1310 that is configured to be received in an opening of a bezel 1312 (e.g., a base portion) of the control device 1300. The actuation member 1310 may comprise a front surface 1314 including an upper portion 1316 and a lower portion 1318. Further, and for example, the control device 1300 may comprise the internal components described with reference to the control device 300.

The control device 1300 may include an analog intensity adjustment actuator configured to provide a local control command of a present intensity level L_{PRES} of the lighting load, such as a slider actuator 1340 comprising a slider knob 1342. Although described in context of controlling the present intensity level L_{PRES} of a lighting load, the control device 1300 may be configured to control other characteristics of an electrical load, such as the amount of power delivered to an electrical load, the speed of a ceiling fan, etc. The slider knob 1342 may be configured to move in the vertical direction along a slider slot 1337 of the control device 1300. The slider slot 1337 may be located in the bezel 1312 of the control device. The position of the slider knob 1342 may indicate the present intensity level L_{PRES} of the lighting load via local control. For example, the control device 1300 may control the magnitude of a load current conducted through the lighting load (e.g., and thus the present intensity level L_{PRES} of the lighting load) in response to movement of the slider knob 1342. Accordingly, the control device 1300 may be configured to adjust the present intensity level L_{PRES} of the lighting load from an initial intensity level L_{INIT} to a commanded intensity level L_{CMD} in response to actuation of the intensity adjustment actuator (e.g., movement of the slider knob 1342 along the slider slot 1337).

The control device 1300 may comprise a wireless communication circuit, such as those described herein. The wireless communication circuit may be configured to transmit messages (e.g., digital messages) via one or more wireless signals (e.g., RF signals). The message may include the control data (e.g., commands) generated by the control circuit for controlling the electrical load. For example, the message may include a command (e.g., a remote control command) to adjust the present intensity level L_{PRES} of the lighting load controlled by the control device 1300 from an initial intensity level L_{INIT} of the lighting load to a commanded intensity level L_{CMD} indicated by the message (e.g., the message may include the commanded intensity level L_{CMD}). The wireless communication circuit may enable the control device 1300 to receive commands for remote control of the lighting load (e.g., in additional to the local control provided via the actuation member 1310 and the intensity adjustment actuator).

The control device 1300 may include a visible display. As opposed to the illumination surface 224 of the control device 200, the control device 1300 may include a plurality of visible indicators 1320a-1320g that act as the visible display. The control device 1300 may be configured to illuminate the visible indicators 1320a-1320g to provide feedback, such as the present intensity level L_{PRES} of the lighting load. For example, the visible indicators 1320a-1320g may provide feedback indicating the present intensity level L_{PRES} of the lighting load. In some examples, the control device 1300 may be configured to illuminate the visible indicators 1320a-1320g using one or more light sources of the control device 1300, such LED light sources. For example, the control device 1300 may be configured to control which light sources of the plurality of light sources are illuminated (e.g., based on the intensity of lighting load) such that a corresponding number of visible indicators N_{FB} are illuminated (e.g., half the visible indicators are illuminated when the lighting load is controlled to 50% intensity level). The control device 1300 may include one or more light pipes, wherein each light pipe is configured to guide light from one or more light sources to a determined number of visible indicators 1320a-1320g to indicate the present intensity level L_{PRES} of the lighting load. Although the visible indicators 1320a-1320g are illustrated as a linear array of circular visible indicators, in other examples the visible indicators 1320a-1320g may be segments (e.g., such as the segments 226a-226i) that are illuminated through the bezel.

Further, the visible indicators 1320a-1320g may provide multiple types of feedback, such as any combination of an indication of the present intensity level L_{PRES} of the lighting load, an indication of whether the slider knob 1342 is in synchronization with (e.g., aligned with) the present intensity level L_{PRES} of the lighting load, an indication of one or more characteristics of the electrical load (e.g., a color and/or color temperature of light emitted from a lighting load), and/or the like.

Each visible indicator 1320a-1320g may be an opening in the bezel 1312. The visible indicator 1320a-1320g may be in a linear arrangement (e.g., as shown). In the illustrated example, the visible indicators 1320a-1320g may be located between the actuation member 1310 and the slider slot 1337. However, in other examples, the slider slot 1337 may be located between the visible indicators 1320a-1320g and the actuation member 1310, or the actuation member 1310 may be located between the visible indicators 1320a-1320g and the slider slot 1337. Finally, in some examples, the visible indicators 1320a-1320g may be located (e.g., spaced horizontally) above the upper portion 1316 of the actuation member 1310 or below the lower portion 1318 of the actuation member 1310.

The control device 1300 may be configured to illuminate the visible indicator 1320a-1320g in different manners and/or using different parameters based on whether the control is received via a local control command (e.g., via an actuation of the actuation member 1310 and/or via movement of the slider knob 1342) or the control is received via a remote control command (e.g., a message received via a remote control device). For example, in response to a local control command, such as movement of the slider knob 1342, the control device 1300 may be configured to illuminate all or a subset of the visible indicators 1320a-1320g based on the position of the slider knob 1342 along the slider slot 1337 (e.g., based on the position of the center or the top edge of the slider knob 1342). Stated another way, in response to a local control command, the control device 1300 may be configured to indicate that the present intensity level L_{PRES} of the lighting load is in synchronization with the position of the slider knob 1342 along the slider slot 1337 by illuminating all or a subset of the visible indicators 1320a-1320g such that the illuminated visible indicators 1320a-1320g are aligned with the position of the slider knob 1342 along the slider slot 1337.

FIG. 30A illustrates an example of the control device 1300 illuminating the visible indicators 1320a-1320e to indicate the present intensity level L_{PRES} of the lighting load may be in synchronization with (e.g., aligned with) the position of the slider knob 1324 along the slider slot 1337. For example, the present intensity level L_{PRES} of the lighting load may be in synchronization with (e.g., aligned with) the position of the slider knob 1324 along the slider slot 1337 based on local control (e.g., receiving a local control command). In FIG. 30A, the slider knob 1342 (e.g., the center of the slider knob 1342) is located adjacent to the visible indicator 1320e. Accordingly, the control device 1300 may illuminate the visible indicators 1320a-1320e while maintaining the visible indicators 1320f-1320g unilluminated (e.g., off) to indicate the present intensity level L_{PRES} of the lighting load. The control device 1300 may be configured to turn on the visible indicators 1320a-1320e that are adjacent to or located below the position of the slider knob 1342 (e.g., the center or top of the slider knob 1342), and turn off the visible indicators 1320f-1320g that are located above the position of the slider knob 1342. Therefore, the illuminated visible indicators may remain at or below the slider knob 1342 (e.g., the center or top edge of the slider knob 1342) and may not extend above the slider knob 1342 (e.g., the top edge of the slider knob 1342). For instance, when the slider knob 1342 is moved, the control device 1300 may adjust the illumination of the visible indicators 1320f-1320g (e.g., the number of illuminated visible indicators 1320f-1320g) to indicate the present intensity level L_{PRES} of the lighting load and to remain at or below the slider knob 1342.

FIGS. 30B and 30C illustrate examples of the control device 1300 illuminating the visible indicator 1320a-1320f to indicate the present intensity level L_{PRES} of the lighting load may not in synchronization with (e.g., not aligned with) the position of the slider knob 1324 along the slider slot 1337 and the present intensity level L_{PRES} is greater than an intensity level associated with the position of the slider knob. For example, the present intensity level L_{PRES} of the lighting load may not be in synchronization with (e.g., not aligned with) the position of the slider knob 1324 along the slider slot 1337 based on a remote control command (e.g., receive via a message). As described herein, the control device 1300 may be configured to adjust the present intensity level L_{PRES} of the lighting load based on messages received from one or more remote devices (e.g., the retrofit remote control device 112, the wall-mounted remote control device 114, the tabletop remote control device 116, the handheld remote control device 118, a smart phone, tablet, and/or the like). The message may include a command to adjust the present intensity level L_{PRES} of the lighting load controlled by the control device 1300 to a commanded intensity level L_{CMD}. In such instances, the control device 1300 may adjust the present intensity level L_{PRES} of the lighting load to an intensity level that does not align with the position of the slider knob 1342, and the control device 1300 may be configured to illuminate all or a subset of the visible indicators 1320a-1320g based on the commanded intensity level L_{CMD} (e.g., such that the illuminated visible indicators 1320a-1320g do not align with the position of the slider knob 1342 in the slider slot 1337).

In FIG. 30B, the control device 1300 may be configured to adjust the present intensity level L_{PRES} of the lighting load to an intensity level that is greater than the intensity level associated with the position of the slider knob 1342 based on a received message from a remote device, and the control device 1300 may be configured to illuminate the visible indicators 1320a-1320f (e.g., and turn the visible indicator 1320g off) to indicate the present intensity level L_{PRES} of the lighting load. In FIG. 30C, the control device 1300 may be configured to adjust the present intensity level L_{PRES} of the lighting load to an intensity level that is below the position of the slider knob 1342 based on a received message from a remote device, and the control device 1300 may be configured to illuminate the visible indicators 1320a-1320c (e.g., and turn the visible indicators 1320d-1320g off) to indicate the present intensity level L_{PRES} of the lighting load. In FIG. 30B, the present intensity level L_{PRES} of the lighting load is above the intensity level associated with the position of the slider knob 1342, while in FIG. 30C, the present intensity level L_{PRES} of the lighting load is below the intensity level associated with the position of the slider knob 1342.

Since, for example, the message may command the control device 1300 to control the present intensity level L_{PRES} of the lighting load to an intensity level that is not synchronized with (e.g., aligned with) the position of the slider knob 1342, the control device 1300 may be configured to control which of the visible indicators 1320a-1320g are illuminated such that the illuminated visible indicators 1320a-1320g do not align with (e.g., track) the position (e.g., location) of the slider knob 1342, but does indicate the present intensity level L_{PRES} of the lighting load. That is, when the commanded intensity level L_{CMD} provided by a remote message does not correspond with the position of the slider knob 1342, the control device 1300 may be configured to illuminate the all or a subset of the visible indicators 1320a-1320g to indicate the present intensity level L_{PRES} of the lighting load in accordance with the received message and such that the illuminated visible indicators 1320a-1320g are not aligned with the position of the slider knob 1342 along the slider slot 1337. As such, the illuminated feedback provided via the visible indicators 1320a-1320g is decoupled from the position of the slider knob 1342 when the control device 1300 is operating in response to a received message. Further, the control device 1300 may be configured to indicate that the present intensity level L_{PRES} of the lighting load is out of synchronization with the position of the slider knob 1342 along the slider slot 1337 by illuminating visible indicators 1320a-1320g such that the illuminated visible indicators 1320a-1320g are not aligned with the position of the slider knob 1342 along the slider slot 1337.

The control device 1300 may be configured to realign the illuminated visible indicators 1320a-1320g with the position of the slider knob 1342 if the position of the slider knob 1342 moves (e.g., when the illuminated portion was unsynchronized with the position of the slider knob 1342, such as after controlling the lighting load and the illuminated visible indicators 1320a-1320g in response to a message received from a remote device). For example, if, based on a received message from a remote device, the control device 1300 may control the present intensity level L_{PRES} of the lighting load to a commanded intensity level L_{CMD} that is different than the intensity level associated with the position of the slider knob 1342 (e.g., as shown in FIGS. 30B and 30C) and the position of the slider knob 1342 of the control device 1300 is later adjusted, the control device 1300 may realign the illuminated visible indicators 1320a-1320g with the position of the slider knob 1342 in the slider slot 1337 (e.g., as illustrated in FIG. 30A) and control the present intensity level L_{PRES} of the lighting load accordingly.

As such, the control device 1300 may be configured to align the illuminated visible indicators 1320a-1320g with the position of the slider knob 1342 when the slider knob 1342 is used to control the present intensity level L_{PRES} of the lighting load, while also being configured to control the lighting load in response to messages received from remote devices and provide feedback accordingly, even if the commanded intensity level L_{CMD} indicated by the message does not align with the position of the slider knob 1342. Therefore, the control device 1300 may always provide feedback regarding the present intensity level L_{PRES} of the lighting load (e.g., using the visible indicators 1320a-1320g) regardless of the position of the slider knob 1342.

Finally, it should be appreciated that the control device 1300 may include a control circuit (e.g., the dimmer control circuit 514) that may be configured to perform one or more of the procedures described herein, such as the procedure 900, 1000, and/or 1100. Further, while a linear array of circular visible indicators are shown in FIG. 30A-C, the visible indicators 1320a-1320g could be other shapes. Also, in some example, the visible indicators 1320a-1320g might not be provided through openings. For example, the segments 226a-226i shown in FIG. 5D could be provided on the front surface 1314 of the bezel 1312 adjacent to the slider slot 1337 (e.g., in place of the visible indicators 1302a-1320g shown in FIGS. 30A-30C).

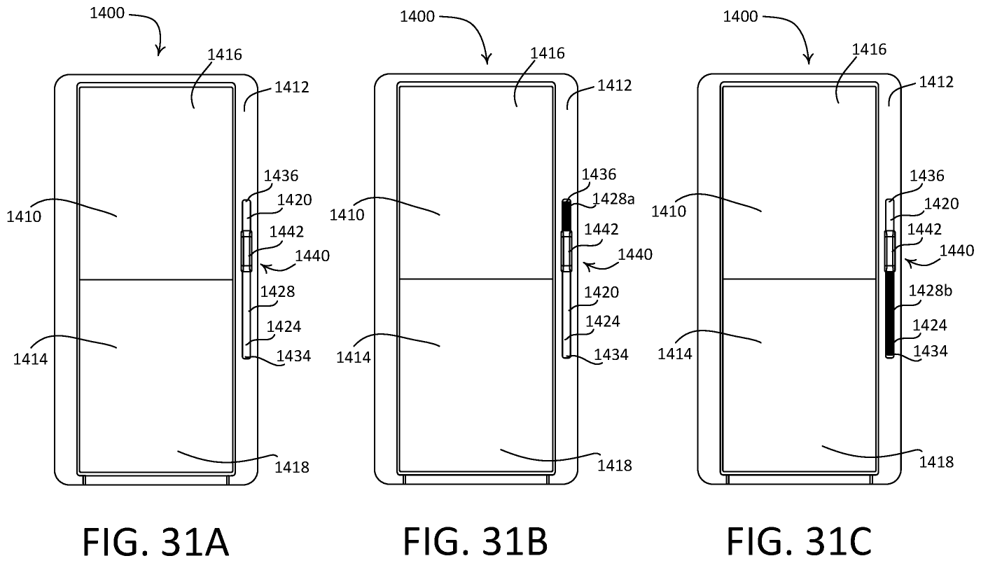

FIG. 31A-31C are front views of an example control device 1400 illustrating an illumination surface of a user interface that is configured to be illuminated (e.g., in a section, such as a continuous bar). The control device 1400 may be an example of the control device 200, the control device 300, the control device 400, and/or the control device 500. Since the control device 1400 may be an example (e.g., alternative example) of the control device 200, the control device 300, the control device 400, and/or the control device 500, the description of every component of the control device 1400 will not be repeated. For example, similar to the control device 200, the control device 1400 may comprise an actuation portion 1410 that is configured to be received in an opening of a bezel 1412 (e.g., a base portion) of the control device 1400. The actuation member 1410 may comprise a front surface 1414 including an upper portion 1416 and a lower portion 1418. Further, and for example, the control device 1400 may comprise the internal components described with reference to the control device 300.

The control device 1400 may include an analog intensity adjustment actuator configured to provide a local control command of a present intensity level L_{PRES} of the lighting load, such as a slider actuator 1440 comprising a slider knob 1442. Although described in context of controlling the present intensity level L_{PRES} of a lighting load, the control device 1400 may be configured to control other characteristics of an electrical load, such as the amount of power delivered to an electrical load, the speed of a ceiling fan, etc. The slider knob 1442 may be configured to move in the vertical direction along a slider slot 1437 of the control device 1400. The slider slot 1437 may be located in the bezel 1412 of the control device. The position of the slider knob 1442 may indicate present intensity level L_{PRES} of the lighting load via local control. For example, the control device 1400 may control the magnitude of a load current conducted through the lighting load (e.g., and thus the present intensity level L_{PRES} of the lighting load) in response to movement of the slider knob 1442. Accordingly, the control device 1400 may be configured to adjust the present intensity level L_{PRES} of the lighting load from an initial intensity level L_{INIT} to a commanded intensity level L_{CMD} in response to actuation of the intensity adjustment actuator (e.g., movement of the slider knob 1442 along the slider slot 1437).

The control device 1400 may comprise a wireless communication circuit, such as those described herein. The wireless communication circuit may be configured to transmit messages (e.g., digital messages) via one or more wireless signals (e.g., RF signals). The message may include the control data (e.g., commands) generated by the control circuit for controlling the electrical load. For example, the message may include a command (e.g., a remote control command) to adjust the present intensity level L_{PRES} of the lighting load controlled by the control device 1400 from an initial intensity level L_{INIT} of the lighting load to a commanded intensity level L_{CMD} indicated by the message (e.g., the message may include the commanded intensity level L_{CMD}). The wireless communication circuit may enable the control device 1400 to receive commands for remote control of the lighting load (e.g., in additional to the local control provided via the actuation member 1410 and the intensity adjustment actuator).

The control device 1400 may include a visible display, such as an illumination surface 1424. For example, a front surface of a diffuser 1420 may define the illumination surface 1424 of the user interface of the control device 1400. The illumination surface 1424 of the user interface 1402 may be illuminated to provide feedback, such as an indication of the present intensity level L_{PRES} of the lighting load (e.g., relative to the position of the slider knob 1442 in the slider slot 1437). The illumination surface 1424 may be illuminated using one or more light sources of the control device, such as LED light sources. The slider slot 1437 (e.g., the combination of the slider knob 1442 and the illumination surface 1424) may provide multiple types of feedback, such as any combination of an indication of the amount of an indication of an present intensity level L_{PRES} of the lighting load, an indication of whether the slider knob 1442 is in synchronization with (e.g., aligned with) the present intensity level L_{PRES} of the lighting load, an indication of one or more characteristics of the electrical load (e.g., a color and/or color temperature of light emitted from a lighting load), and/or the like. For example, the illumination surface 1424 may provide feedback indicating the present intensity level L_{PRES} of the lighting load (e.g., relative to the position of the slider knob 1442 in the slider slot 1437).

FIG. 31A is a front view of the control device 1400 when the present intensity level L_{PRES} of the lighting load is in synchronization with (e.g., aligned with) the position of the slider knob 1424 along the slider slot 1437. For example, the present intensity level L_{PRES} of the lighting load may be in synchronization with (e.g., aligned with) the position of the slider knob 1424 along the slider slot 1437 as a result of receiving a local control command, such as via movement of the slider knob 1442. For example, the control device 1400 may maintain the illumination surface 1424 unilluminated (e.g., off) when the control is received via a local control command, such as via movement of the slider knob 1442. For example, if the user moves the slider knob 1442, the control device 1400 may adjust the present intensity level L_{PRES} of the lighting load based on the position of the slider knob 1442 in the slider slot 1437, but the control device may maintain the illumination surface 1424 unilluminated (e.g., off). In such instances, the slider knob 1442 may provide the feedback indicating the present intensity level L_{PRES} of the lighting load.

FIG. 31B is a is a front view of the control device 1400 when the present intensity level L_{PRES} of the lighting load is not in synchronization with (e.g., not aligned with) the position of the slider knob 1424 along the slider slot 1437 and the present intensity level L_{PRES} is greater than an intensity level associated with the position of the slider knob. For example, the present intensity level L_{PRES} of the lighting load may not be in synchronization with (e.g., not aligned with) the position of the slider knob 1424 along the slider slot 1437 as a result of receiving a remote control command, such as via a received message. As shown in FIG. 31B, the commanded intensity level L_{CMD} of the received message may be greater than the present intensity level L_{PRES} of the lighting load associated with the position of the slider knob 1442. For example, in FIG. 31B, the slider knob 1442 may be located at a position along the slider slot 1437 that is associated with a lighting level that is approximately 75% of the high-end intensity level L_{HE}. In FIG. 31B, the commanded intensity level L_{CMD} indicated by the received message may be greater than 75% of the high-end lighting intensity level, and as such, the control device 1400 may be configured to illuminate a section 1428a located on the illumination surface 1424 above the slider knob 1442 to indicate, for example, that the present intensity level L_{PRES} of the lighting load is greater than the intensity level associated with the position of the slider knob 1442. For example, the control device 1400 may be configured to illuminate the section 1428a, such that the section 1428a may extend from the slider knob 1442 to the high-end position 1436 of the illumination surface 1424 (e.g., when the commanded intensity level L_{CMD} is greater than the intensity level associated with the position of the slider knob). Although the illuminated section 1428a is illustrated in FIG. 31B as comprising the entire portion of the slider slot 1437 above the slider knob 1442, in other examples, the control device 1400 may be configured to illuminate the section 1428a such that it extends for only a portion of the distance between the slider knob 1442 and the high-end position 1436 of the illumination surface 1424.

FIG. 31C is a is a front view of the control device 1400 when the present intensity level L_{PRES} of the lighting load is not in synchronization with (e.g., not aligned with) the position of the slider knob 1424 along the slider slot 1437 and the present intensity level L_{PRES} is less than an intensity level associated with the position of the slider knob. For example, the present intensity level L_{PRES} of the lighting load may not be in synchronization with (e.g., not aligned with) the position of the slider knob 1424 along the slider slot 1437 as a result of receiving a control via a remote control command, such as via a remove message. As shown in FIG. 31C, the commanded intensity level L_{CMD} of the lighting load is less than the present intensity level L_{PRES} of the lighting load associated with the position of the slider knob 1442. For example, in FIG. 31C, the slider knob 1442 may be located at a position along the slider slot 1437 that is associated with a lighting level that is approximately 75% of the high-end intensity level. In FIG. 31C, the commanded intensity level L_{CMD} indicated by the remote control command may be less than 75% of the high-end intensity level L_{HE}, and as such, the control device 1400 may be configured to illuminate a section 1428b located on the illumination surface 1424 below the slider knob 1442 to indicate, for example, that the present intensity level L_{PRES} of the lighting load is less than the intensity level associated with the position of the slider knob 1442. For example, the control device 1400 may be configured to illuminate the section 1428b, such that the section 1428b may extended from the slider knob 1442 to the low-end position 1434 of the illumination surface 424 (e.g., when the commanded intensity level L_{CMD} is less than the intensity level associated with the position of the slider knob). Although the illuminated section 1428b is illustrated in FIG. 31C as comprising the entire portion of the slider slot 1437 below the slider knob 1442, in other examples, the control device 1400 may be configured to illuminate the section 1428a such that it extends for only a portion of the distance between the slider knob 1442 and the low-end position 1434 of the illumination surface 1424.

As such, the control device 1400 may illuminate the section 1428a, 1428b on the illumination surface 1424 that indicates that the present intensity level L_{PRES} of the lighting load is not synchronized with (e.g., not aligned with) the position of the slider knob 1442 along the slider slot 1437. The control device 1400 may also illuminate the sections 1428a, 1428b to indicate whether the present intensity level L_{PRES} is greater than or less than (e.g., relative to) the intensity level associated with the position of the slider knob 1442.

Accordingly, the section 1428a, 1428b on the illumination surface 1424 may indicate whether the slider knob 1442 is in synchronization with (e.g., aligned with) the present intensity level L_{PRES} of the lighting load. For example, in response to a remote control command, the control device 1400 may be configured to illuminate the sections 1428a, 1428b on the illumination surface 1424 based on the commanded intensity level L_{CMD} indicated by the remote control command relative to the position of the slider knob 1442 along the slider slot 1437. The illuminated sections 1428a, 1428b in FIGS. 31B and 31C may be variable in length depending upon the position of the slider knob 1442. The control device 1400 may illuminate the section 1428a, 1428b on the illumination surface 1424 that indicates the relative magnitude of the present intensity level L_{PRES} of the lighting load (e.g., relative as compared to the intensity level associated with the position of the slider knob 1442), but not the exact magnitude of the present intensity level L_{PRES}. Accordingly, illumination of the section 1428a, 1428b on the illumination surface 1424 may also indicate that the control device 1400 is operating in response to a remote control command (e.g., as opposed to a local command). Therefore, since the message may command the control device 1400 to control the present intensity level L_{PRES} of the lighting load to a level that is not synchronized with (e.g., aligned with) the position of the slider knob 1442, the control device 1400 may be configured to illuminate a section 1428a, 1428b on the illumination surface 1424 to indicate that the present intensity level L_{PRES} does not align with (e.g., track) the position (e.g., location) of the slider knob 1442, while also indicating the present intensity level L_{PRES} of the lighting load relative to the position of the slider knob 1442.

The control device 1400 may be configured to turn off the section 1428a, 1428b on the illumination surface 1424 if the position of the slider knob 1442 moves (e.g., when the illuminated portion was unsynchronized with the position of the slider knob 1442, such as after controlling the lighting load and illuminating one of the section 1428a, 1428b in response to a message received from a remote device). For example, if, based on a received message from a remote device, the control device 1400 is controlling present intensity level L_{PRES} of the lighting load to an intensity level that is different than the intensity level associated with the position of the slider knob 1442 (e.g., as shown in FIGS. 31B and 31C) and the position of the slider knob 1442 is later adjusted, the control device 1400 may turn off the section 1428a, 1428b on the illumination surface 1424 (e.g., as illustrated in FIG. 31A) and control the present intensity level L_{PRES} of the lighting load according to the local control (e.g., the movement of the slider knob 1442). As such, the control device 1400 may illuminate one of the section 1428a, 1428b on the illumination surface 1424 to indicate that the control device 1400 is operating in response to a remote control command (e.g., as opposed to a local command) and, when operating in response to a remote control command, indicate whether the commanded intensity level L_{CMD} is greater than or less than the intensity associated with the position of the slider knob 1442.

FIG. 32A-32C are front views of an example control device 1500 illustrating a visible display that is comprised of a plurality of visible indicators. The control device 1500 may be an example of the control device 200, the control device 300, the control device 400, and/or the control device 500. Since the control device 1500 may be an example (e.g., alternative example) of the control device 200, the control device 300, the control device 400, and/or the control device 500, the description of every component of the control device 1500 will not be repeated. For example, similar to the control device 200, the control device 1500 may comprise an actuation portion 1510 that is configured to be received in an opening of a bezel 1512 (e.g., a base portion) of the control device 1500. The actuation member 1510 may comprise a front surface 1514 including an upper portion 1516 and a lower portion 1518. Further, and for example, the control device 1500 may comprise the internal components described with reference to the control device 300.

The control device 1500 may include an analog intensity adjustment actuator to provide a local control command of the lighting load, such as a slider actuator 1540 comprising a slider knob 1542. Although described in context of controlling the present intensity level L_{PRES} of a lighting load, the control device 1500 may be configured to control other characteristics of an electrical load, such as the amount of power delivered to an electrical load, the speed of a ceiling fan, etc. The slider knob 1542 may be configured to move in the vertical direction along a slider slot 1537 of the control device 1500. The slider slot 1537 may be located in the bezel 1512 of the control device. The position of the slider knob 1542 may indicate the commanded intensity level L_{CMD} of the lighting load via local control. For example, the control device 1500 may control the magnitude of a load current conducted through the lighting load (e.g., and thus the present intensity level L_{PRES} of the lighting load) in response to movement of the slider knob 1542. Accordingly, the control device 1500 may be configured to adjust a present intensity level L_{PRES} of the lighting load from an initial intensity level L_{INIT} to a commanded intensity level L_{CMD} in response to actuation of the intensity adjustment actuator (e.g., movement of the slider knob 1542 along the slider slot 1537).

The control device 1500 may comprise the wireless communication circuit, such as those described herein. The wireless communication circuit may be configured to transmit messages (e.g., digital messages) via one or more wireless signals (e.g., RF signals). The message may include the control data (e.g., commands) generated by the control circuit for controlling the electrical load. For example, the message may include a command (e.g., a remote control command) to adjust the present intensity level L_{PRES} of the lighting load controlled by the control device 1500 from an initial intensity level L_{INIT} of the lighting load to a commanded intensity level L_{CMD} indicated by the message. The wireless communication circuit may enable the control device 1500 to receive commands for remote control of the lighting load (e.g., in additional to the local control provided via the actuation member 1510 and the intensity adjustment actuator).

The control device 1500 may include a visible display. As opposed to the illumination surface 224 provided within the slider slot 237 of the control device 200, the control device 1500 may include a visible display that is external to the slider slot 1537. For example, the control device 1500 may include a plurality of visible indicators, such as a lower visible indicator 1520a and an upper visible indicator 1520b that act as the visible display. The control device 1500 may be configured to illuminate the visible indicators 1520a, 1520b to provide feedback, such as the present intensity level L_{PRES} of the lighting load. For example, the visible indicator 1520a, 1520b may provide feedback indicating the present intensity level L_{PRES} of the lighting load relative to the position of the slider knob 1542 (e.g., and not actual intensity level).

In some examples, the control device 1500 may be configured to illuminate the visible indicators 1520a, 1520b using one or more light sources of the control device 1500, such as LED light sources. For example, the control device 1500 may be configured to control which light sources of the plurality of light sources are illuminated (e.g., based on the intensity of lighting load) such that the corresponding visible indicator 1520a, 1520b is illuminated. The control device 1500 may include one or more light pipes, wherein each light pipe is configured to guide light from one or more light sources to the visible indicators 1520a, 1520b to indicate the present intensity level L_{PRES} of the lighting load (e.g., relative to the position of the slider knob 1542, and not actual intensity level). Further, the visible indicators 1520a, 1520b may provide multiple types of feedback, such as any combination of an indication of the present intensity level L_{PRES} of the lighting load, an indication of whether the slider knob 1542 is in synchronization with (e.g., aligned with) the present intensity level L_{PRES} of the lighting load, an indication of one or more characteristics of the electrical load (e.g., a color and/or color temperature of light emitted from a lighting load), and/or the like.

Each visible indicator 1520a, 1520b may be an opening in the bezel 1512. The upper visible indicator 1520b may be located above the top end of the slider slot 1537, while the lower visible indicator 1520a may be located below the bottom end of the slider slot 1537 (e.g., as shown). In the illustrated example, the visible indicators 1520a, 1520b are aligned above and below the slider slot 1537, however, in other examples, the visible indicators 1520a, 1520b may be located between the slider slot 1537 and the actuation member 1310, or the actuation member 1310 may be located between the visible indicators 1520a, 1520b and the slider slot 1537. Finally, in some examples, the visible indicators 1520a, 1520b may be located (e.g., spaced horizontally) above the upper portion 1516 of the actuation member 1510 or below the lower portion 1518 of the actuation member 1510.

The control device 1500 may be configured to illuminate the visible indicators 1520a, 1520b in different manners and/or using different parameters based on whether the control is received via a local control command (e.g., via an actuation of the actuation member 1510 and/or via movement of the slider knob 1542) or the control is received via a remote control command (e.g., a message received via a remote control device).

FIG. 32A is a front view of the control device 1500 when a control is received via a local control command, such as via movement of the slider knob 1542. For example, the control device 1500 may maintain the visible indicators 1520a, 1520b unilluminated (e.g., off) when the control is received via a local control command, such as via movement of the slider knob 1542. For example, if the user moves the slider knob 1542, the control device 1500 may adjust the present intensity level L_{PRES} of the lighting load based on the position of the slider knob 1542 in the slider slot 1537, but the control device may maintain the visible indicators 1520a, 1520b unilluminated (e.g., off). In such instances, the slider knob 1542 may provide the feedback indicating the intensity of the lighting load. Therefore, in response to a local control command, the control device 1500 may be configured to indicate that the present intensity level L_{PRES} of the lighting load is in synchronization with the position of the slider knob 1542 along the slider slot 1537 by unilluminating (e.g., turning off) the visible indicators 1520a, 1520b.

FIG. 32B is a is a front view of the control device 1500 when the present intensity level L_{PRES} of the lighting load is not in synchronization with (e.g., not aligned with) the position of the slider knob 1524 along the slider slot 1537 and the present intensity level L_{PRES} is greater than an intensity level associated with the position of the slider knob 1524. For example, the present intensity level L_{PRES} of the lighting load may not be in synchronization with (e.g., not aligned with) the position of the slider knob 1524 along the slider slot 1537 as a result of receiving a remote control command, such as via a remote control command. As shown in FIG. 32B, the commanded intensity level Lao) of the lighting load may be greater than the present intensity level L_{PRES} of the lighting load associated with the position of the slider knob 1542. For example, in FIG. 32B, the slider knob 1542 may be located at a position along the slider slot 1537 that is associated with a lighting level that is approximately 75% of the high-end intensity level L_{HE}. In FIG. 32B, the commanded intensity level L_{CMD} indicated by the remote control command may be greater than 75% of the high-end intensity level L_{HE}, and as such, the control device 1500 may be configured to illuminate the upper visible indicator 1520b to indicate, for example, that the present intensity level L_{PRES} of the lighting load is greater than the intensity level associated with the position of the slider knob 1542. Further, by illuminating the upper visible indicator 1520b, the control device 1500 may indicate that control device 1500 is being controlled via a remote control command.

FIG. 32C is a is a front view of the control device 1500 when the present intensity level L_{PRES} of the lighting load is not in synchronization with (e.g., not aligned with) the position of the slider knob 1524 along the slider slot 1537 and the present intensity level L_{PRES} is less than an intensity level associated with the position of the slider knob 1524. For example, the present intensity level L_{PRES} of the lighting load may not be in synchronization with (e.g., not aligned with) the position of the slider knob 1524 along the slider slot 1537 as a result of receiving a remote control command, such as via a remote message. As shown in FIG. 32C, the commanded intensity level L_{CMD} of the lighting load may be less than the present intensity level L_{PRES} of the lighting load associated with the position of the slider knob 1542. For example, in FIG. 32C, the slider knob 1542 may be located at a position along the slider slot 1537 that is associated with a lighting level that is approximately 75% of the high-end intensity level L_{HE}. In FIG. 32C, the commanded intensity level L_{CMD} indicated by the remote control command may be less than 75% of the high-end intensity level L_{HE}, and as such, the control device 1500 may be configured to illuminate the lower visible indicator 1520a to indicate, for example, that the present intensity level L_{PRES} of the lighting load is less than the intensity level associated with the position of the slider knob 1542. Further, by illuminating the lower visible indicator 1520a, the control device 1500 may indicate that control device 1500 is being controlled via a remote control command.

Accordingly, the visible indicators 1520a, 1520b may indicate whether the slider knob 1542 is in synchronization with (e.g., aligned with) the present intensity level L_{PRES} of the lighting load. For example, in response to a remote control command, the control device 1500 may be configured to illuminate one of the visible indicators 1520a, 1520b based on the commanded intensity level L_{CMD} indicated by the remote control command relative to the position of the slider knob 1542 along the slider slot 1537. As such, the control device 1500 may illuminate one of the visible indicators 1520a, 1520b that indicates the relative magnitude of the present intensity level L_{PRES} of the lighting load (e.g., relative as compared to the intensity level associated with the position of the slider knob), but not the exact magnitude of the present intensity level L_{PRES}. Accordingly, illumination of the visible indicators 1520a, 1520b may also indicate that the control device 1500 is operating in response to a remote control command (e.g., as opposed to a local command). Therefore, since the message may command the control device 1500 to control the present intensity level L_{PRES} of the lighting load to a level that is not synchronized with (e.g., aligned with) the position of the slider knob 1542, the control device 1500 may be configured to illuminate one of the visible indicators 1520a, 1520b to indicate that the controlled intensity level does not align with (e.g., track) the position (e.g., location) of the slider knob 1542, while also indicating the present intensity level L_{PRES} of the lighting load relative to the position of the slider knob 1542.

The control device 1500 may be configured to turn off the visible indicators 1520a, 1520b if the position of the slider knob 1542 moves (e.g., when the illuminated portion was unsynchronized with the position of the slider knob 1542, such as after controlling the load and illuminating visible indicators 1520a, 1520b in response to a message received from a remote device). For example, if, based on a received message from a remote device, the control device 1500 is controlling the present intensity level L_{PRES} of the lighting load to an intensity level that is different than the intensity level associated with the position of the slider knob 1542 (e.g., as shown in FIGS. 32B and 32C) and the position of the slider knob 1542 is later adjusted, the control device 1500 may turn off the visible indicators 1520a, 1520b (e.g., as illustrated in FIG. 32A) and control the present intensity level L_{PRES} of the lighting load according to the local control (e.g., the movement of the slider knob 1542). As such, the control device 1500 may illuminate the visible indicators 1520a, 1520b to indicate that the control device 1500 is operating in response to a remote control command (e.g., as opposed to a local command) and, when operating in response to a remote control command, indicate whether the commanded intensity level L_{CMD} is greater than or less than the intensity associated with the position of the slider knob 1542.

FIG. 33 is a flowchart of an example procedure 1700 for controlling a visible display of a control device to indicate whether the present intensity of the lighting load L_{PRES} is in synchronization with the position of a slider knob along a slider slot. The control device that is configured to perform the procedure 1700 may be the control device 1400 and/or the control device 1500, although the procedure 1700 may be performed by any of the control devices described herein. For example, the control device may receive a command via local control from a user interface of the control device or via remote control from a remote device (e.g., the retrofit remote control device 112, the wall-mounted remote control device 114, the tabletop remote control device 116, the handheld remote control device 118, a smart phone, tablet, and/or the like). The procedure 1700 may be executed by a control circuit of a control device, for example, the dimmer control circuit 514 of the control device 500. The procedure 1700 may, for example, ensure that the visible display of the control device provides feedback that indicates whether the present intensity of the lighting load L_{PRES} is in synchronization with the position of a slider knob along a slider slot (e.g., the slider knob 1442 along the slider slot 1437, the slider knob 1542 along the slider slot 1537, etc.). The control circuit may execute the procedure 1700 periodically and/or in response to receiving a new user command to control (e.g., change) the present intensity level L_{PRES} of the lighting load to a commanded intensity level L_{CMD}.

The procedure 1700 may start at 1710. At 1712, the control circuit may determine whether a new command is received. The new command may be a command to adjust the present intensity level L_{PRES} of the lighting load controlled by the control device to a commanded intensity level L_{CMD}. For instance, the present intensity level L_{PRES} of the lighting load may be at an initial intensity level L_{INIT} (e.g., which may be zero if the lighting load is off), and the new command may indicate the commanded intensity level L_{CMD}. If the control circuit determines that a new command is not received at 1712, the control circuit may exit the procedure 1700. If the control circuit determines that a new command is received at 1712, the control circuit may determine the commanded intensity level L_{CMD} indicated by the command at 1714.

At 1714, the control circuit may determine the commanded intensity level L_{CMD} from the command. As described herein, the user command may be received in response to local control of the lighting load and/or remote control of the lighting load. The control circuit may receive a command via local control, for example, by detecting an actuation of an actuation member (e.g., the actuation member 1410 and/or the actuation member 1510) and/or movement of an intensity adjustment actuator of the control device (e.g., the slider actuator 1440 comprising a slider knob 1442, the slider actuator 1540 comprising a slider knob 1542, etc.). The control circuit may determine the commanded intensity level L_{CMD} based on local control (e.g., based on the position of the slider knob). The control circuit may receive a command via remote control, for example, via a remote control command received from a remote device. For example, as noted herein, the control device may receive message (e.g., digital messages via wireless signals from the remote device) representative of commands to control the lighting load, and generate respective control signals for executing the commands. The message may include the commands (e.g., control data) generated by the control circuit for controlling the lighting load, such as a command to adjust the present intensity level L_{PRES} of the lighting load controlled by the control device. For instance, the message may include an indication of the commanded intensity level L_{CMD}. At 1716, the control circuit may control the present intensity level L_{PRES} of the lighting load to the commanded intensity level L_{CMD}.

At 1718, the control circuit may determine whether the command received at 1712 is a local control command of the lighting load (e.g., or remote control command of the lighting load). If the control circuit determines that the command is a local control command of the lighting load at 1718, the control circuit may set a previous local intensity level L_{LOCAL} of the lighting load to the present intensity level L_{PRES} of the lighting load (e.g., as set at 1716). The previous local intensity level L_{LOCAL} may be the intensity level as determined by the position of the slider knob along the slider slot prior to the reception of the command at 1712. If the control circuit determines that the command received at 1712 is a remote control command of the lighting load (e.g., a message received from a remote device), the control circuit may proceed to 1722, for example, without adjusting the previous local intensity level L_{LOCAL}. As such, the control circuit may set the previous local intensity level L_{LOCAL} to be equal to the present intensity level L_{PRES} of the lighting load in response to a local control command, but not in response to a remote control command. Accordingly, the previous local intensity level L_{LOCAL} may be equal to the intensity level associated with the position of the slider knob along the slider slot.

At 1722, the control circuit may determine whether the present intensity level L_{PRES} of the lighting load is equal to the previous local intensity level L_{LOCAL} of the lighting load. If the command received at 1712 was a local command, then the present intensity level L_{PRES} of the lighting load is equal to the previous local intensity level L_{LOCAL} of the lighting load (e.g., as shown in 1720). However, if the command received at 1712 was a remote command, then the present intensity level L_{PRES} of the lighting load may or may not be equal to the previous local intensity level L_{LOCAL} of the lighting load. For instance, although it may be unlikely, there may be situations where a remote control command causes the present intensity level L_{PRES} of the lighting load to be equal to the previous local intensity level L_{LOCAL} of the lighting load.

If the control circuit determines that the present intensity level L_{PRES} of the lighting load is equal to the previous local intensity level L_{LOCAL} of the lighting load at 1722 (e.g., that the command is a local control command), the control circuit may control the visible display to indicate that the present intensity of the lighting load L_{PRES} is in synchronization with the position of the slider knob along the slider slot. For instance, taking the control device 1400 as an example, the visible display of the control device may include the illumination surface 1424. In such examples, the control device may maintain the illumination surface 1424 unilluminated or turn off the illumination surface 1424 at 1724 to indicate that the present intensity level L_{PRES} of the lighting load is in synchronization with (e.g., aligned with) the position of the slider knob along the slider slot. For example, the control device may maintain the illumination surface unilluminated as a result of receiving a local control command, such as via movement of the slider knob. Taking the control device 1500 as an example, the visible display may comprise the visible indicators 1520a, 1520b. In such examples, the control device may maintain the visible indicators 1520a, 1520b unilluminated or turn off the visible indicators 1520a, 1520b at 1724 to indicate that the present intensity level L_{PRES} of the lighting load is in synchronization with (e.g., aligned with) the position of the slider knob along the slider slot. For example, the control device may maintain the visible indicators 1520a, 1520b unilluminated or turn off the visible indicators 1520a, 1520b as a result of receiving a local control command, such as via movement of the slider knob.

If the control circuit determines that the present intensity level L_{PRES} of the lighting load is not equal to the previous local intensity level L_{LOCAL} of the lighting load at 1722, the control circuit may determine whether the present intensity level L_{PRES} of the lighting load is greater than the previous local intensity level L_{LOCAL} of the lighting load at 1726. When the present intensity level L_{PRES} of the lighting load is not equal to the previous local intensity level L_{LOCAL} of the lighting load, the present intensity level L_{PRES} of the lighting load is not in synchronization with (e.g., not aligned with) the position of the slider knob along the slider slot. If the control circuit determines that the present intensity level L_{PRES} of the lighting load is greater than the previous local intensity level L_{LOCAL} of the lighting load at 1726, the control circuit may control the visible display to indicate that the present intensity level L_{PRES} of the lighting load is greater than the position of the slider knob along the slider slot at 1728. If the control circuit determines that the present intensity level L_{PRES} of the lighting load is less than the previous local intensity level L_{LOCAL} of the lighting load at 1726, the control circuit may control the visible display to indicate that the present intensity level L_{PRES} of the lighting load is less than the position of the slider knob along the slider slot at 1730.

Taking the control device 1400 as an example, the visible display of the control device may include the illumination surface 1424. In such examples, the control device may be configured to illuminate a section 1428a located on the illumination surface 1424 above the slider knob to indicate, for example, that the present intensity level L_{PRES} of the lighting load is greater than the intensity level associated with the position of the slider knob. For example, the control device may be configured to illuminate the section 1428a, such that the section 1428a may extend from the slider knob to the high-end position of the illumination surface 1424. In other examples, the control device may be configured to illuminate the section 1428a such that it extends for only a portion of the distance between the slider knob and the high-end position of the illumination surface 1424. As such, when the present intensity level L_{PRES} of the lighting load is not equal to the previous local intensity level L_{LOCAL} of the lighting load and the present intensity level L_{PRES} is greater than the previous local intensity level L_{LOCAL} of the lighting load, the control device may illuminate the section 1428a located on the illumination surface 1424 above the slider knob to indicate, for example, that the present intensity level L_{PRES} of the lighting load is greater than the position of the slider knob along the slider slot at 1728 (e.g., and not in synchronization with the position of the slider knob along the slider slot).

Taking the control device 1500 as an example, the visible display may comprise the visible indicators 1520a, 1520b. In such examples, the control device may be configured to illuminate the visible indicator 1520b above the slider slot to indicate, for example, that the present intensity level L_{PRES} of the lighting load is greater than the intensity level associated with the position of the slider knob. As such, when the present intensity level L_{PRES} of the lighting load is not equal to the previous local intensity level L_{LOCAL} of the lighting load and the present intensity level L_{PRES} is greater than the previous local intensity level L_{LOCAL} of the lighting load, the control device may illuminate the visible indicator 1520b above the slider slot to indicate, for example, that the present intensity level L_{PRES} of the lighting load is greater than the position of the slider knob along the slider slot at 1728 (e.g., and not in synchronization with the position of the slider knob along the slider slot).

As noted above, if the control circuit determines that the present intensity level L_{PRES} of the lighting load is not greater than the previous local intensity level L_{LOCAL} of the lighting load at 1726, the control circuit may control the visible display to indicate that the present intensity level L_{PRES} of the lighting load is less than the position of the slider knob along the slider slot at 1730. Taking the control device 1400 as an example, the visible display of the control device may include the illumination surface 1424. In such examples, the control device may be configured to illuminate a section 1428b located on the illumination surface 1424 below the slider knob to indicate, for example, that the present intensity level L_{PRES} of the lighting load is less than the intensity level associated with the position of the slider knob. For example, the control device may be configured to illuminate the section 1428b, such that the section 1428b may extend from the slider knob to the low-end position of the illumination surface 1424. In other examples, the control device may be configured to illuminate the section 1428b such that it extends for only a portion of the distance between the slider knob and the low-end position of the illumination surface 1424. As such, when the present intensity level L_{PRES} of the lighting load is not equal to the previous local intensity level L_{LOCAL} of the lighting load and the present intensity level L_{PRES} is less than the previous local intensity level L_{LOCAL} of the lighting load, the control device may illuminate the section 1428b located on the illumination surface 1424 below the slider knob to indicate, for example, that the present intensity level L_{PRES} of the lighting load is less than the position of the slider knob along the slider slot at 1728 (e.g., and not in synchronization with the position of the slider knob along the slider slot).

Taking the control device 1500 as an example, the visible display may comprise the visible indicators 1520a, 1520b. In such examples, the control device may be configured to illuminate the visible indicator 1520a below the slider slot to indicate, for example, that the present intensity level L_{PRES} of the lighting load is less than the intensity level associated with the position of the slider knob at 1730. As such, when the present intensity level L_{PRES} of the lighting load is not equal to the previous local intensity level L_{LOCAL} of the lighting load and the present intensity level L_{PRES} is less than the previous local intensity level L_{LOCAL} of the lighting load, the control device may illuminate the visible indicator 1520a below the slider slot to indicate, for example, that the present intensity level L_{PRES} of the lighting load is less than the position of the slider knob along the slider slot at 1730 (e.g., not in synchronization with the position of the slider knob along the slider slot).

FIGS. 34A-34B are front views of an example control device 1600 illustrating a visible display that is comprised of a visible indicator on a slider knob of a slider actuator. The control device 1600 may be an example of the control device 200, the control device 300, the control device 400, and/or the control device 500. Since the control device 1600 may be an example (e.g., alternative example) of the control device 200, the control device 300, the control device 400, and/or the control device 500, the description of every component of the control device 1600 will not be repeated. For example, similar to the control device 200, the control device 1600 may comprise an actuation portion 1610 that is configured to be received in an opening of a bezel 1612 (e.g., a base portion) of the control device 1600. The actuation member 1610 may comprise a front surface 1614 including an upper portion 1616 and a lower portion 1618. Further, and for example, the control device 1600 may comprise the internal components described with reference to the control device 300.

The control device 1600 may include an analog intensity adjustment actuator to provide a local control command of the lighting load, such as a slider actuator 1640 comprising a slider knob 1642. Although described in context of controlling the present intensity level L_{PRES} of a lighting load, the control device 1600 may be configured to control other characteristics of an electrical load, such as the amount of power delivered to an electrical load, the speed of a ceiling fan, etc. The slider knob 1642 may be configured to move in the vertical direction along a slider slot 1637 of the control device 1600. The slider slot 1637 may be located in the bezel 1612 of the control device 1600. The position of the slider knob 1642 may indicate the commanded intensity level Um) of the lighting load via local control. For example, the control device 1600 may control the magnitude of a load current conducted through the lighting load (e.g., and thus the present intensity level L_{PRES} of the lighting load) in response to movement of the slider knob 1642. Accordingly, the control device 1600 may be configured to adjust a present intensity level L_{PRES} of the lighting load from an initial intensity level L_{INIT} to a commanded intensity level L_{CMD} in response to actuation of the intensity adjustment actuator (e.g., movement of the slider knob 1642 along the slider slot 1637).

The control device 1600 may comprise the wireless communication circuit, such as those described herein. The wireless communication circuit may be configured to transmit messages (e.g., digital messages) via one or more wireless signals (e.g., RF signals). The message may include the control data (e.g., commands) generated by the control circuit for controlling the electrical load. For example, the message may include a command (e.g., a remote control command) to adjust the present intensity level L_{PRES} of the lighting load controlled by the control device 1600 from an initial intensity level L_{INIT} of the lighting load to a commanded intensity level L_{CMD} indicated by the message (e.g., the message may include the commanded intensity level L_{CMD}). The wireless communication circuit may enable the control device 1600 to receive commands for remote control of the lighting load (e.g., in additional to the local control provided via the actuation member 1610 and the intensity adjustment actuator).

The control device 1600 may include a visible display. As opposed to the illumination surface 224 provided within the slider slot 237 of the control device 200, the control device 1600 may include a visible display that is external to the slider slot 1637. For example, the control device 1600 may include a visible indicator 1620 located on the slider knob 1642 of the slider actuator 1640. The control device 1600 may be configured to illuminate the visible indicator 1620 to provide feedback, such as whether the slider knob 1642 is in synchronization with (e.g., aligned with) the present intensity level L_{PRES} of the lighting load. Further, and for example, the control device 1600 may be configured to illuminate the visible indicator 1620 to indicate whether the control device 1600 is operating based on a local control command (e.g., based on a movement of the slider knob 1642) or based on a remote control command (e.g., a remote message). The visible indicator 1620 may be an opening in the slider knob 1642. However, in other examples, the visible indicator 1620 may be located elsewhere on the control device 1600, such as on the bezel 1612 (e.g., above or below the slider slot 1637), on the actuation member 1610, or within the slider slot 1637, for example. In some examples, the control device 1600 may be configured to illuminate the visible indicator 1620 using one or more light sources of the control device 1600, such as LED light sources. The control device 600 may include a light pipe, wherein the light pipe is configured to guide light from one or more light sources to the visible indicator 1620 to indicate. Accordingly, the visible indicator 1620 may provide multiple types of feedback, such as an indication of whether the slider knob 1642 is in synchronization with (e.g., aligned with) the present intensity level L_{PRES} of the lighting load and/or an indication of whether the control device 1600 is operating based on a local control command or based on a remote control command.

FIG. 34A is a front view of the control device 1600 when a control is received via a local control command, such as via movement of the slider knob 1642. For example, the control device 1600 may illuminate the visible indicator 1620 when the control is received via a local control command, such as via movement of the slider knob 1642. For example, if the user moves the slider knob 1642, the control device 1600 may adjust the present intensity level L_{PRES} of the lighting load based on the position of the slider knob 1642 in the slider slot 1637, and the control device may illuminate the visible indicator 1620. Therefore, in response to a local control command, the control device 1600 may be configured to indicate that the present intensity level L_{PRES} of the lighting load is in synchronization with the position of the slider knob 1642 along the slider slot 1637 by illuminating the visible indicators 1620.

FIG. 34B is a is a front view of the control device 1600 when a control is received via a remote control command, such as via a remote control command. For example, the control device 1600 may be configured to turn off the visible indicator 1620 to indicate, for example, that the present intensity level L_{PRES} of the lighting load is not in synchronization with the position of the slider knob 1642 along the slider slot 1637 and/or to indicate that the control device 1600 is being controlled via a remote control command. Although described as being configured to illuminate the visible indicator 1620 in response to a local control command (e.g., as shown in FIG. 34A), and turn off the visible indicator 1620 in response to a remote control command, the control device 1600 may be configured to operate in different manners. For example, the control device 1600 may be configured to turn off the visible indicator 1620 in response to a local control command, and illumine the visible indicator 1620 in response to a remote control command.

Referring to the examples shown in FIGS. 34A and 34B, the control device 1600 may be configured to illuminate the visible indicator 1620 if the position of the slider knob 1642 moves (e.g., when synchronized). For example, if, based on a received message from a remote device, the control device 1600 is controlling the present intensity level L_{PRES} of the lighting load to an intensity level that is different than the intensity level associated with the position of the slider knob 1642 (e.g., as shown in FIG. 34B) and the position of the slider knob 1642 is later adjusted, the control device 1600 may illuminate the visible indicator 1620 (e.g., as illustrated in FIG. 34A) to indicate that the present intensity level L_{PRES} of the lighting load is in synchronization with the position of the slider knob 1642 and control the present intensity level L_{PRES} of the lighting load according to the local control (e.g., the movement of the slider knob 1642).

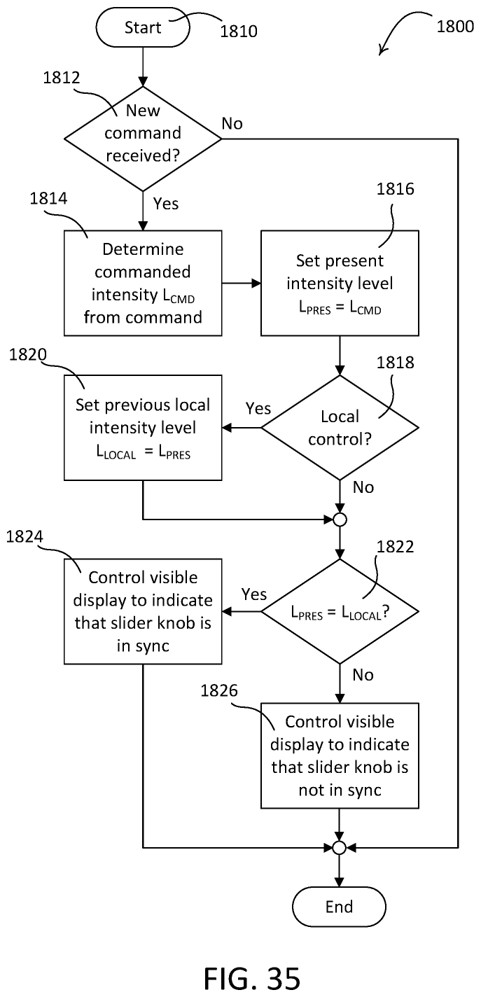

FIG. 35 is a flowchart of an example procedure 1800 for controlling a visible display of a control device to indicate whether the present intensity of the lighting load L_{PRES} is in synchronization with the position of a slider knob along a slider slot. The control device that is configured to perform the procedure 1800 may be the control device 1600, although the procedure 1800 may be performed by any of the control devices described herein (e.g., assuming that the control device includes a visible indicator in the slider knob). For example, the control device may receive a command via local control from a user interface of the control device or via remote control from a remote device (e.g., the retrofit remote control device 112, the wall-mounted remote control device 114, the tabletop remote control device 116, the handheld remote control device 118, a smart phone, tablet, and/or the like). The procedure 1800 may be executed by a control circuit of a control device, for example, the dimmer control circuit 514 of the control device 500. The procedure 1800 may, for example, ensure that the visible display of the control device provides feedback that indicates whether the present intensity of the lighting load L_{PRES} is in synchronization with the position of a slider knob along a slider slot (e.g., the slider knob 1642 along the slider slot 1637, etc.). The control circuit may execute the procedure 1800 periodically and/or in response to receiving a new user command to control (e.g., change) the present intensity level L_{PRES} of the lighting load to a commanded intensity level L_{CMD}.

The procedure 1800 may start at 1810. At 1812, the control circuit may determine whether a new command is received. The new command may be a command to adjust the present intensity level L_{PRES} of the lighting load controlled by the control device to a commanded intensity level L_{CMD}. For instance, the present intensity level L_{PRES} of the lighting load may be at an initial intensity level L_{INIT} (e.g., which may be zero if the lighting load is off), and the new command may indicate the commanded intensity level L_{CMD}. If the control circuit determines that a new command is not received at 1812, the control circuit may exit the procedure 1800. If the control circuit determines that a new command is received at 1812, the control circuit may determine the commanded intensity level L_{CMD} indicated by the command at 1814.

At 1814, the control circuit may determine the commanded intensity level L_{CMD} from the command. As described herein, the user command may be received in response to local control of the lighting load and/or remote control of the lighting load. The control circuit may receive a command via local control, for example, by detecting an actuation of an actuation member (e.g., the actuation member 1610) and/or movement of an intensity adjustment actuator of the control device (e.g., the slider actuator 1640 comprising a slider knob 1642, etc.). The control circuit may determine the commanded intensity level L_{CMD} based on local control (e.g., based on the position of the slider knob). The control circuit may receive a command via remote control, for example, via a remote control command received from a remote device. For example, as noted herein, the control device may receive message (e.g., digital messages via wireless signals from the remote device) representative of commands to control the lighting load, and generate respective control signals for executing the commands. The message may include the commands (e.g., control data) generated by the control circuit for controlling the lighting load, such as a command to adjust the present intensity level L_{PRES} of the lighting load controlled by the control device. For instance, the message may include an indication of the commanded intensity level L_{CMD}. At 1816, the control circuit may control the present intensity level L_{PRES} of the lighting load to the commanded intensity level L_{CMD}.

At 1818, the control circuit may determine whether the command received at 1812 is a local control command of the lighting load (e.g., or remote control command of the lighting load). If the control circuit determines that the command is a local control command of the lighting load at 1818, the control circuit may set a previous local intensity level L_{LOCAL} of the lighting load to the present intensity level L_{PRES} of the lighting load (e.g., as set at 1816). The previous local intensity level L_{LOCAL} may be the intensity level as determined by the position of the slider knob along the slider slot prior to the reception of the command at 1812. If the control circuit determines that the command received at 1812 is a remote control command of the lighting load (e.g., a message received from a remote device), the control circuit may proceed to 1822, for example, without adjusting the previous local intensity level L_{LOCAL}. As such, the control circuit may set the previous local intensity level L_{LOCAL} to be equal to the present intensity level L_{PRES} of the lighting load in response to a local control command, but not in response to a remote control command. Accordingly, the previous local intensity level L_{LOCAL} may be equal to the intensity level associated with the position of the slider knob along the slider slot.

At 1822, the control circuit may determine whether the present intensity level L_{PRES} of the lighting load is equal to the previous local intensity level L_{LOCAL} of the lighting load. If the command received at 1812 was a local command, then the present intensity level L_{PRES} of the lighting load is equal to the previous local intensity level L_{LOCAL} of the lighting load (e.g., as shown in 1820). However, if the command received at 1812 was a remote command, then the present intensity level L_{PRES} of the lighting load may or may not be equal to the previous local intensity level L_{LOCAL} of the lighting load. For instance, although it may be unlikely, there may be situations where a remote control command causes the present intensity level L_{PRES} of the lighting load to be equal to the previous local intensity level L_{LOCAL} of the lighting load.

If the control circuit determines that the present intensity level L_{PRES} of the lighting load is equal to the previous local intensity level L_{LOCAL} of the lighting load at 1822 (e.g., that the command is a local control command), the control circuit may control the visible display to indicate that the present intensity of the lighting load L_{PRES} is in synchronization with the position of the slider knob along the slider slot at 1824. For instance, taking the control device 1600 as an example, the visible display of the control device may include a visible indicator 1620 that is located in the slider knob 1642. In such examples, the control device may illuminate the visible indicator 1620 to indicate that the present intensity level L_{PRES} of the lighting load is in synchronization with the position of the slider knob 1642 along the slider slot 1637 at 1824. Thereafter, the procedure 1800 may exit.

If the control circuit determines that the present intensity level L_{PRES} of the lighting load is not equal to the previous local intensity level L_{LOCAL} of the lighting load at 1822, the control circuit may control the visible display to indicate that the present intensity level L_{PRES} of the lighting load is not in synchronization with the position of the slider knob along the slider slot at 1826. For instance, taking the control device 1600 as an example, the control device may turn off the visible indicator 1620 and/or maintain the visible indicator unilluminated to indicate that the present intensity level L_{PRES} of the lighting load is not in synchronization with the position of the slider knob 1642 along the slider slot 1637 at 1826. Thereafter, the procedure 1800 may exit.

What is claimed is:

1-35. (canceled)

36. A control device for controlling an electrical load, the control device comprising:
a slider knob configured to move along an elongated slot;
a plurality of light sources;
a surface located behind the elongated slot, wherein the surface is configured to be illuminated by the plurality of light sources; and
a control circuit configured to control an amount of power delivered to the electrical load in response movement of the slider knob along the elongated slot, and to illuminate an illuminated portion of the surface to indicate the amount of power delivered to the electrical load.

37. The control device of claim 36, wherein the slider knob is configured to move along the elongated slot in response to a user input for adjusting the amount of power delivered to the electrical load.

38. The control device of claim 36, further comprising:
a diffuser defining the surface, wherein the diffuser is coupled to the slider knob and configured to move with the slider knob as the slider knob moves along the elongated slot.

39. The control device of claim 36, wherein, in response to movements of the slider knob, the control circuit is configured to align the illuminated portion of the surface with a location of the slider knob; and
in response to control of the electrical load by a remote device, the control circuit is configured to illuminate the surface to indicate the amount of power delivered to the electrical load such that the illuminated portion of the surface does not align with the location of the slider knob.

40. The control device of claim 36, further comprising a communication circuit configured to receive a message from a remote device;
wherein the control circuit is configured to control the amount of power delivered to the electrical load in response to the received message, and illuminate the illuminated portion of the surface to indicate the amount of power delivered to the electrical load in accordance with the received message.

41. The control device of claim 36, further comprising a communication circuit;
wherein the control circuit is configured to cause the communication circuit to transmit a control message that causes the amount of power delivered to the electrical load to be adjusted in response to movement of the slider knob along the slider slot.

42. The control device of claim 36, further comprising a communication circuit configured to receive a message from a remote device;
wherein the control circuit is configured to illuminate the illuminated portion of the surface to indicate the amount of power delivered to the electrical load in accordance with the received message such that the illuminated portion of the surface is not aligned with a position of the slider knob along the elongated slot.

43. The control device of claim 36, wherein, when the illuminated portion of the surface is not aligned with a position of the slider knob along the elongated slot, the control circuit is configured to realign the illuminated portion of the surface with the position of the slider knob in response to movement of the slider knob.

44. The control device of claim 36, wherein the slider knob is configured to move along the slider slot in a vertical direction, and, in response to movement of the slider knob along the slider slot, the control circuit is configured to illuminate the illuminated portion of the surface that is located below the slider knob.

45. The control device of claim 44, wherein, in response to movement of the slider knob along the slider slot, the control circuit is configured to illuminate the surface behind the location of the slider knob without illuminating any portion of the surface located above the slider knob.

46. The control device of claim 36, wherein the illuminated portion of the surface defines a plurality of discrete segments, and wherein the control circuit is configured to controllably illuminate at least a subset of the plurality of discrete segments based on the amount of power delivered to the electrical load.

47. The control device of claim 46, wherein the plurality of segments comprises nine segments.

48. The control device of claim 46, wherein the slider knob defines a length, and the length of the slider knob is equal to or greater than a length of each of the plurality of segments.

49. The control device of claim 48, wherein the length of the slider knob is at least two times greater than the length of each of the plurality of segments.

50. The control device of claim 46, further comprising:
a tunnel structure located between the plurality of light sources and the surface, wherein the tunnel structure comprises a plurality of apertures that are configured to cause the illuminated portion of the surface to illuminate the plurality of discrete segments along the elongated slot.

51. The control device of claim 36, wherein the control circuit is configured to enter an idle mode when the electrical load is off; and
wherein, when in the idle mode, the control circuit is configured to illuminate the surface at a first intensity level that is lower than a second intensity level used to indicate the amount of power delivered to the electrical load when in an active mode.

52. The control device of claim 36, further comprising:
an actuation member, wherein the elongated slot is located adjacent to the actuation member.

53. The control device of claim 52, wherein the actuation member is configured to pivot in response to an actuation of an upper portion of the actuation member or a lower position of the actuation member; and
wherein the control circuit is configured to turn the electrical load on in response to an actuation of the upper portion of the actuation member, and configured to turn the electrical load off in response to an actuation of the lower portion of the actuation member.

54. The control device of claim 36, further comprising:
a bezel, the elongated slot located in the bezel; and
an actuation member located within an opening in the bezel adjacent to the elongated slot.

55. The control device of claim 36, wherein the elongated slot is located within a bezel of the control device.

56. The control device of claim 36, further comprising:
an actuation member, wherein the elongated slot is located within the actuation member.

57. The control device of claim 36, wherein the slider knob is mechanically coupled to a potentiometer of the control device, such that the control circuit is configured to determine the amount of power to be delivered to the electrical load in response to a voltage generated by the potentiometer.

58. The control device of claim 36, wherein the control circuit is configured to determine a length of the illuminated portion of the surface in proportion to the amount of power delivered to the electrical load.

59. The control device of claim 36, wherein the electrical load comprises a lighting load, and wherein the control circuit is configured to adjust an intensity level of the lighting load between a low-end intensity level and a high-end intensity level in response to adjustment of the slider knob along the elongated slot.

60. The control device of claim 36, further comprising a diffuser comprising an elongated portion that extends behind the elongated slot, wherein the diffuser is configured to scatter light received from the plurality of light sources.

61. The control device of claim 60, wherein the plurality of light sources comprises one or more light-emitting diodes.

62. The control device of claim 36, further comprising:
a controllably conductive device adapted to be coupled in series electrical connection between an alternating current (AC) power source and the electrical load;
wherein the control circuit is configured to control the controllably conductive device to control the amount of power delivered to the electrical load in response to movement of the slider knob along the elongated slot.

63. The control device of claim 36, wherein the control circuit is configured to control the amount of power delivered to the electrical load based on a position of the slider knob along the elongated slot.

64. The control device of claim 36, further comprising:
a linear diffuser that defines the surface.

65. The control device of claim 36, wherein the elongated slot is configured to provide feedback indicating whether the amount of power provided to the electrical load is determined based on a position of the slider knob along the slider slot or a message received from an external device.

66. The control device of claim 36, wherein the electrical load comprises a lighting load, and wherein the elongated slot is configured to provide multiple types of feedback including two or more of an intensity level of the lighting load, a color of the lighting load, or a position of the slider knob.

67-189. (canceled)

190. The control device of claim 46, wherein the control circuit is configured to:
illuminate a first segment of the plurality of discrete segments when the amount of power delivered to the electrical load is between a low-end threshold and a first threshold;
illuminate the first segment and a second segment of the plurality of discrete segments when the amount of power delivered to the electrical load is between the first threshold and a second threshold;
illuminate the first segment, the second segment, and a third segment of the plurality of discrete segments when the amount of power delivered to the electrical load is between the second threshold and a third threshold; and
illuminate the first segment, the second segment, the third segment, and a fourth segment of the plurality of discrete segments when the amount of power delivered to the electrical load is between the third threshold and a fourth threshold.

191. The control device of claim 46, wherein the control circuit is configured to control the amount of power delivered to the electrical load across a power range; and
wherein each of the plurality of discrete segments are associated with a lower power threshold and an upper power threshold that are associated with a portion of the power range.

192. The control device of claim 191, wherein the lower power threshold and the upper power threshold for at least some of the plurality of discrete segments are different based on whether the amount of power delivered to the electrical load is controlled in response to movement of the slider knob along the slider slot or is controlled in response to a message received from an external device.

193. The control device of claim 36, wherein the control circuit is configured to illuminate the visible display as a continuous light bar.

194. The control device of claim 193, wherein the control circuit is configured to illuminate the visible display as the continuous light bar such that an end point of the continuous light bar is based on the amount of power delivered to the electrical load.

195. The control device of claim 36, wherein the slider knob is configured to move in a horizontal direction along the elongated slot.

196. The control device of claim 36, wherein the slider knob is configured to move in a non-linear direction along the elongated slot.
